(19) United States
(12) Patent Application Publication
(10) Pub. No.: US 2012/0235984 A1
(43) Pub. Date: Sep. 20, 2012

(54) DISPLAY PANEL, LIQUID CRYSTAL DISPLAY, AND DRIVING METHOD

(75) Inventor: Asahi Yamato, Osaka-shi (JP)

(73) Assignee: SHARP KABUSHIKI KAISHA, Osaka-shi, Osaka (JP)

(21) Appl. No.: 13/514,300

(22) PCT Filed: Sep. 27, 2010
(86) PCT No.: PCT/JP2010/066717

§ 371 Date: Jun. 7, 2012

(30) Foreign Application Priority Data
Dec. 11, 2009 (JP) 2009-282192

(51) Int. Cl. G09G 3/36; G06F 3/038

(52) U.S. Cl. 345/212; 345/87

(57) ABSTRACT

A display panel includes: a gate driver (13), which supplies gate signals to a plurality of gate bus lines (GL₁ to GL_{N}); a source driver (12), which supplies source signals to a plurality of source bus lines (SL₁ to SL_{M}); a plurality of counter electrode bus lines (COML₁ to COML_{N}); and a counter electrode driver (14) which, in a single vertical scanning period (T_{V}) from a point in time where the gate driver (13) supplies a gate bus line (GLₙ) with a conducting signal to a point in time where the gate driver (13) supplies the conducting signal next, supplies a counter electrode bus line (COMLₙ) with a rectangular voltage signal (#COMLₙ) being composed of at least a first voltage level (V_{COM1}) and a second voltage level (V_{COM2}) that is different from the first voltage level. This allows the display panel to suppress the phenomenon of blurring of moving images while suppressing increase in manufacturing cost and in power consumption.

### TECHNICAL FIELD

The present invention relates to a display panel that displays an image by using liquid crystals, and also relates to a liquid crystal display device including such a display panel.

### BACKGROUND ART

Conventionally, image display devices for displaying images have been classified broadly into impulse-type image display devices such as CRT (cathode-ray tubes) and hold-type image display devices such as liquid crystal display devices.

In an impulse-type image display device, a lighting period during which an image is displayed and an extinction period during which no image is displayed are alternately repeated. In a typical hold-type image display device, on the other hand, no extinction period is provided.

Therefore, the hold-type image display devices are more likely to suffer from blurring of moving images than the impulse-type image display devices.

A reason for this is for example as follows: Although, in changing from displaying one frame to displaying the next frame, a hold-type image display device displays an moving object as if the moving object were staying in one position, the observer transfers his/her gaze on the screen in chase of the moving object even in a period of time during which the moving object is being displayed as if it were staying in one position; therefore, the contours of the moving object appear to be blurred.

Patent Literature 1 discloses an image display device which divides one frame period into two subframes, namely a first-half subframe and a second-half subframe, and which supplies the two subframes with image signals having different gray-scale levels. According to the technology described in Patent Literature 1, such the phenomenon of blurring of moving images can be suppressed by making the brightness of an image in the first-half subframe and the brightness of an image in the second-half subframe different.

### CITATION LIST

### Patent Literature 1

Japanese Patent Application Publication, Tokukai, No. 2005-173573 (Jun. 30, 2005)

### SUMMARY OF INVENTION

### Technical Problem

However, the technology described in Patent Literature 1 requires a frame memory in which to temporarily store the input image signals, thus undesirably bringing about increase in manufacturing cost. Moreover, the technology described in Patent Literature 1 requires access to the frame memory every time a frame is displayed, thus undesirably bringing about increase in power consumption.

The present invention has been made in view of the foregoing problems, and it is an object of the present invention to realize a display panel capable of suppressing the phenomenon of blurring of moving images while suppressing increase in manufacturing cost and in power consumption.

### Solution to Problem

In order to solve the foregoing problems, a display panel according to the present invention is a display panel including: a plurality of gate bus lines; a plurality of source bus lines; a plurality of counter electrode bus lines; a transistor including a gate connected to a given gate bus line of the plurality of gate bus lines and a source connected to a given source bus line of the plurality of source bus lines; a pixel electrode connected to a drain of the transistor; a counter electrode opposed to the pixel electrode via a liquid crystal and connected to a given counter electrode bus line of the plurality of counter electrode bus lines; a source driver, connected to one end of each of the plurality of source bus lines, which supplies the given source bus line with a source signal; and a gate driver, connected to one end of each of the plurality of gate bus lines, which sequentially supplies the given gate bus line with a conducting signal that renders the transistor conducting, the display panel including a counter electrode driver which, in a single scanning period from a point in time where the gate driver supplies the given gate bus line with the conducting signal to a point in time where the gate driver supplies the conducting signal next, supplies the given counter electrode bus line with a rectangular voltage signal composed of at least a first voltage level and a second voltage level that is different from the first voltage level.

Although, in changing from displaying one frame to displaying the next frame, a hold-type display device such as a liquid crystal display device displays an moving object as if the moving object were staying in one position, the observer transfers his/her gaze on the screen in chase of the moving object even in a period of time during which the moving object is being displayed as if it were staying in one position; therefore, there occurs a phenomenon of blurring of moving images where the contours of the moving object appear to be blurred.

As described above, the display panel according to the present invention is a display panel including: a plurality of gate bus lines; a plurality of source bus lines; a plurality of counter electrode bus lines; a transistor including a gate connected to a given gate bus line of the plurality of gate bus lines and a source connected to a given source bus line of the plurality of source bus lines; a pixel electrode connected to a drain of the transistor; a counter electrode opposed to the pixel electrode via a liquid crystal and connected to a given counter electrode bus line of the plurality of counter electrode bus lines; a source driver, connected to one end of each of the plurality of source bus lines, which supplies the given source bus line with a source signal; and a gate driver, connected to one end of each of the plurality of gate bus lines, which sequentially supplies the given gate bus line with a conducting signal that renders the transistor conducting, the display panel including a counter electrode driver which, in a single scanning period from a point in time where the gate driver supplies the given gate bus line with the conducting signal to a point in time where the gate driver supplies the conducting signal next, supplies the given counter electrode bus line with a rectangular voltage signal composed of a first voltage level and a second voltage level that is different from the first voltage level. Therefore, in a single scanning period from a point in time where the gate driver supplies the given gate bus line with the conducting signal to a point in time where the gate driver supplies the conducting signal next, a first voltage level and a second voltage level that is different from the first voltage level can be applied to the pixel electrode connected via the transistor to the given gate bus line.

Generally, the brightness of an image that is displayed by a pixel region changes according to a voltage that is applied to the pixel electrode. Therefore, the foregoing configuration can cause the brightness of an image in the pixel region in which the pixel electrode has been formed to switch between two values in the single scanning period.

This brings about an effect of making it possible to suppress the phenomenon of blurring of moving images.

Further, in the display panel according to the present invention, the blurring of moving images can be suppressed without using a frame memory in which to temporarily store image signals. Therefore, as compared with a conventional configuration that uses a frame memory in which to temporarily store image signals, the display panel according to the present invention brings about an effect of making it possible to reduce manufacturing cost. Further, as compared with a conventional configuration that uses a frame memory in which to temporarily store image signals, the display panel according to the present invention brings about an effect of making it possible to reduce power consumption.

Further, a driving method according to the present invention is a method for driving a display panel including: a plurality of gate bus lines; a plurality of source bus lines; a plurality of counter electrode bus lines; a transistor including a gate connected to a given gate bus line of the plurality of gate bus lines and a source connected to a given source bus line of the plurality of source bus lines; a pixel electrode connected to a drain of the transistor; a counter electrode opposed to the pixel electrode via a liquid crystal and connected to a given counter electrode bus line of the plurality of counter electrode bus lines; a source driver, connected to one end of each of the plurality of source bus lines, which supplies the given source bus line with a source signal; and a gate driver, connected to one end of each of the plurality of gate bus lines, which sequentially supplies the given gate bus line with a conducting signal that renders the transistor conducting, the method including a voltage signal supplying step of, in a single scanning period from a point in time where the gate driver supplies the given gate bus line with the conducting signal to a point in time where the gate driver supplies the conducting signal next, supplying the given counter electrode bus line with a rectangular voltage signal composed of at least a first voltage level and a second voltage level that is different from the first voltage level.

The foregoing method brings about the same effects as the foregoing display panel according to the present invention.

### Advantageous Effects of Invention

As described above, a display panel according to the present invention is a display panel including: a plurality of gate bus lines; a plurality of source bus lines; a plurality of counter electrode bus lines; a transistor including a gate connected to a given gate bus line of the plurality of gate bus lines and a source connected to a given source bus line of the plurality of source bus lines; a pixel electrode connected to a drain of the transistor; a counter electrode opposed to the pixel electrode via a liquid crystal and connected to a given counter electrode bus line of the plurality of counter electrode bus lines; a source driver, connected to one end of each of the plurality of source bus lines, which supplies the given source bus line with a source signal; and a gate driver, connected to one end of each of the plurality of gate bus lines, which sequentially supplies the given gate bus line with a conducting signal that renders the transistor conducting, the display panel including a counter electrode driver which, in a single scanning period from a point in time where the gate driver supplies the given gate bus line with the conducting signal to a point in time where the gate driver supplies the conducting signal next, supplies the given counter electrode bus line with a rectangular voltage signal composed of at least a first voltage level and a second voltage level that is different from the first voltage level.

Therefore, in the display panel according to the present invention, the blurring of moving images can be suppressed without using a frame memory in which to temporarily store image signals. Therefore, as compared with a conventional configuration that uses a frame memory in which to temporarily store image signals, manufacturing cost can be reduced. Further, as compared with a conventional configuration that uses a frame memory in which to temporarily store image signals, power consumption can be reduced.

### BRIEF DESCRIPTION OF DRAWINGS

FIG. 1 is a block diagram showing a configuration of a display panel according to a first embodiment of the present invention.

FIG. 2 is a circuit diagram showing a configuration of a pixel region of the display panel according to the first embodiment of the present invention.

FIG. 3 serves to explain a first example of operation of the display panel according to the first embodiment of the present invention, (a) being a timing chart showing a waveform of a source signal, (b) being a timing chart showing a waveform of a gate signal, (c) being a timing chart showing a potential of a pixel electrode, (d) being a timing chart showing a waveform of a counter electrode signal.

FIG. 4 serves to explain a second example of operation of the display panel according to the first embodiment of the present invention, (a) being a timing chart showing a waveform of a source signal, (b) being a timing chart showing a waveform of a gate signal, (c) being a timing chart showing a potential of a pixel electrode, (d) being a timing chart showing a waveform of a counter electrode signal.

FIG. 5 serves to explain a third example of operation of the display panel according to the first embodiment of the present invention, (a) being a timing chart showing a waveform of a source signal, (b) being a timing chart showing a waveform of a gate signal, (c) being a timing chart showing a potential of a pixel electrode, (d) being a timing chart showing a waveform of a counter electrode signal.

FIG. 6 serves to explain a fourth example of operation of the display panel according to the first embodiment of the present invention, (a) being a timing chart showing a waveform of a source signal, (b) being a timing chart showing a waveform of a gate signal, (c) being a timing chart showing a potential of a pixel electrode, (d) being a timing chart showing a waveform of a counter electrode signal.

FIG. 7 serves to explain a fifth example of operation of the display panel according to the first embodiment of the present invention, (a) being a timing chart showing a waveform of a source signal, (b) being a timing chart showing a waveform of a gate signal, (c) being a timing chart showing a potential of a pixel electrode, (d) being a timing chart showing a waveform of a counter electrode signal.

FIG. 8 serves to explain a sixth example of operation of the display panel according to the first embodiment of the present invention, (a) being a timing chart showing a waveform of a source signal, (b) being a timing chart showing a waveform of a gate signal, (c) being a timing chart showing a potential of a pixel electrode, (d) being a timing chart showing a waveform of a counter electrode signal.

FIG. 9 serves to explain an example of operation of the display panel according to the first embodiment of the present invention, (a) being a timing chart showing waveforms of gate signals, (b) being a timing chart showing examples of waveforms of counter electrode signals, (c) being a timing chart showing other example of waveforms of counter electrode signals.

FIG. 10 serves to explain a seventh example of operation of the display panel according to the first embodiment of the present invention, (a) being a timing chart showing waveforms of gate signals, (b) being a timing chart showing waveforms of counter electrode signals.

FIG. 11 serves to explain an example of operation of the display panel according to the first embodiment of the present invention, (a) being a timing chart showing a waveform of a source signal, (b) being a timing chart showing a waveform of a gate signal, (c) being a timing chart showing a potential of a pixel electrode, (d) being a timing chart showing a waveform of a counter electrode signal having a duty ratio.

FIG. 12 serves to explain an example of operation of the display panel according to the first embodiment of the present invention, (a) being a timing chart showing a waveform of a source signal, (b) being a timing chart showing a waveform of a gate signal, (c) being a timing chart showing a potential of a pixel electrode, (d) being a timing chart showing a waveform of a counter electrode signal having another duty ratio.

FIG. 13, which serves to explain an effect of the display panel according to the first embodiment of the present invention, is a graph representing a relationship between the duty ratio and brightness.

FIG. 14, which serves to explain an effect of the display panel according to the first embodiment of the present invention, is a graph representing a relationship between the duty ratio and visibility.

FIG. 15 serves to explain an example of operation of the display panel according to the first embodiment of the present invention, (a) being a timing chart showing a waveform of a gate signal, (b) being a timing chart showing an example of a waveform of a counter electrode signal, (c) being a timing chart showing an example of a potential of an pixel electrode, (d) being a timing chart showing another example of a waveform of a counter electrode signal, (e) being a timing chart showing another example of a potential of an pixel electrode.

FIG. 16, which serves to explain an example of operation of the display panel according to the first embodiment of the present invention, is a graph showing a relationship between the amplitude of a source signal and brightness as obtained by changing the amplitude of a counter electrode signal.

FIG. 17 is a block diagram showing a configuration of a counter electrode driver in the display panel according to the first embodiment of the present invention.

FIG. 18 is a block diagram showing a configuration of a display panel according to a second embodiment of the present invention.

FIG. 19 serves to explain an example of operation of the display panel according to the second embodiment of the present invention, (a) being a timing chart showing waveforms of gate signals, (b) being a timing chart showing waveforms of counter electrode signals.

FIG. 20 is a block diagram showing a configuration of a display panel according to a third embodiment of the present invention.

FIG. 21 is a circuit diagram showing a configuration of a display section in a display panel according to the third embodiment of the present invention.

FIG. 22 is a circuit diagram showing a configuration of a display section in a display panel according to a fourth embodiment of the present invention.

FIG. 23, which is a diagram showing an example of operation of the display panel according to the fourth embodiment of the present invention, is a diagram showing the polarities of potentials that are applied to pixel electrodes formed in the respective pixel regions of the display panel.

### DESCRIPTION OF EMBODIMENTS

### Embodiment 1

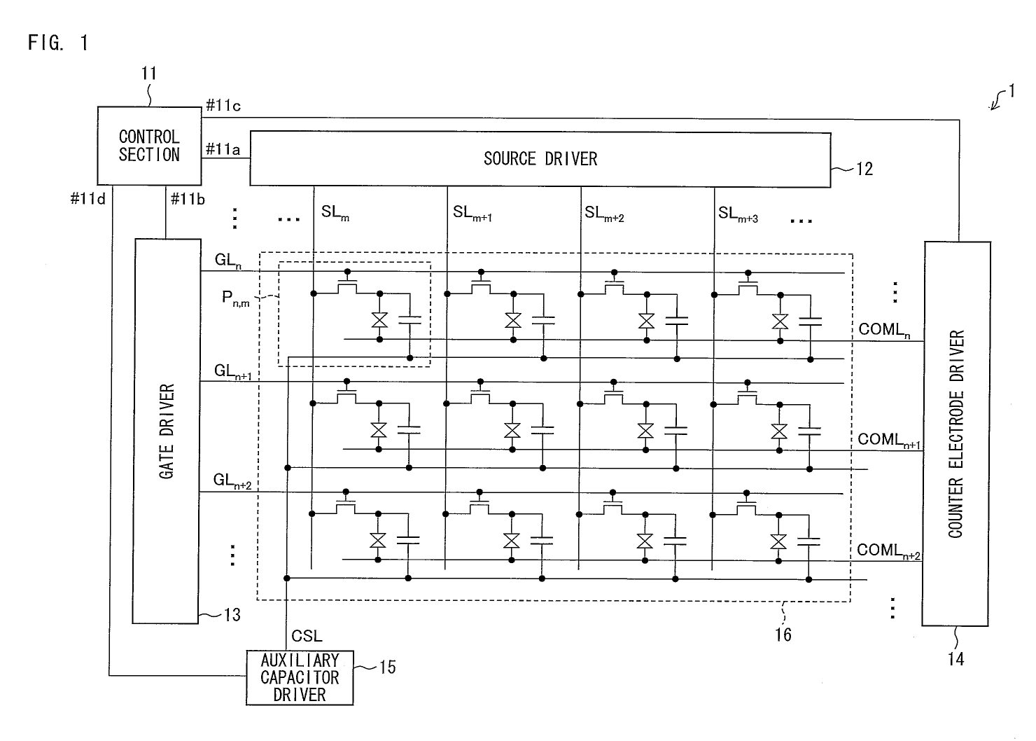

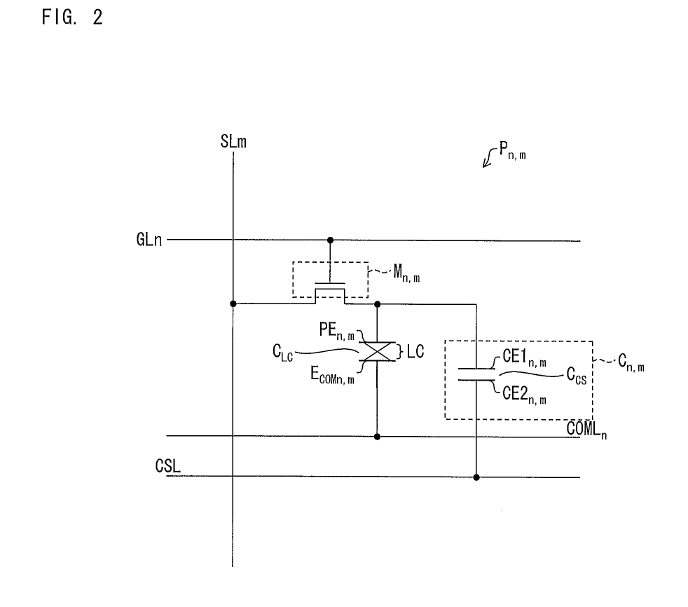

A configuration of a display panel according to a first embodiment of the present invention is described with reference to FIGS. 1 and 2. FIG. 1 is a block diagram showing a configuration of a display panel 1 according to the present embodiment. The display panel 1 is an active-matrix liquid crystal display panel.

As shown in FIG. 1, the display panel 1 includes a control section 11, a source driver 12, a gate driver 13, a counter electrode driver 14, an auxiliary capacitor driver 15, and a display section 16.

The control section 11 outputs a control signal #11a to control the source driver 12, a control signal #11b to control the gate driver 13, a control signal #11c to control the counter electrode driver 14, and a control signal #11d to control the auxiliary capacitor driver 15.

In the display section 16, N gate bus lines GL₁ to GL_{N} and M source bus lines SL₁ to SL_{M} are formed in such a reticular pattern as to intersect one another. Further, in the display section 16, N counter electrode bus lines COML₁ to COML_{N} are formed substantially in parallel with the N gate bus lines GL₁ to GL_{N}. Further, in the display section 16, an auxiliary capacitor bus line CSL is formed. In the following, as shown in FIG. 1, the nth gate bus line, the mth source bus line, and the nth counter electrode bus line are represented as “gate bus line GLₙ”, “source bus line SLₘ”, and “counter electrode bus line COMLₙ”, respectively.

Further, as shown in FIG. 1, the display section 16 includes a pixel region P_{n,m} defined by the gate bus line GLₙ (1≦n≦N) and the source bus line SLₘ(1≦m≦M).

As shown in FIG. 1, the M source bus lines SL₁ to SL_{M} have their terminals connected to the source driver 12. The source driver 12 supplies the M source bus lines SL₁ to SL_{M} with source signals #SL₁ to #SL_{M}, respectively.

Further, the N gate bus lines GL₁ to GL_{N} have their terminals connected to the gate driver 13. The gate driver 13 supplies the N gate bus lines GL₁ to GL_{N} with gate signals #GL₁ to #GL_{N}, respectively.

Further, the N counter electrode bus lines COML₁ to COML_{N} have their terminals connected to the counter electrode driver 14. The counter electrode driver 14 supplies the N counter electrode bus lines COML₁ to COML_{N} with counter electrode signals #COML₁ to #COML_{N}, respectively.

Further, the auxiliary capacitor bus line CSL has its terminal connected to the auxiliary capacitor driver 15. The auxiliary capacitor driver 15 supplies the auxiliary capacitor bus line CSL with an auxiliary capacitor potential V_{CS}.

FIG. 2 is a circuit diagram showing a configuration of the display panel 1 in the pixel region P_{n,m}. As shown in FIG. 2, the display panel 1 includes, in the pixel region P_{n,m} a transistor M_{n,m} having its gate connected to the gate bus line GLₙ and its source connected to the source bus line SLₘ. The transistor M_{n,m} is, for example, a thin-film transistor (TFT), but, in the present invention, is not to be limited to a specific type of transistor. Further, in the present embodiment, the transistor M_{n,m} is described by taking, as an example, a transistor that switches into a conducting state when a high-level potential is applied to the gate and switches into a cutoff state when a low-level potential is applied to the gate. However, the present invention is not to be limited to such an example. The present invention can be applied to even a transistor that switches into a conducting state when a low-level potential is applied to the gate and switches into a cutoff state when a high-level potential is applied to the gate.

Further, as shown in FIG. 2, the transistor M_{n,m} has its drain connected to a pixel electrode PE_{n,m}. Further, the display panel 1 includes, in the pixel region P_{n,m}, a counter electrode E_{COMn,m} opposed to the pixel electrode PE_{n,m}, and the counter electrode E_{COMn,m} is connected to the counter electrode bus line COMLₙ. Further, the display panel 1 includes a liquid crystal LC between the pixel electrode PE_{n,m} and the counter electrode E_{COMn,m}, with a pixel capacitor C_{LC} formed between the pixel electrode PE_{n,m} and the counter electrode E_{COMn,m}.

An electric field corresponding to the potential difference between the potential V_{PEn,m} of the pixel electrode PE_{n,m} and the potential V_{ECOMn,m} of the counter electrode E_{COMn,m} is induced between the pixel electrode PE_{n,m} and the counter electrode E_{COMn,m}, and the orientation of the liquid crystal LC is determined according to the magnitude of the electric field. Further, the transmittance of the liquid crystal LC is determined according to the absolute value of the potential difference between the potential V_{PEn,m} and the potential V_{ECOMn,m}. The present embodiment is described by taking, as an example, a case of normally black in which as the absolute value of the potential difference becomes larger, the transmittance of the liquid crystal LC becomes higher. However, the present invention is not to be limited to such an example. Even a case of normally white in which as the absolute value of the potential difference becomes larger, the transmittance of the liquid crystal LC becomes lower can be applied. It should be noted that the higher the transmittance of the liquid crystal LC becomes, the higher the brightness of an image that is displayed in the pixel region P_{n,m}, which includes the liquid crystal LC, becomes.

Further, the transistor M_{n,m} has its drain connected to a first auxiliary capacitor electrode CE1_{n,m} parallel to the pixel electrode PE_{n,m}. Further, the pixel region P_{n,m} includes a second auxiliary capacitor electrode CE2_{n,m} opposed to the first auxiliary capacitor electrode CE1_{n,m} and connected to the auxiliary capacitor bus line CSL, with an auxiliary capacitor C_{CS} formed between the first auxiliary capacitor electrode CE1_{n,m} and the second auxiliary capacitor electrode CE2_{n,m} in parallel with the pixel capacitor C_{LC}. In other words, the first auxiliary capacitor electrode CE1_{n,m} and the second auxiliary capacitor electrode CE2_{n,m} constitute a capacitor C_{n,m} having the auxiliary capacitor C_{CS}.

Although the present embodiment is described by taking, as an example, a case where the pixel region P_{n,m} of the display panel 1 includes the capacitor C_{n,m}, the present invention is not to be limited to such an example. That is, the present invention can be applied even in a case where the pixel region P_{n,m} does not include such a capacitor C_{n,m}.

(Example 1 of Operation of the Display Panel 1)

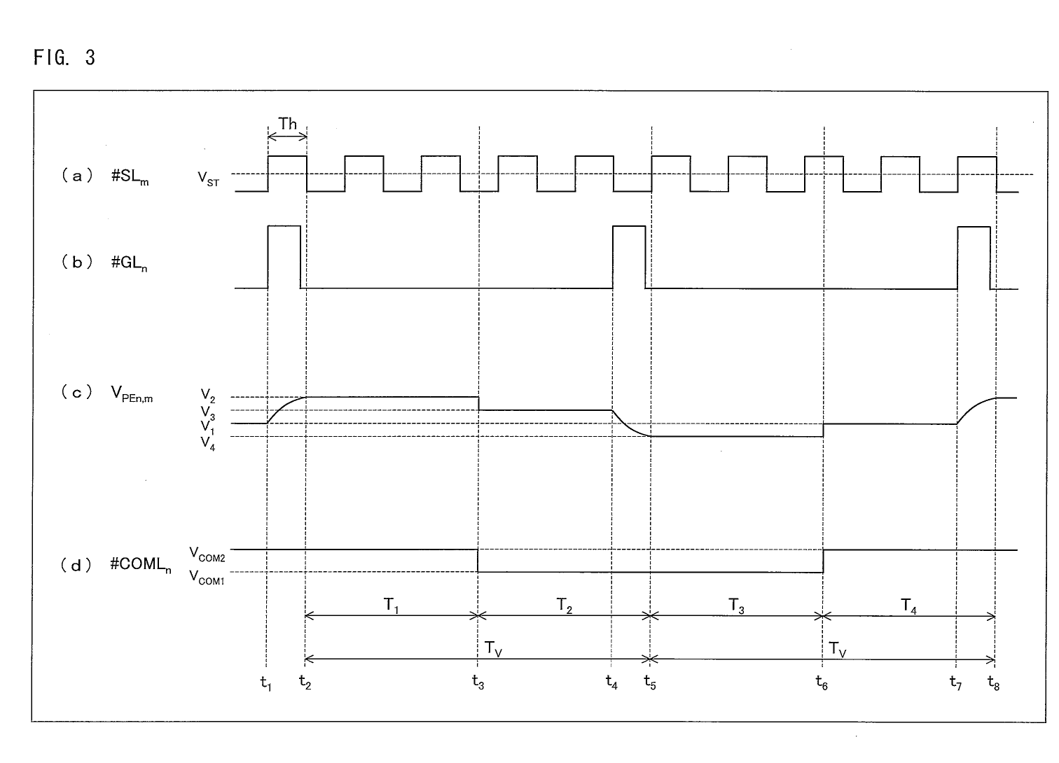

A first example of operation of the display panel 1 according to the present embodiment is described below with reference to (a) through (d) of FIG. 3.

(a) of FIG. 3 is a timing chart showing an example of a waveform of the source signal #SLₘ, which is supplied to the source bus line SLₘ.

Further, the following description assumes that the auxiliary capacitor bus line CSL is at a constant potential.

(b) of FIG. 3 is a timing chart showing an example of a waveform of the gate signal #GLₙ, which is supplied to the gate bus line GLₙ.

(c) of FIG. 3 is a timing chart showing a potential V_{PEn,m} of the liquid crystal electrode PE_{n,m}.

(d) of FIG. 3 is a timing chart showing a waveform of the counter electrode signal #COMLₙ, which is supplied to the counter electrode bus line COMLₙ. As shown in (d) of FIG. 3, the counter electrode signal #COMLₙ is a signal that alternately takes on a potential V_{COM1} and a potential V_{COM2} in a single cycle composed of two consecutive vertical scanning periods T_{V}. More specifically, as shown in (d) of FIG. 3, the counter electrode signal #COMLₙ takes on the potential V_{COM2} during a period T₁ in a single vertical scanning period T_{V}, and takes on the potential V_{COM2} during a period T₂. Further, the counter electrode signal #COMLₙ takes on the potential V_{COM1} during a period T₃ in the ensuing vertical scanning period T_{V}, and takes on the potential V_{COM2} during a period T₄. It is assumed that as shown in (d) of FIG. 3, specific values of the potentials V_{COM1} and V_{COM2} satisfy V_{COM1}<V_{COM2}.

As shown in (c) and (d) of FIG. 3, when the counter electrode signal #COMLₙ is at the highest potential (potential V_{COM2}) and the gate signal #GLₙ is at a high level, the voltage that is applied to the liquid crystal LC changes into a positive polarity; and when the counter electrode signal #COMLₙ is at the lowest potential (potential V_{COM1}) and the gate signal #GLₙ is at a high level, the voltage that is applied to the liquid crystal LC changes into a negative polarity.

The “voltage that is applied to the liquid crystal LC” here means a voltage of a difference between the potential that is applied to the pixel electrode PE_{n,m} and the potential that is applied to the counter electrode E_{COMn,m} (same applies below).

Further, in the present embodiment, a case is described where the potential V_{PEn,m}, which is applied to the pixel electrode PE_{n,m}, has the same polarity as a potential V_{PEn,t} (t≠m, 1≦t≦M) that is applied to a pixel electrode PE_{n,t}.

Further, each single vertical scanning period T_{V} is defined as including a boundary time at a point in time where the period starts, but not including a boundary time at a point in time where the period ends. That is, in (d) of FIG. 3, each single vertical period T_{V} is defined as a set of times t that satisfy t₂≦t<t₅ or as a set of times t that satisfy t₅≦t≦t₈ (same applies below).

The following describes the operation of each of the components in the pixel region P_{n,m} of the display panel 1.

First, as shown in (b) of FIG. 3, the gate signal #GLₙ rises from a low level to a high level at the time t₁ and, after a certain period of time has elapsed, falls to a low level. In a period of time during which the gate signal #GLₙ is at a high level, the transistor M_{n,m} is in a conducting state. When the transistor M_{n,m} is in a conducting state, the source signal #SLₘ is supplied to the pixel electrode PE_{n,m} and the first auxiliary capacitor electrode CE1_{n,m}. As shown in (c) of FIG. 3, in a period from the time t₁ to the time t₂, the potential V_{PEn,m} of the pixel electrode PE_{n,m} increases from a potential V₁ to a potential V₂ (V₂>V_{COM2}).

Then, the counter electrode signal #COMLₙ falls from the potential V_{COM2} to the potential V_{COM1} at the time t₃. That is, the potential of the counter electrode E_{COMn,m} falls from the potential V_{COM2} to the potential V_{COM1}. Since the gate signal #GLₙ is at a low level at this point in time, the transistor M_{n,m} is in a cutoff state. Therefore, a sum of the charge stored in the pixel electrode PE_{n,m} and the charge stored in the first auxiliary capacitor electrode CE1_{n,m} is invariable. Meanwhile, when the value of the counter electrode signal #COMLₙ changes, the charge stored in the pixel electrode PE_{n,m} and the charge stored in the first auxiliary capacitor electrode CE1_{n,m} change. Accordingly, the potential V_{PEn,m} of the pixel electrode PE_{n,m} changes from the potential V₂ to a potential V₃. It should be noted here that a specific value of the potential V₃ is defined as:

V₃=(V_{COM1}−V_{COM2})×C_{LC}/Σ_{C}+V₂.

Since V_{COM1}<V_{COM2} as mentioned above, the potential V₃ is smaller than the potential V₂.

It should be noted that Σ_{C} is the sum of the capacitors connected to the drain of the transistor M_{n,m} in parallel with each other. For example, in such a case where the pixel capacitor C_{LC} and the auxiliary capacitor C_{CS} are the only capacitors connected to the drain of the transistor M_{n,m}, Σ_{C}=C_{LC}+C_{CS}. However, generally, in addition to these capacitors, a capacitor (parasitic capacitor) Cgd exists between the drain of the transistor M_{n,m} and the gate bus line GLₙ and a capacitor (parasitic capacitor) Csd exists between the drain of the transistor M_{n,m} and the source bus line SLₘ. In such a case, Σ_{C}=C_{LC}+C_{CS}+Cgd+Csd. Alternatively, in such a case where in addition to these capacitors, a further capacitor Cext exists in parallel with the liquid crystal capacitor C_{LC}, Σ_{C}=C_{LC}+C_{CS}+Cgd+Csd+Cext (same applies below).

Further, the potential V₃, the potential V₂, the potential V_{COM1}, and the potential V_{COM2} satisfy V₃−V_{COM1}−(V₂−V_{COM2})=(V_{COM2}−V_{COM1})×(Σ_{C}−C_{LC})/Σ_{C}, and since V_{COM1}<V_{COM2} as mentioned above, V₃−V_{COM1}>V₂−V_{COM2} holds. That is, the potential difference between the potential V_{PEn,m} of the pixel electrode PE_{n,m} and the potential V_{ECOMn,m} of the counter electrode E_{COMn,m} in a period from the time t₃ to the time t₄ is greater than the potential difference between the potential V_{PEn,m} of the pixel electrode PE_{n,m} and the potential V_{ECOMn,m} of the counter electrode E_{COMn,m} in a period from the time t₂ to the time t₃. Therefore, the brightness of the pixel region P_{n,m} in the period from the time t₃ to the time t₄ is greater than the brightness of the pixel region P_{n,m} in the period from the time t₂ to the time t₃.

Then, the gate signal #GLₙ rises from a low level to a high level at the time t₄ and, after a certain period of time has elapsed, falls to a low level. In a period of time during which the gate signal #GLₙ is at a high level, the transistor M_{n,m} is in a conducting state, so that the source signal #SLₘ is supplied to the pixel electrode PE_{n,m} and the first auxiliary capacitor electrode CE1_{n,m}.

As shown in (c) of FIG. 3, in a period from the time t₄ to the time t₅, the potential V_{PEn,m} of the pixel electrode PE_{n,m} decreases from the potential V₃ to a potential V₄ (V₄<V_{COM1}).

Then, the counter electrode signal #COMLₙ rises from the potential V_{COM1} to the potential V_{COM2} at the time t₆. That is, the potential of the counter electrode E_{COMn,m} rises from the potential V_{COM1} to the potential V_{COM2}. Since the gate signal #GLₙ is at a low level at this point in time, the transistor M_{n,m} is in a cutoff state. Therefore, a sum of the charge stored in the pixel electrode PE_{n,m} and the charge stored in the first auxiliary capacitor electrode CE1_{n,m} is invariable. Meanwhile, when the value of the counter electrode signal #COMLₙ changes, the charge stored in the pixel electrode PE_{n,m} and the charge stored in the first auxiliary capacitor electrode CE1_{n,m} change. Accordingly, the potential V_{PEn,m} of the pixel electrode PE_{n,m} changes from the potential V₄ to the potential V₁. It should be noted here that a specific value of the potential V₁ is defined as:

V₁=(V_{COM2}−V_{COM1})×C_{LC}/ΣC+V₄.

Further, since V_{COM1}<V_{COM2} as mentioned above, the potential V₁ is greater than the potential V₄.

Further, the potential V₁, the potential V₄, the potential V_{COM1}, and the potential V_{COM2} satisfy V_{COM2}−V₁−(V_{COM1}−V₄)=(V_{COM2}−V_{COM1})×(Σ_{C}−C_{LC})/Σ_{C}, and since V_{COM1}<V_{COM2} as mentioned above, V_{COM2}−V₁>(V_{COM1}−V₄) holds. That is, the potential difference between the potential V_{PEn,m} of the pixel electrode PE_{n,m} and the potential V_{ECOMn,m} of the counter electrode E_{COMn,m} in a period from the time t₆ to the time t₇ is greater than the potential difference between the potential V_{PEn,m} of the pixel electrode PE_{n,m} and the potential V_{ECOMn,m} of the counter electrode E_{COMn,m} in a period from the time t₅ to the time t₆. Therefore, the brightness of the pixel region P_{n,m} in the period from the time t₆ to the time t₇ is greater than the brightness of the pixel region P_{n,m} in the period from the time t₅ to the time t₆.

The operation at the time t₇ and later is the same as the operation at the time t₁ and later.

It should be noted that a period of time during which the gate signal #GLₙ shown in (b) of FIG. 3 is at a high level is sufficiently shorter than a single vertical scanning period T_{V}.

As described above, the display panel 1 according to the present embodiment is a display panel including: a plurality of gate bus lines GL₁ to GL_{N}; a plurality of source bus lines SL₁ to SLₘ; a plurality of counter electrode bus lines COML₁ to COML_{N}; a transistor M_{n,m} including a gate connected to a given gate bus line GLₙ of the plurality of gate bus lines and a source connected to a given source bus line SLₘ of the plurality of source bus lines; a pixel electrode PE_{n,m} connected to a drain of the transistor; a counter electrode E_{COMn,m} opposed to the pixel electrode via a liquid crystal (liquid crystal LC) and connected to a given counter electrode bus line COMLₙ of the plurality of counter electrode bus lines; a source driver 12, connected to one end of each of the plurality of source bus lines, which supplies the given source bus line SLₘ with a source signal #SLₘ; and a gate driver 13, connected to one end of each of the plurality of gate bus lines, which sequentially supplies the given gate bus line GL_{N} with a conducting signal (high-level interval of a gate signal #GLₙ) that renders the transistor conducting, the display panel including a counter electrode driver 14 which, in a single scanning period (single vertical scanning period T_{V}) from a point in time where the gate driver 13 supplies the given gate bus line with the conducting signal to a point in time where the gate driver supplies the conducting signal next, supplies the given counter electrode bus line COMLₙ with a rectangular voltage signal (counter electrode signal #COMLₙ) composed of at least a first voltage level and a second voltage level that is different from the first voltage level (i.e., a potential V_{COM1} and a potential V_{COM2}).

Therefore, in the single scanning period, the display panel 1 can apply a two-valued voltage level to the pixel electrode connected via the transistor to the given gate bus line. That is, the display panel 1 can cause the brightness of an image in the pixel region P_{n,m}, in which the pixel electrode PE_{n,m} has been formed, to switch between two values in the single scanning period.

This makes it possible to suppress the aforementioned phenomenon of blurring of moving images.

Further, in the display panel 1 according to the present invention, the blurring of moving images can be suppressed without using a frame memory in which to temporarily store image signals. Therefore, as compared with a conventional configuration that uses a frame memory in which to temporarily store image signals, manufacturing cost can be reduced. Further, as compared with a conventional configuration that uses a frame memory in which to temporarily store image signals, power consumption can be reduced.

Further, in the display panel 1 according to the present embodiment, in the single scanning period (single vertical scanning period T_{V}), the counter electrode driver 14 supplies the given counter electrode bus line COMLₙ with the rectangular voltage signal (counter electrode signal #COMLₙ) in synchronization with the conducting signal (high-level interval of the gate signal #GLₙ), the rectangular voltage signal being composed of at least the first and second voltage levels.

Therefore, unlike in a case where a voltage signal is supplied out of synchronization with the conducting signal, the switching between bright and dark can be carried out in every pixel region on the screen after a certain period of time has elapsed since an update of image data. Further, a proportion between a period of display at a high brightness and a period of display at a low brightness can be made substantially equal in any place on the screen, so that blurring of moving images can be effectively suppressed.

Further, according to this example of operation, the rectangular voltage signal (counter electrode signal #COMLₙ) takes on either one of the first and second voltage levels (i.e., either one voltage level of the potentials V_{COM1} and V_{COM2}) in an at least 10% continuous period of time of the single scanning period.

Therefore, the phenomenon of blurring of moving images can be effectively suppressed.

Further, according to this example of operation, the rectangular voltage signal (counter electrode signal #COMLₙ) takes on either one of the first and second voltage levels in a period of time from a point in time at which the single scanning period (single vertical scanning period T_{V}) starts to a point in time where substantially 10% of the single scanning period elapses, and takes on the other one of the first and second voltage levels in a period of time from a point in time where substantially 90% of the single scanning period elapses to a point in time at which the single scanning period ends.

Generally, in the case of switching between a display at a high brightness and a display at a low brightness, the viewer feels no improvement in blurring of moving images when the percentage of the display at the high brightness is 90% or higher, feels more improvement in blurring of moving images at a lower percentage between 90% to 10%, and feels satisfactory improvement in blurring of moving images a percentage of approximately 10%.

Therefore, according to the foregoing configuration, the phenomenon of blurring of moving images can be effectively suppressed.

Further, the display panel according to the present invention may be configured such that in the single scanning period (single vertical scanning period T_{V}), the polarity of a voltage that is applied to the liquid crystal when the rectangular voltage signal (counter electrode signal #COMLₙ) is at the first voltage level and the polarity of a voltage that is applied to the liquid crystal when the rectangular voltage signal is at the second voltage level are polarities that are different from each other.

That is, the display panel according to the present invention may be configured such that in the single scanning period (single vertical scanning period T_{V}), the polarity of a voltage that is applied to the liquid crystal as represented by a difference between the potential V_{PEn,m} of the pixel electrode PE_{n,m} and the potential of the counter electrode E_{COMn,m} when the rectangular voltage signal (counter electrode signal #COMLₙ) is at the potential V_{COM1} and the polarity of a voltage that is applied to the liquid crystal as represented by a difference between the potential V_{PEn,m} of the pixel electrode PE_{n,m} and the potential of the counter electrode E_{COMn,m} when the rectangular voltage signal (counter electrode signal #COMLₙ) is at the potential V_{COM2} are polarities that are different from each other.

According to the foregoing configuration, regardless of whether the rectangular voltage signal is at the first or second voltage level, the absolute value of the voltage that is applied to the liquid crystal can be made sufficiently small.

Therefore, according to the foregoing configuration, in a normally black type in which the brightness is lower in a case where the absolute value of a voltage that is applied to the liquid crystal is smaller, a black display can be carried out at a sufficiently low brightness, regardless of whether the rectangular voltage signal is at the first or second voltage level.

Further, the display panel according to the present invention may be configured such that the absolute value of the potential difference between the first voltage level and the second voltage level is twice or less as great as the threshold voltage of the liquid crystal.

That is, the display panel according to the present invention may be configured such that the absolute value |V_{COM1}−V_{COM2}| of the potential difference between the potential V_{COM1} and the potential V_{COM2} is twice or less as great as the threshold voltage of the liquid crystal LC.

Generally, the orientation of a liquid crystal is not affected even when a voltage that is equal to or lower than the threshold voltage is applied to the liquid crystal. In other words, the threshold voltage means a voltage at which the orientation of a liquid crystal starts to be affected (same applies below). The threshold voltage can be defined, for example, as a voltage 1/100 times as great as a saturation voltage at which the transmittance of the liquid crystal gets saturated.

Assuming that the voltage difference between the voltage that is applied to the liquid crystal as represented by the difference between the potential of the pixel electrode PE_{n,m} and the potential V_{COMn,m} of the counter electrode in a case where the counter electrode signal #COMLₙ is at the potential V_{COM1} and the voltage that is applied to the liquid crystal as represented by the difference between the potential of the pixel electrode PE_{n,m} and the potential V_{COMn,m} of the counter electrode in a case where the counter electrode signal #COMLₙ is at the potential V_{COM2} is represented as ΔV_{LC}, ΔV_{LC} satisfies:

ΔV_{LC}=(V_{COM2}−V_{COM1})×(Σ_{C}−C_{LC})/Σ_{C}.

It should be noted here that since (Σ_{C}−C_{LC})/Σ_{C}<1, ΔV_{LC}<(V_{COM2}−V_{COM1}) is derived.

Further, assuming that the voltage that is applied to the liquid crystal as represented by the difference between the potential of the pixel electrode PE_{n,m} and the potential V_{COMn,m} of the counter electrode is expressed as V_{LC}, it is desirable that in a case where the potential of the counter electrode signal #COMLₙ is the potential V_{COM1}, V_{LC} be set as V_{LC}=−ΔV_{LC}/2, and that in a case where the potential of the counter electrode signal #COMLₙ is the potential V_{COM2}, V_{LC} be set as V_{LC}=ΔV_{LC}/2. It should be noted here that as long as ΔV_{LC}/2 is equal to or less than the threshold voltage V_{LCth}, i.e., ΔV_{LC}/2≦V_{LCth}, a black display can be carried out regardless of whether the potential of the counter electrode signal #COMLₙ is the potential V_{COM1} or the potential V_{COM2}. Therefore, as long as V_{COM2}−V_{COM1}≦2×V_{LCth}, a black display can be carried out regardless of whether the potential of the counter electrode signal #COMLₙ is the potential V_{COM1} or the potential V_{COM2}.

According to the foregoing configuration, as described above, in a normally black type in which the brightness is lower in a case where the absolute value of a voltage that is applied to the liquid crystal is smaller, a black display can be carried out regardless of whether the voltage level of the rectangular voltage signal is the first or second voltage level.

It should be noted that substantially the same method of derivation as above can apply to the examples of operation to be described later.

As described above, according to the foregoing configuration, the absolute value of the potential difference between the first voltage level and the second voltage level is twice or less as great as the threshold voltage of the liquid crystal. This makes it possible to prevent the orientation of the liquid crystal from being affected, regardless of whether the rectangular voltage signal is at the first or second voltage level.

Therefore, the foregoing configuration brings about a further effect of making it possible, in a normally black type in which the brightness is lower in a case where the absolute value of a voltage that is applied to the liquid crystal is smaller, to carry out a black display regardless of whether the rectangular voltage signal is at the first or second voltage level.

(Example 2 of Operation of the Display Panel 1)

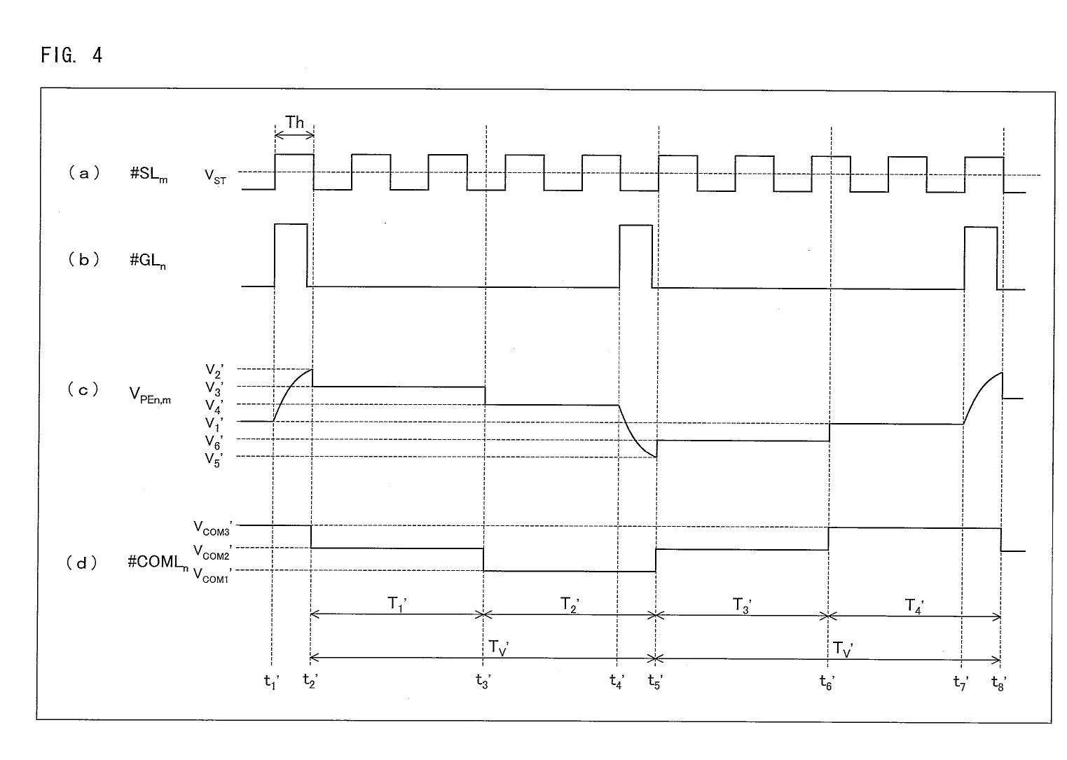

A second example of operation of the display panel 1 according to the present embodiment is described below with reference to (a) through (d) of FIG. 4.

(a) of FIG. 4 is a timing chart showing an example of a waveform of the source signal #SLₘ, which is supplied to the source bus line SLₘ. This waveform is substantially the same as the waveform of the source signal #SLₘ shown in (a) of FIG. 3.

(b) of FIG. 4 is a timing chart showing a waveform of the gate signal #GLₙ, which is supplied to the gate bus line GLₙ. As shown in (b) of FIG. 4, the waveform of the gate signal #GLₙ in this example of operation is described as being the same as the waveform of the gate signal #GLₙ shown in (b) of FIG. 3.

(c) of FIG. 4 is a timing chart showing a potential V_{PEn,m} of the liquid crystal electrode PE_{n,m}.

(d) of FIG. 4 is a timing chart showing a waveform of the counter electrode signal #COMLₙ, which is supplied to the counter electrode bus line COMLₙ. As shown in (d) of FIG. 4, the counter electrode signal #COMLₙ in this example of operation is a signal that takes on a potential V_{COM1}′, a potential V_{COM2}′, and a potential V_{COM3}′ in a single cycle composed of two consecutive vertical scanning periods T_{V}′. More specifically, as shown in (d) of FIG. 4, the counter electrode signal #COMLₙ takes on the potential V_{COM2}′ during a period T₁′ in a single vertical scanning period T_{V}′, and takes on the potential V_{COM1}′ during a period T₂′. Further, the counter electrode signal #COMLₙ takes on the potential V_{COM2}′ during a period T₃′ in the ensuing vertical scanning period T_{V}′, and takes on the potential V_{COM3}′ during a period T₄′. It is assumed that as shown in (d) of FIG. 4, specific values of the potentials V_{COM1}′, V_{COM2}′, and V_{COM2}′ satisfy V_{COM1}′<V_{COM2}′<V_{COM3}′.

As shown in (c) and (d) of FIG. 4, when the counter electrode signal #COMLₙ is at the highest potential (potential V_{COM3}′) and the gate signal #GLₙ is at a high level, the voltage that is applied to the liquid crystal LC changes into a positive polarity; and when the counter electrode signal #COMLₙ is at the lowest potential (potential V_{COM1}′) and the gate signal #GLₙ is at a high level, the voltage that is applied to the liquid crystal LC changes into a negative polarity.

The following describes the operation of each of the components in the pixel region P_{n,m} of the display panel 1 in this example of operation.

First, as shown in (b) of FIG. 4, the gate signal #GLₙ rises from a low level to a high level at the time t₁′ and, after a certain period of time has elapsed, falls to a low level. In a period of time during which the gate signal #GLₙ is at a high level, the transistor M_{n,m} is in a conducting state. When the transistor M_{n,m} is in a conducting state, the source signal #SLₘ is supplied to the pixel electrode PE_{n,m} and the first auxiliary capacitor electrode CE1_{n,m}. As shown in (c) of FIG. 4, in a period from the time t₁′ to the time t₂′, the potential V_{PEn,m} of the pixel electrode PE_{n,m} increases from a potential V₁′ to a potential V₂′ (V₂′>V_{COM3}′).

Further, the counter electrode signal #COMLₙ falls from the potential V_{COM3}′ to the potential V_{COM2}′ at the time t₂′. Since the gate signal #GLₙ is at a low level at this point in time, the transistor M_{n,m} is in a cutoff state. Therefore, a sum of the charge stored in the pixel electrode PE_{n,m} and the charge stored in the first auxiliary capacitor electrode CE1_{n,m} is invariable. Meanwhile, when the value of the counter electrode signal #COMLₙ changes, the charge stored in the pixel electrode PE_{n,m} and the charge stored in the first auxiliary capacitor electrode CE1_{n,m} change. Accordingly, the potential V_{PEn,m} of the pixel electrode PE_{n,m} changes from the potential V₂′ to a potential V₃′. It should be noted here that a specific value of the potential V₃′ is defined as:

V₃′=(V_{COM2}′−V_{COM3}′)×C_{LC}/Σ_{C}+V₂′.

Since V_{COM2}′<V_{COM3}′ as mentioned above, the potential V₃′ is smaller than the potential V₂′.

Then, the counter electrode signal #COMLₙ falls from the potential V_{COM2}′ to the potential V_{COM1}′ at the time t₃′. Accordingly, the potential V_{PEn,m} of the pixel electrode PE_{n,m} changes from the potential V₃′ to a potential V₄′. It should be noted here that a specific value of the potential V₄′ is defined as:

V₄′=(V_{COM1}′−V_{COM2}′)×C_{LC}/Σ_{C}+V₃′.

Since V_{COM1}′<V_{COM2}′ as mentioned above, the potential V₄′ is smaller than the potential V₃′.

Further, the potential V₃′, the potential V₄′, the potential V_{COM1}′, and the potential V_{COM2}′ satisfy V₄′−V_{COM1}′−(V₃′−V_{COM2}′)=(V_{COM2}′−V_{COM1}′)×(Σ_{C}−C_{LC})/Σ_{C}, and since V_{COM1}′<V_{COM2}′ as mentioned above, V₄′−V_{COM1}′>V₃′ V_{COM2}′ holds. That is, the potential difference between the potential V_{PEn,m} of the pixel electrode PE_{n,m} and the potential V_{ECOMn,m} of the counter electrode E_{COMn,m} in a period from the time t₃′ to the time t₄′ is greater than the potential difference between the potential V_{PEn,m} of the pixel electrode PE_{n,m} and the potential V_{ECOMn,m} of the counter electrode E_{COMn,m} in a period from the time t₂′ to the time t₃′. Therefore, the brightness of the pixel region P_{n,m} in the period from the time t₃′ to the time t₄′ is greater than the brightness of the pixel region P_{n,m} in the period from the time t₂′ to the time t₃′.

Then, the gate signal #GLₙ rises from a low level to a high level at the time t₄′ and, after a certain period of time has elapsed, falls to a low level. In a period of time during which the gate signal #GLₙ is at a high level, the transistor M_{n,m} is in a conducting state, so that the source signal #SLₘ is supplied to the pixel electrode PE_{n,m} and the first auxiliary capacitor electrode CE1_{n,m}.

As shown in (a) of FIG. 4, in a period from the time t₄′ to the time t₅′, the potential V_{PEn,m} of the pixel electrode PE_{n,m} decreases from the potential V₄′ to a potential V₅′ (V₅′<V_{COM1}′).

Further, the counter electrode signal #COMLₙ rises from the potential V_{COM1}′ to the potential V_{COM2}′ at the time t₅′. Accordingly, the potential V_{PEn,m} of the pixel electrode PE_{n,m} changes from the potential V₅′ to a potential V₆′. It should be noted here that a specific value of the potential V₆′ is defined as:

V₆′=(V_{COM2}′−V_{COM1}′)×C_{LC}/Σ_{C}+V₅′.

Since V_{COM1}′<V_{COM2}′ as mentioned above, the potential V₆′ is greater than the potential V₅′.

Then, the counter electrode signal #COMLₙ rises from the potential V_{COM2}′ to the potential V_{COM3}′ at the time t₆′. Accordingly, the potential V_{PEn,m} of the pixel electrode PE_{n,m} changes from the potential V₆′ to the potential V₁′. It should be noted here that a specific value of the potential V₁′ is defined as:

V₁′=(V_{COM3}′−V_{COM2}′)×C_{LC}/Σ_{C}+V₆′.

Since V_{COM2}′<V_{COM3}′ as mentioned above, the potential V₁′ is greater than the potential V₆′.

Further, the potential V₁′, the potential V₆′, the potential V_{COM2}′, and the potential V_{COM3}′ satisfy V_{COM3}′−V₁′−(V_{COM2}′−V₆′)=(V_{COM3}′−V_{COM2}′)×(Σ_{C}−C_{LC})/Σ_{C}, and since V_{COM2}′<V_{COM3}′ as mentioned above, V_{COM3}′−V₁′>V_{COM2}′−V₆′ holds. That is, the potential difference between the potential V_{PEn,m} of the pixel electrode PE_{n,m} and the potential V_{ECOMn,m} of the counter electrode E_{COMn,m} in a period from the time t₆′ to the time t₇′ is greater than the potential difference between the potential V_{PEn,m} of the pixel electrode PE_{n,m} and the potential V_{ECOMn,m} of the counter electrode E_{COMn,m} in a period from the time t₅′ to the time t₆′. Therefore, the brightness of the pixel region P_{n,m} in the period from the time t₆′ to the time t₇′ is greater than the brightness of the pixel region P_{n,m} in the period from the time t₅′ to the time t₆′.

The operation at the time t₇′ and later is the same as the operation at the time t₁′ and later.

The above example of operation has described a case where the counter electrode signal #COMLₙ falls from the potential V_{COM3}′ to the potential V_{COM2}′ at the time t₂′ and the counter electrode signal #COMLₙ rises from the potential V_{COM1}′ to the potential V_{COM2}′ at the time t₅′. However, more generally, the counter electrode signal #COMLₙ falls from the potential V_{COM3}′ to the potential V_{COM2}′ before several horizontal periods (period multiple times as long as a horizontal period Th) have elapsed since the time t₂′ and the counter electrode signal #COMLₙ rises from the potential V_{COM1}′ to the potential V_{COM2}′ before several horizontal periods (period multiple times as long as a horizontal period Th) have elapsed since the time t₅′.

As described above, according to this example of operation, in the single scanning period (single vertical scanning period T_{V}′), the counter electrode driver 14 supplies the given counter electrode bus line with a rectangular voltage signal (counter electrode signal #COMLₙ) in synchronization with the conducting signal, the rectangular voltage signal being composed of the first voltage level, the second voltage level, and a third voltage level that is different from the first and second voltage levels.

That is, according to this example of operation, in the single scanning period, the counter electrode driver 14 supplies a rectangular voltage signal (counter electrode signal #COMLₙ) composed of the potential V_{COM1}′, the potential V_{COM2}′, and the potential V_{COM3}′.

Therefore, according to this example of operation, in the single scanning period, a three-valued voltage level can be applied to the pixel electrode connected via the transistor to the given gate bus line. In other words, in the single scanning period, the level of voltage that is applied to the pixel electrode makes two transitions. The first transition between the voltage levels in the single scanning period causes a voltage that is applied to the liquid crystal after the first transitions between the voltage levels to be suitable for a display after the first transition between the voltage levels, and the second transition between the voltage levels allows switching between a high brightness and a low brightness.

That is, the foregoing configuration makes a display at a higher brightness possible while effectively suppressing the phenomenon of blurring of moving images.

Further, according to this example of operation, in a case where when the gate driver 13 supplies the given gate bus line GLₙ with the conducting signal (high-level interval of the gate signal #GLₙ), the given counter electrode bus line COMLₙ is supplied with the highest voltage level among the voltage levels, the counter electrode driver 14 supplies the given counter electrode bus line COMLₙ with the rectangular voltage signal (counter electrode signal #COMLₙ) in the single scanning period, the rectangular voltage signal #COMLₙ having its voltage levels arranged in a descending order.

That is, according to this example of operation, as described above, in a case where in the period from the time t₁′ to the time t₂′, the counter electrode bus line COMLₙ is supplied with the highest voltage level potential V_{COM3}′ among the potentials V_{COM1}′, V_{COM2}′, and V_{COM3}′, the counter electrode driver 14 supplies the counter electrode bus line COMLₙ with a counter electrode signal #COMLₙ in a single scanning period from the time t₂′ to the time t₅′ (single vertical scanning period T_{V}′), the counter electrode signal #COMLₙ taking on the voltage level V_{COM2}′ in a period T₁′ from the time t₂′ to the time t₃′ and taking on the voltage level V_{COM1}′ (V_{COM1}′<V_{COM2}′) in a period T₂′ from the time t₃′ to the time t₅′.

Generally, in a normally black type in which a black display is carried out in a case where no voltage is applied to the pixel electrode, a phenomenon of insufficient rising from a low brightness to a high brightness occurs due to finite lengths of time of response of the liquid crystal. In other words, there is such a characteristic that the amount of time required to change from a low brightness to a high brightness is larger than the amount of time required to change from a high brightness to a low brightness. Such a phenomenon can occur at a timing when the potential difference between the potential of the pixel electrode and the potential of the counter electrode increases.

According to the foregoing configuration, in a case where when the gate driver supplies the given gate bus line with the conducting signal, the given counter electrode bus line is supplied with the highest voltage level among the voltage levels, the pixel electrode can be supplied with a voltage signal at a higher voltage and then with a voltage signal at a lower voltage level in the single scanning period.

This allows the potential difference between the potential of the pixel electrode and the potential of the counter electrode to gradually increase. This makes it possible to suppress the phenomenon of insufficient rising from a low brightness to a high brightness that can occur in a normally black type.

Further, according to this example of operation, in a case where when the gate driver 13 supplies the given gate bus line GLₙ with the conducting signal (high-level interval of the gate signal #GLₙ), the given counter electrode bus line COMLₙ is supplied with the lowest voltage level among the voltage levels, the counter electrode driver 14 supplies the given counter electrode bus line COMLₙ with the rectangular voltage signal (counter electrode signal #COMLₙ) in the single scanning period, the rectangular voltage signal having its voltage levels arranged in an ascending order.

That is, according to this example of operation, as described above, in a case where in the period from the time t₄′ to the time t₅′, the counter electrode bus line COMLₙ is supplied with the lowest voltage level potential V_{COM1}′ among the potentials V_{COM1}′, V_{COM2}′, and V_{COM3}′, the counter electrode driver 14 supplies the counter electrode bus line COMLₙ with a counter electrode signal #COMLₙ in a single scanning period from the time t₅′ to the time t₈′ (single vertical scanning period T_{V}′), the counter electrode signal #COMLₙ taking on the voltage level V_{COM2}′ in a period T₃′ from the time t₅′ to the time t₆′ and taking on the voltage level V_{COM3}′ (V_{COM3}′>V_{COM2}′) in a period T₄′ from the time t₆′ to the time t₈′.

Generally, in a normally black type in which a black display is carried out in a case where no voltage is applied to the pixel electrode, a phenomenon of insufficient rising from a low brightness to a high brightness occurs due to finite lengths of time of response of the liquid crystal. In other words, there is such a characteristic that the amount of time required to change from a low brightness to a high brightness is larger than the amount of time required to change from a high brightness to a low brightness. Such a phenomenon can occur at a timing when the potential difference between the potential of the pixel electrode and the potential of the counter electrode increases.

According to the foregoing configuration, in a case where when the gate driver supplies the given gate bus line with the conducting signal, the given counter electrode bus line is supplied with the lowest voltage level among the voltage levels, the pixel electrode can be supplied with a voltage signal at a lower voltage and then with a voltage signal at a higher voltage level in the single scanning period.

This allows the potential difference between the potential of the pixel electrode and the potential of the counter electrode to gradually increase. This makes it possible to suppress the phenomenon of insufficient rising from a low brightness to a high brightness that can occur in a normally black type.

Further, according to this example of operation, it is preferable that the rectangular voltage signal (counter electrode signal #COMLₙ) take on any one of the first to third voltage levels in an at least 10% period of time of the single scanning period (single vertical scanning period T_{V}′).

That is, according to this example of operation, it is preferable that the rectangular voltage signal (counter electrode signal #COMLₙ) take on a voltage level from among the potentials V_{COM1}′, V_{COM2}′, and V_{COM3}′ in an at least 10% period of time of the single scanning period (single vertical scanning period T_{V}′).

According to the foregoing configuration, the rectangular voltage signal takes on any one of the first to third voltage levels in an at least 10% period of time of the single scanning period. This makes it possible to effectively suppress the phenomenon of blurring of moving images.

Further, the display panel according to the present invention may be configured such that in the single scanning period (single vertical scanning period T_{V}′), a polarity of a voltage that is applied to the liquid crystal as represented by a difference between a potential of the pixel electrode and a potential of the counter electrode after a first transition between the voltage levels and a polarity of a voltage that is applied to the liquid crystal as represented by a difference between a potential of the pixel electrode and the potential of the counter electrode after a next transition between the voltage levels are polarities that are different from each other.

That is, the display panel according to the present invention may be configured such that in the single scanning period (single vertical scanning period T_{V}′), the polarity of a voltage that is applied the liquid crystal after the first transition between the voltage levels (transition of the counter electrode signal #COMLₙ from the potential V_{COM3}′ to the potential V_{COM2}′ at the time t₂′) and the polarity of a voltage that is applied the liquid crystal after the next transition between the voltage levels (transition of the counter electrode signal #COMLₙ from the potential V_{COM2}′ to the potential V_{COM1}′ at the time t₃′) are polarities that are different from each other.

According to the foregoing configuration, regardless of whether after the first transition between the voltage levels or after the next transition between the voltage levels in the single scanning period, the absolute value of the voltage that is applied to the liquid crystal can be made sufficiently small.

Therefore, according to the foregoing configuration, in a normally black system in which the brightness is lower in a case where the absolute value of a voltage that is applied to the liquid crystal is smaller, a black display can be carried out at a sufficiently low brightness, regardless of whether after the first transition between the voltage levels or after the next transition between the voltage levels in the single scanning period.

Further, the display panel according to the present invention may be configured such that an absolute value of a potential difference between the middle voltage level (i.e., the potential V_{COM2}′) among the first to third voltage levels and the lowest voltage level (i.e., the potential V_{COM1}′) among the first to third voltage levels is twice or less as great as a threshold voltage of the liquid crystal.

According to the foregoing configuration, the absolute value of the potential difference between the middle voltage level among the first to third voltage levels and the lowest voltage level among the first to third voltage levels is twice or less as great as the threshold voltage of the liquid crystal. This makes it possible to prevent the orientation of the liquid crystal from being affected, regardless of which of the first to third voltage levels the rectangular voltage signal takes on.

Therefore, according to the foregoing configuration, in a normally black system in which the brightness is lower in a case where the absolute value of a voltage that is applied to the liquid crystal is smaller, a black display can be carried out regardless of which of the first to third voltage levels the rectangular voltage signal takes on.

(Example 3 of Operation of the Display Panel 1)

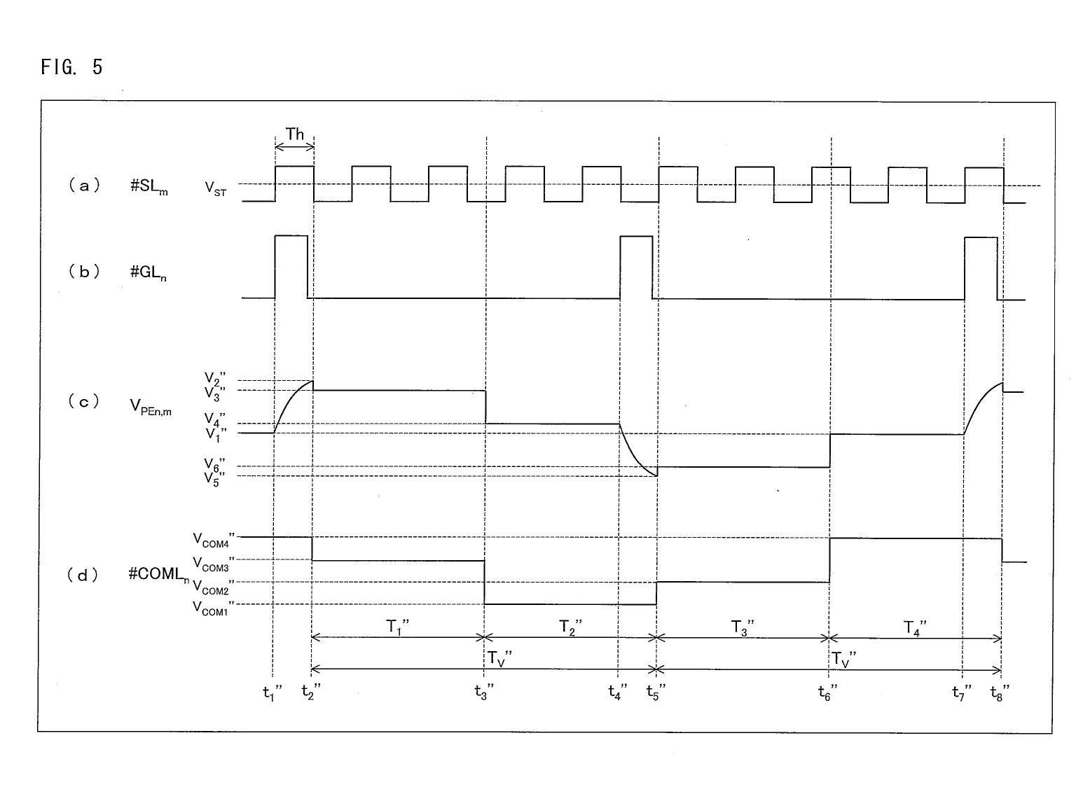

A third example of operation of the display panel 1 according to the present embodiment is described below with reference to (a) through (d) of FIG. 5.

(a) of FIG. 5 is a timing chart showing an example of a waveform of the source signal #SLₘ, which is supplied to the source bus line SLₘ. As shown in (a) of FIG. 5, the waveform of the source signal #SLₘ in this example of operation is described as being substantially the same as the waveform of the source signal #SLₘ shown in (a) of FIG. 3.

(b) of FIG. 5 is a timing chart showing a waveform of the gate signal #GLₙ, which is supplied to the gate bus line GLₙ. As shown in (b) of FIG. 5, the waveform of the gate signal #GLₙ in this example of operation is described as being the same as the waveform of the gate signal #GLₙ shown in (b) of FIG. 3.

(c) of FIG. 5 is a timing chart showing a potential V_{PEn,m} of the liquid crystal electrode PE_{n,m}.

(d) of FIG. 5 is a timing chart showing a waveform of the counter electrode signal #COMLₙ, which is supplied to the counter electrode bus line COMLₙ. As shown in (d) of FIG. 5, the counter electrode signal #COMLₙ in this example of operation is a signal that takes on a potential V_{COM1}″, a potential V_{COM2}″, a potential V_{COM3}″, and a potential V_{COM4}″ in a single cycle composed of two consecutive vertical scanning periods T_{V}″. More specifically, as shown in (d) of FIG. 5, the counter electrode signal #COMLₙ takes on the potential V_{COM3}″ during a period T₁′ in a single vertical scanning period T_{V}″, and takes on the potential V_{COM1}″ during a period T₂″. Further, the counter electrode signal #COMLₙ takes on the potential V_{COM2}″ during a period T₃″ in the ensuing vertical scanning period T_{V}″, and takes on the potential V_{COM4}″ during a period T₄″. It is assumed that as shown in (d) of FIG. 5, specific values of the potentials V_{COM1}″, V_{COM2}″, V_{COM3}″, and V_{COM4}″ satisfy V_{COM1}″<V_{COM2}″<V_{COM3}″<V_{COM4}″, V_{COM4}″−V_{COM3}″<V_{COM3}″−V_{COM1}″, and V_{COM2}″−V_{COM1}″<V_{COM4}″−V_{COM2}″.

As shown in (c) and (d) of FIG. 5, when the counter electrode signal #COMLₙ is at the highest potential (potential V_{COM4}″) and the gate signal #GLₙ is at a high level, the voltage that is applied to the liquid crystal LC changes into a positive polarity; and when the counter electrode signal #COMLₙ is at the lowest potential (potential V_{COM1}″) and the gate signal #GLₙ is at a high level, the voltage that is applied to the liquid crystal LC changes into a negative polarity.

The following describes the operation of each of the components in the pixel region P_{n,m} of the display panel 1 in this example of operation.

First, as shown in (b) of FIG. 5, the gate signal #GLₙ rises from a low level to a high level at the time t₁″ and, after a certain period of time has elapsed, falls to a low level. In a period of time during which the gate signal #GLₙ is at a high level, the transistor M_{n,m} is in a conducting state. When the transistor M_{n,m} is in a conducting state, the source signal #SLₘ is supplied to the pixel electrode PE_{n,m} and the first auxiliary capacitor electrode CE1_{n,m}. As shown in (c) of FIG. 5, in a period from the time t₁″ to the time t₂″, the potential V_{PEn,m} of the pixel electrode PE_{n,m} increases from a potential V₁″ to a potential V₂″ (V₂″>V_{COM4}″).

Further, the counter electrode signal #COMLₙ falls from the potential V_{COM4}″ to the potential V_{COM3}″ at the time t₂″. Accordingly, the potential V_{PEn,m} of the pixel electrode PE_{n,m} changes from the potential V₂″ to a potential V₃″. It should be noted here that a specific value of the potential V₃″ is defined as:

V₃″=(V_{COM3}″−V_{COM4}″)×C_{LC}/Σ_{C}+V₂″.

Since V_{COM3}″<V_{COM4}″ as mentioned above, the potential V₃″ is smaller than the potential V₂″.

Then, the counter electrode signal #COMLₙ falls from the potential V_{COM3}″ to the potential V_{COM1}″ at the time t₃″. Accordingly, the potential V_{PEn,m} of the pixel electrode PE_{n,m} changes from the potential V₃″ to a potential V₄″. It should be noted here that a specific value of the potential V₄″ is defined as:

V₄″=(V_{COM1}″−V_{COM3}″)×C_{LC}/Σ_{C}+V₃″.

Since V_{COM1}″<V_{COM3}″ as mentioned above, the potential V₄″ is smaller than the potential V₃″.

Further, the potential V₃″, the potential V₄″, the potential V_{COM1}″, and the potential V_{COM3}″ satisfy V₄″-V_{COM1}″−(V₃″−V_{COM3}″)=(V_{COM3}″−V_{COM1}″)×(Σ_{C}−C_{LC})/Σ_{C}, and since V_{COM1}″<V_{COM3}″ as mentioned above, V₄″−V_{COM1}″>V₃″−V_{COM3}″ holds. That is, the potential difference between the potential V_{PEn,m} of the pixel electrode PE_{n,m} and the potential V_{ECOMn,m} of the counter electrode E_{COMn,m} in a period from the time t₃″ to the time t₄″ is greater than the potential difference between the potential V_{PEn,m} of the pixel electrode PE_{n,m} and the potential V_{ECOMn,m} of the counter electrode E_{COMn,m} in a period from the time t₂″ to the time t₃″. Therefore, the brightness of the pixel region P_{n,m} in the period from the time t₃″ to the time t₄″ is greater than the brightness of the pixel region P_{n,m} in the period from the time t₂″ to the time t₃″.

Then, the gate signal #GLₙ rises from a low level to a high level at the time t₄″ and, after a certain period of time has elapsed, falls to a low level. In a period of time during which the gate signal #GLₙ is at a high level, the transistor M_{n,m} is in a conducting state, so that the source signal #SLₘ is supplied to the pixel electrode PE_{n,m} and the first auxiliary capacitor electrode CE1_{n,m}.

As shown in (c) of FIG. 5, in a period from the time t₄″ to the time t₅″, the potential V_{PEn,m} of the pixel electrode PE_{n,m} decreases from the potential V₄″ to a potential V₅″ (V₅″<V_{COM1}″).

Further, the counter electrode signal #COMLₙ rises from the potential V_{COM1}″ to the potential V_{COM2}″ at the time t₅″. Accordingly, the potential V_{PEn,m} of the pixel electrode PE_{n,m} changes from the potential V₅″ to a potential V₆″. It should be noted here that a specific value of the potential V₆″ is defined as:

V₆″=(V_{COM2}″−V_{COM1}″)×C_{LC}/Σ_{C}+V₅″.

Since V_{COM1}″<V_{COM2}″ as mentioned above, the potential V₆″ is greater than the potential V₅″.

Then, the counter electrode signal #COMLₙ rises from the potential V_{COM2}″ to the potential V_{COM4}″ at the time t₆″. Accordingly, the potential V_{PEn,m} of the pixel electrode PE_{n,m} changes from the potential V₆″ to the potential V₁″. It should be noted here that a specific value of the potential V₁″ is defined as:

V₁″=(V_{COM4}″−V_{COM2}″)×C_{LC}/Σ_{C}+V₆″.

Since V_{COM2}″<V_{COM4}″ as mentioned above, the potential V₁″ is greater than the potential V₆″.

Further, the potential V₁″, the potential V₆″, the potential V_{COM2}″, and the potential V_{COM4}″ satisfy V_{COM4}″−(V_{COM2}″−V₆″)=(V_{COM4}″−V_{COM2}″)×(Σ_{C}−C_{LC})/Σ_{C}, and since V_{COM2}″<V_{COM4}″ as mentioned above, V_{COM4}″−V₁″>V_{COM2}″−V₆″ holds. That is, the potential difference between the potential V_{PEn,m} of the pixel electrode PE_{n,m} and the potential V_{ECOMn,m} of the counter electrode E_{COMn,m} in a period from the time t₆″ to the time t₇″ is greater than the potential difference between the potential V_{PEn,m} of the pixel electrode PE_{n,m} and the potential V_{ECOMn,m} of the counter electrode E_{COMn,m} in a period from the time t₅″ to the time t₆″. Therefore, the brightness of the pixel region P_{n,m} in the period from the time t₆″ to the time t₇″ is greater than the brightness of the pixel region P_{n,m} in the period from the time t₅″ to the time t₆″.

The operation at the time t₇″ and later is the same as the operation at the time t₁″ and later.

The above example of operation has described a case where the counter electrode signal #COMLₙ falls from the potential V_{COM4}″ to the potential V_{COM3}″ at the time t₂″ and the counter electrode signal #COMLₙ rises from the potential V_{COM1}″ to the potential V_{COM2}″ at the time t₅″. However, more generally, the counter electrode signal #COMLₙ falls from the potential V_{COM4}″ to the potential V_{COM3}″ before several horizontal periods (period multiple times as long as a horizontal period Th) have elapsed since the time t₂″ and the counter electrode signal #COMLₙ rises from the potential V_{COM1}″ to the potential V_{COM2}″ before several horizontal periods (period multiple times as long as a horizontal period Th) have elapsed since the time t₅″.

As described above, according to this example of operation, in the single scanning period (single vertical scanning period T_{V}″), the counter electrode driver 14 supplies the given counter electrode bus line COMLₙ with a rectangular voltage signal composed of the first voltage level, the second voltage level, and a third voltage level that is different from the first and second voltage levels, and in a single scanning period subsequent to the single scanning period, the counter electrode driver 14 supplies the given counter electrode bus line COMLₙ with a rectangular voltage signal composed of any two of the first to third voltage levels and a fourth voltage level that is different from the first to third voltage levels.

That is, according to this example of operation, in the two consecutive vertical scanning periods, the counter electrode driver 14 supplies a rectangular voltage signal (counter electrode signal #COMLₙ) composed of the potential V_{COM1}″, the potential V_{COM2}″, the potential V_{COM3}″, and the potential V_{COM4}″.

According to foregoing configuration, in the single scanning period, the counter electrode driver can supply the given counter electrode bus line with a rectangular voltage signal in synchronization with the conducting signal, the rectangular voltage signal being composed of the first voltage level, the second voltage level, and a third voltage level that is different from the first and second voltage levels. Therefore, in the single scanning period, the level of voltage that is applied to the pixel electrode switches among three values. In other words, in the single scanning period, the level of voltage that is applied to the pixel electrode makes two transitions. The first transition between the voltage levels in the single scanning period causes a voltage that is applied to the liquid crystal after the first transition between the voltage levels to be suitable for a display after the first transition between the voltage levels, and the second transition between the voltage levels allows switching between a high brightness and a low brightness.

Therefore, the foregoing configuration makes a display at a higher brightness possible while effectively suppressing the phenomenon of blurring of moving images.

Furthermore, the foregoing configuration makes it possible, in a single scanning period subsequent to the single scanning period, to supply a rectangular voltage signal composed of any two of the first to third voltage levels and a fourth voltage level that is different from the first to third voltage levels. Therefore, as compared with a case where a rectangular voltage signal composed of the first to third voltage levels is supplied in a single scanning period subsequent to the single scanning period, the adjustment of brightness levels between a high brightness and a low brightness can be more flexibly carried out.

Therefore, the foregoing configuration makes a display at a high brightness possible while further effectively suppressing the phenomenon of blurring of moving images.

Further, according to this example of operation, the absolute value |V_{COM4}″−V_{COM3}″| of the potential difference between the voltage level before a first transition between the voltage levels in the single scanning period (single vertical scanning period T_{V}″) and the voltage level after the first transition is smaller than the absolute value |V_{COM3}″−V_{COM1}″| of the potential difference between the voltage level before a next transition between the voltage levels in the single scanning period and the voltage level after the next transition. It is assumed here that the symbol |a| represents the absolute value of a.

Therefore, in this example of operation, a change in brightness of the pixel region P_{n,m} along with a transition between the voltage levels of the counter electrode signal #COMLₙ at the time t₃″ can be made larger than a change in brightness of the pixel region P_{n,m} along with a transition between the voltage levels of the counter electrode signal #COMLₙ at the time t₂″.

Therefore, in this example of operation, the phenomenon of blurring of moving images can be more effectively suppressed. The same applies to the single vertical scanning period T_{V}″ from the time t₅″ to the time t₈″.

Further, according to this example of operation, it is preferable that the rectangular voltage signal (counter electrode signal #COMLₙ) take on any one of the first to fourth voltage levels (i.e., the potentials V_{COM1}″, V_{COM2}″, V_{COM3}″, and V_{COM4}″) in an at least 10% period of time of the single scanning period (single vertical scanning period T_{V}″).

According to the foregoing configuration, the rectangular voltage signal takes on any one of the first to fourth voltage levels in an at least 10% period of time of the single scanning period. This makes it possible to effectively suppress the phenomenon of blurring of moving images.

Further, the display panel according to the present invention is preferably configured such that in the single scanning period, a polarity of a voltage that is applied to the liquid crystal as represented by a difference between a potential of the pixel electrode and a potential of the counter electrode after a first transition between the voltage levels and a polarity of a voltage that is applied to the liquid crystal as represented by a difference between a potential of the pixel electrode and the potential of the counter electrode after a next transition between the voltage levels are polarities that are different from each other.

According to the foregoing configuration, regardless of whether after the first transition between the voltage levels or after the next transition between the voltage levels in the single scanning period, the absolute value of the voltage that is applied to the liquid crystal can be made sufficiently small.

Therefore, the foregoing configuration brings about a further effect of making it possible, in a normally black type in which the brightness is lower in a case where the absolute value of a voltage that is applied to the liquid crystal is smaller, to carry out a black display at a sufficiently low brightness, regardless of whether after the first transition between the voltage levels or after the next transition between the voltage levels in the single scanning period.

Further, the display panel according to the present invention may be configured such that in the single scanning period (single vertical scanning period T_{V}″), the polarity of a voltage that is applied the liquid crystal as represented by a difference between a potential of the pixel electrode and a potential of the counter electrode after the first transition between the voltage levels (transition of the counter electrode #COMLₙ from the potential V_{COM4}″ to the potential V_{COM3}″ at the time t₂″) and the polarity of a voltage that is applied the liquid crystal as represented by a difference between a potential of the pixel electrode and the potential of the counter electrode after the next transition between the voltage levels (transition of the counter electrode #COMLₙ from the potential V_{COM3}″ to the potential V_{COM1}″ at the time t₃″) are polarities that are different from each other.

According to the foregoing configuration, regardless of whether after the first transition between the voltage levels or after the next transition between the voltage levels in the single scanning period, the absolute value of the voltage that is applied to the liquid crystal can be made sufficiently small.

Therefore, according to the foregoing configuration, in a normally black type in which the brightness is lower in a case where the absolute value of a voltage that is applied to the liquid crystal is smaller, a black display can be carried out at a sufficiently low brightness, regardless of whether after the first transition between the voltage levels or after the next transition between the voltage levels in the single scanning period.

Further, the display panel according to the present invention may be configured such that an absolute value of a potential difference between the second lowest voltage level (i.e., the potential V_{COM2}″) among the first to fourth voltage levels and the highest voltage level (i.e., the potential V_{COM4}″) among the first to fourth voltage levels is twice or less as great as a threshold voltage of the liquid crystal.

According to the foregoing configuration, the absolute value of the potential difference between the second lowest voltage level among the first to fourth voltage levels and the highest voltage level among the first to fourth voltage levels is twice or less as great as the threshold voltage of the liquid crystal. This makes it possible to prevent the orientation of the liquid crystal from being affected, regardless of whether the rectangular voltage signal takes on the lowest or highest voltage level among the first to fourth voltage levels.

Therefore, according to the foregoing configuration, in a normally black type in which the brightness is lower in a case where the absolute value of a voltage that is applied to the liquid crystal is smaller, a black display can be carried out regardless of which of the first to fourth voltage levels the rectangular voltage signal takes on.

(Example 4 of Operation of the Display Panel 1)

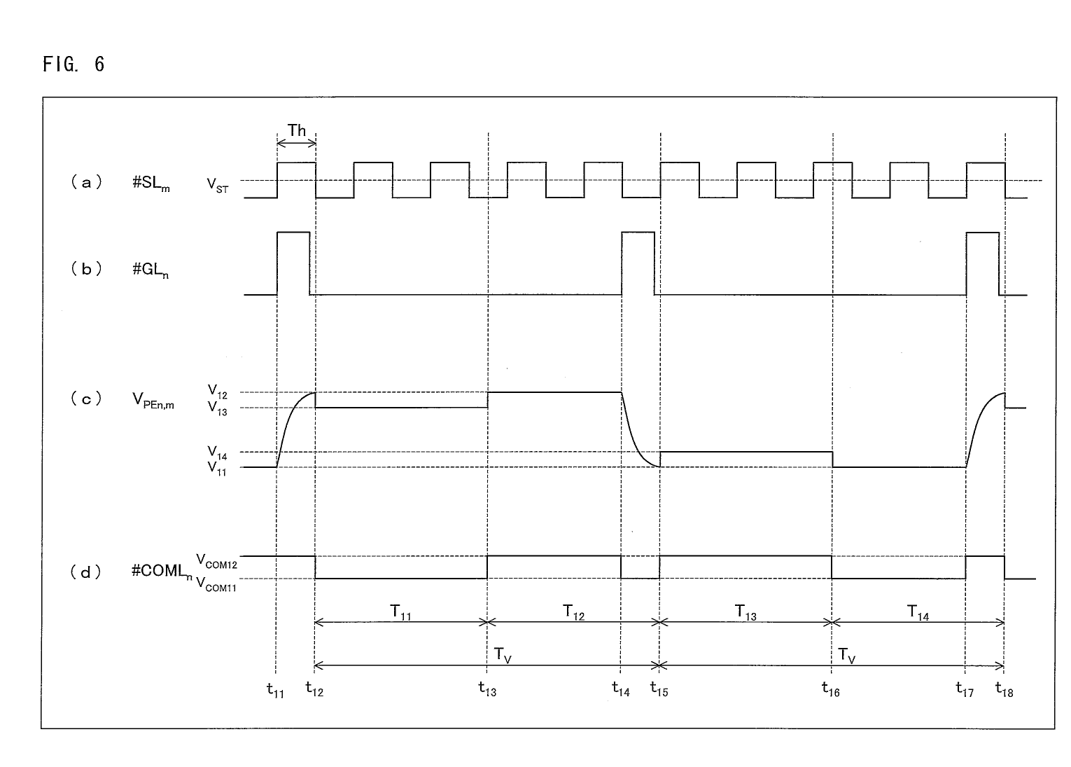

A fourth example of operation of the display panel 1 according to the present embodiment is described below with reference to (a) through (d) of FIG. 6.

(a) of FIG. 6 is a timing chart showing an example of a waveform of the source signal #SLₘ which is supplied to the source bus line SLₘ. As shown in (a) of FIG. 6, the waveform of the source signal #SLₘ in this example of operation is described as being substantially the same as the waveform of the source signal #SLₘ shown in (a) of FIG. 3.

(b) of FIG. 6 is a timing chart showing a waveform of the gate signal #GLₙ, which is supplied to the gate bus line GLₙ. As shown in (b) of FIG. 6, the waveform of the gate signal #GLₙ in this example of operation is described as being the same as the waveform of the gate signal #GLₙ shown in (b) of FIG. 3.

(c) of FIG. 6 is a timing chart showing a potential V_{PEn,m} of the liquid crystal electrode PE_{n,m}.

(d) of FIG. 6 is a timing chart showing a waveform of the counter electrode signal #COMLₙ, which is supplied to the counter electrode bus line COMLₙ. As shown in (d) of FIG. 6, the counter electrode signal #COMLₙ in this example of operation is a signal that takes on a potential V_{COM11} and a potential V_{COM12} in a single cycle composed of two consecutive vertical scanning periods T_{V}. More specifically, as shown in (d) of FIG. 6, the counter electrode signal #COMLₙ takes on the potential V_{COM11} during a period T₁₁ in a single vertical scanning period T_{V}, takes on the potential V_{COM12} from a time t₁₃ to a time t₁₄ in a period T₁₂, and takes on the potential V_{COM11} from the time t₁₄ to a time t₁₅ in the period T₁₂. Further, the counter electrode signal #COMLₙ takes on the potential V_{COM12} during a period T₁₃ in the ensuing vertical scanning period T_{V}, takes on the potential V_{COM11} from a time t₁₆ to a time t₁₇ in a period T₁₄, and takes on the potential V_{COM12} from the time t₁₇ to a time t₁₈ in the period T₁₄. It is assumed that as shown in (d) of FIG. 6, specific values of the potentials V_{COM11} and V_{COM12} satisfy V_{COM11}<V_{COM12}.

The following describes the operation of each of the components in the pixel region P_{n,m} of the display panel 1 in this example of operation.

First, as shown in (b) of FIG. 6, the gate signal #GLₙ rises from a low level to a high level at the time t₁₁ and, after a certain period of time has elapsed, falls to a low level. In a period of time during which the gate signal #GLₙ is at a high level, the transistor M_{n,m} is in a conducting state. When the transistor M_{n,m} is in a conducting state, the source signal #SLₘ is supplied to the pixel electrode PE_{n,m} and the first auxiliary capacitor electrode CE1_{n,m}. As shown in (c) of FIG. 6, in a period from the time t₁₁ to the time t₁₂, the potential V_{PEn,m} of the pixel electrode PE_{n,m} increases from a potential V₁₁ to a potential V₁₂(V₁₂>V_{COM12}).

Further, the counter electrode signal #COMLₙ falls from the potential V_{COM12} to the potential V_{COM11} at the time t₁₂. Accordingly, the potential V_{PEn,m} of the pixel electrode PE_{n,m} changes from the potential V₁₂ to a potential V₁₃. It should be noted here that a specific value of the potential V₁₃ is defined as:

V₁₃=(V_{COM11}−V_{COM12})×C_{LC}/Σ_{C}+V₁₂.

Since V_{COM11}<V_{COM12} as mentioned above, the potential V₁₃ is smaller than the potential V₁₂.

Then, the counter electrode signal #COMLₙ rises from the potential V_{COM11} to the potential V_{COM12} at the time t₁₃. Accordingly, the potential V_{PEn,m} of the pixel electrode PE_{n,m} changes from the potential V₁₃ to the potential V₁₂.

Further, the potential V₁₂, the potential V₁₃, the potential V_{COM11}, and the potential V_{COM12} satisfy V₁₂−V_{COM12}−(V₁₃−V_{COM1}=(V_{COM11}−V_{COM12})×(Σ_{C}−C_{LC})/Σ_{C}, and since V_{COM11}<V_{COM12} as mentioned above, V₁₂−V_{COM12}<V₁₃−V_{COM11} holds. That is, the potential difference between the potential V_{PEn,m} of the pixel electrode PE_{n,m} and the potential V_{ECOMn,m} of the counter electrode E_{COMn,m} in a period from the time t₁₃ to the time t₁₄ is smaller than the potential difference between the potential V_{PEn,m} of the pixel electrode PE_{n,m} and the potential V_{ECOMn,m} of the counter electrode E_{COMn,m} in a period from the time t₁₂ to the time t₁₃. Therefore, the brightness of the pixel region P_{n,m} in the period from the time t₁₃ to the time t₁₄ is smaller than the brightness of the pixel region P_{n,m} in the period from the time t₁₂ to the time t₁₃.

Then, the gate signal #GLₙ rises from a low level to a high level at the time t₁₄ and, after a certain period of time has elapsed, falls to a low level. In a period of time during which the gate signal #GLₙ is at a high level, the transistor M_{n,m} is in a conducting state, and the source signal #SLₘ is supplied to the pixel electrode PE_{n,m} and the first auxiliary capacitor electrode CE1_{n,m}. Further, the counter electrode signal #COMLₙ falls from the potential V_{COM12} to the potential V_{COM11} at the time t₁₄.

As shown in (c) of FIG. 6, in a period from the time t₁₄ to the time t₁₅, the potential V_{PEn,m} of the pixel electrode PE_{n,m} decreases from the potential V₁₂ to the potential V₁₁ (V₁₁<V_{COM11}).

Further, the counter electrode signal #COMLₙ rises from the potential V_{COM11} to the potential V_{COM12} at the time t₁₅. Accordingly, the potential V_{PEn,m} of the pixel electrode PE_{n,m} changes from the potential V₁₁ to the potential V₁₄. It should be noted here that a specific value of the potential V₁₄ is defined as:

V₁₄=(V_{COM12}−V_{COM11})×C_{LC}/Σ_{C}+V₁₁.

Further, since V_{COM11}<V_{COM12} as mentioned above, the potential V₁₄ is greater than the potential V₁₁.

Then, the counter electrode signal #COMLₙ falls from the potential V_{COM12} to the potential V_{COM11} at the time t₁₆. Accordingly, the potential V_{PEn,m} of the pixel electrode PE_{n,m} changes from the potential V₁₄ to the potential V₁₁.

Further, the potential V₁₁, the potential V₁₄, the potential V_{COM11}, and the potential V_{COM12} satisfy V_{COM11}−V₁₁−(V_{COM12}−V₁₄)=(V_{COM11}−V_{COM12})×C_{CS}/Σ_{C}, and since V_{COM11}<V_{COM12} as mentioned above, V_{COM11}−V₁₁<V_{COM12}−V₁₄ holds. That is, the potential difference between the potential V_{PEn,m} of the pixel electrode PE_{n,m} and the potential V_{ECOMn,m} of the counter electrode E_{COMn,m} in a period from the time t₁₆ to the time t₁₇ is smaller than the potential difference between the potential V_{PEn,m} of the pixel electrode PE_{n,m} and the potential V_{ECOMn,m} of the counter electrode E_{COMn,m} in a period from the time t₁₅ to the time t₁₆. Therefore, the brightness of the pixel region P_{n,m} in the period from the time t₁₆ to the time t₁₇ is smaller than the brightness of the pixel region P_{n,m} in the period from the time t₁₅ to the time t₁₆.

Then, the gate signal #GLₙ rises from a low level to a high level at the time t₁₇ and, after a certain period of time has elapsed, falls to a low level. Further, the counter electrode signal #COMLₙ rises from the potential V_{COM11} to the potential V_{COM12} at the time t₁₇. The operation at the time t₁₇ and later is the same as the operation at the time t₁₁ and later.

The above example of operation has described a case where the counter electrode signal #COMLₙ falls from the potential V_{COM12} to the potential V_{COM11} at the time t₁₂ and the counter electrode signal #COMLₙ rises from the potential V_{COM11} to the potential V_{COM12} at the time t₁₅. However, more generally, the counter electrode signal #COMLₙ falls from the potential V_{COM12} to the potential V_{COM11} before several horizontal periods (period multiple times as long as a horizontal period Th) have elapsed since the time t₁₂ and the counter electrode signal #COMLₙ rises from the potential V_{COM11} to the potential V_{COM12} before several horizontal periods (period multiple times as long as a horizontal period Th) have elapsed since the time t₁₅.

Further, the above example of operation has described a case where the counter electrode signal #COMLₙ falls from the potential V_{COM12} to the potential V_{COM11} at the time t₁₄. However, more generally, the counter electrode signal #COMLₙ falls from the potential V_{COM12} to the potential V_{COM11} in a period from the time t₁₃ to the time t₁₅.

As in this example of operation, the display panel 1 according to the present invention can also cause a change in brightness of the pixel region P_{n,m} in a single vertical scanning period by supplying the counter electrode signal #COMLₙ in such a way that the brightness of the pixel region P_{n,m}, in the second half of a single vertical scanning period is smaller than the brightness of the pixel region P_{n,m} in the first half of the single vertical scanning period.

Therefore, in this example of operation, too, the phenomenon of blurring of moving images can be suppressed.

(Example 5 of Operation of the Display Panel 1)

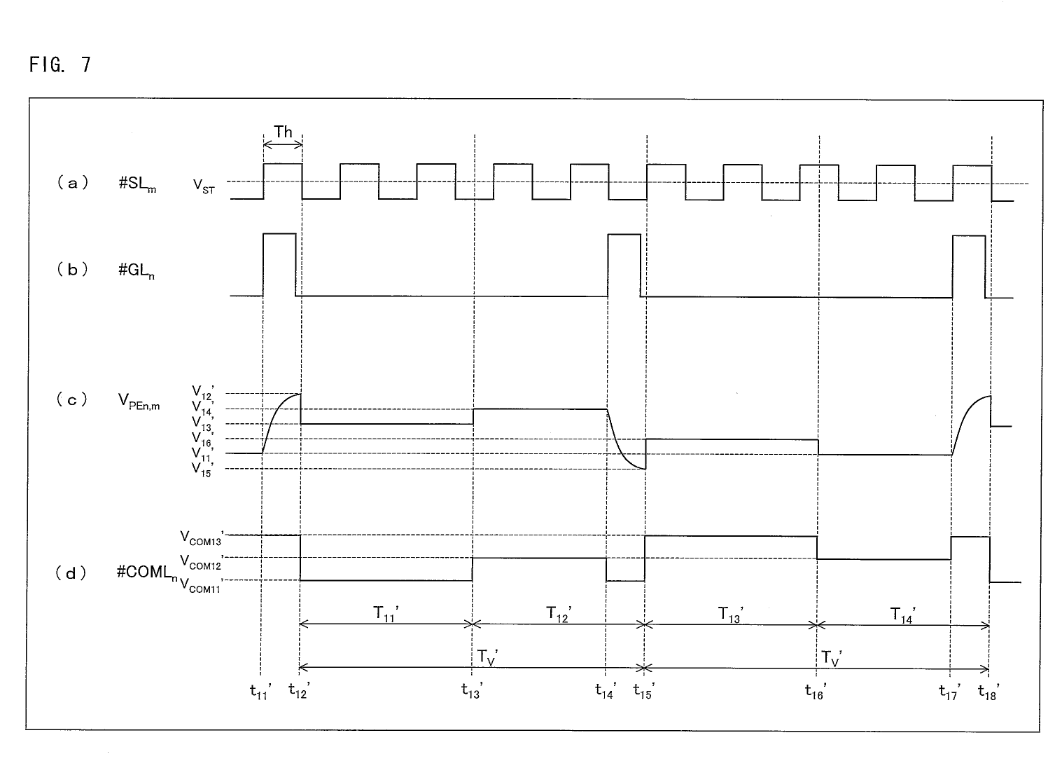

A fifth example of operation of the display panel 1 according to the present embodiment is described below with reference to (a) through (d) of FIG. 7.

(a) of FIG. 7 is a timing chart showing an example of a waveform of the source signal #SLₘ, which is supplied to the source bus line SLₘ. As shown in (a) of FIG. 7, the waveform of the source signal #SLₘ in this example of operation is described as being substantially the same as the waveform of the source signal #SLₘ shown in (a) of FIG. 3.

(b) of FIG. 7 is a timing chart showing a waveform of the gate signal #GLₙ, which is supplied to the gate bus line GLₙ. As shown in (b) of FIG. 7, the waveform of the gate signal #GLₙ in this example of operation is described as being the same as the waveform of the gate signal #GLₙ shown in (b) of FIG. 3.

(c) of FIG. 7 is a timing chart showing a potential V_{PEn,m} of the liquid crystal electrode PE_{n,m}.

(d) of FIG. 7 is a timing chart showing a waveform of the counter electrode signal #COMLₙ, which is supplied to the counter electrode bus line COMLₙ. As shown in (d) of FIG. 7, the counter electrode signal #COMLₙ in this example of operation is a signal that takes on a potential V_{COM11}′, a potential V_{COM12}′, and a potential V_{COM13}′ in a single cycle composed of two consecutive vertical scanning periods T_{V}′. More specifically, as shown in (d) of FIG. 7, the counter electrode signal #COMLₙ takes on the potential V_{COM11}′ during a period T₁₁′ in a single vertical scanning period T_{V}′, takes on the potential V_{COM12}′ from a time t₁₃′ to a time t₁₄′ in a period T₁₂′, and takes on the potential V_{COM11}′ from the time t₁₄′ to a time t₁₅′ in the period T₁₂′. Further, the counter electrode signal #COMLₙ takes on the potential V_{COM13}′ during a period T₁₃′ in the ensuing vertical scanning period T_{V}′, takes on the potential V_{COM12}′ from a time t₁₆′ to a time t₁₇′ in a period T₁₄′, and takes on the potential V_{COM13}′ from the time t₁₁′ to a time t₁₈′ in the period T₁₄′. It is assumed that as shown in (d) of FIG. 7, specific values of the potentials V_{COM11}′, V_{COM12}′, and V_{COM13}′ satisfy V_{COM11}′<V_{COM12}′<V_{COM13}′.

The following describes the operation of each of the components in the pixel region P_{n,m} of the display panel 1 in this example of operation.

First, as shown in (b) of FIG. 7, the gate signal #GLₙ rises from a low level to a high level at the time t₁₁′ and, after a certain period of time has elapsed, falls to a low level. In a period of time during which the gate signal #GLₙ is at a high level, the transistor M_{n,m} is in a conducting state. When the transistor M_{n,m} is in a conducting state, the source signal #SLₘ is supplied to the pixel electrode PE_{n,m} and the first auxiliary capacitor electrode CE1_{n,m}. As shown in (c) of FIG. 7, in a period from the time t₁₁′ to the time t₁₂′, the potential V_{PEn,m} of the pixel electrode PE_{n,m} increases from a potential V₁₁′ to a potential V₁₂′ (V₁₂′>V_{COM13}′).

Further, the counter electrode signal #COMLₙ falls from the potential V_{COM13}′ to the potential V_{COM11}′ at the time t₁₂′. Accordingly, the potential V_{PEn,m} of the pixel electrode PE_{n,m} changes from the potential V₁₂′ to a potential V₁₃′. It should be noted here that a specific value of the potential V₁₃′ is defined as:

V₁₃′=(V_{COM11}′−V_{COM13}′)×C_{LC}/Σ_{C}+V₁₂′.

Since V_{COM11}′<V_{COM13}′ as mentioned above, the potential V₁₃′ is smaller than the potential V₁₂′.

Then, the counter electrode signal #COMLₙ rises from the potential V_{COM11}′ to the potential V_{COM12}′ at the time t₁₃′. Accordingly, the potential V_{PEn,m} of the pixel electrode PE_{n,m} changes from the potential V₁₃′ to a potential V₁₄′. It should be noted here that a specific value of the potential V₁₄′ is defined as:

V₁₄′=(V_{COM12}′−V_{COM11}′)×C_{LC}/Σ_{C}+V₁₃′.

Since V_{COM11}′<V_{COM12}′ as mentioned above, the potential V₁₄′ is greater than the potential V₁₃′.

Further, the potential V₁₃′, the potential V₁₄′, the potential V_{COM11}′, and the potential V_{COM12}′ satisfy V₁₄′−V_{COM12}′−(V₁₃′−V_{COM11}′)=(V_{COM11}′−V_{COM12}′)×(Σ_{C}−C_{LC})/Σ_{C}, and since V_{COM11}′<V_{COM12}′ as mentioned above, V₁₄′. V_{COM12}′<V₁₃′−V_{COM11}′ holds. That is, the potential difference between the potential V_{PEn,m} of the pixel electrode PE_{n,m} and the potential V_{ECOMn,m} of the counter electrode E_{COMn,m} in a period from the time t₁₃′ to the time t₁₄′ is smaller than the potential difference between the potential V_{PEn,m} of the pixel electrode PE_{n,m} and the potential V_{ECOMn,m} of the counter electrode E_{COMn,m} in a period from the time t₁₂′ to the time t₁₃′. Therefore, the brightness of the pixel region P_{n,m} in the period from the time t₁₃′ to the time t₁₄′ is smaller than the brightness of the pixel region P_{n,m} in the period from the time t₁₂′ to the time t₁₃′.

Then, the gate signal #GLₙ rises from a low level to a high level at the time t₁₄′ and, after a certain period of time has elapsed, falls to a low level. In a period of time during which the gate signal #GLₙ is at a high level, the transistor M_{n,m} is in a conducting state, and the source signal #SLₘ is supplied to the pixel electrode PE_{n,m} and the first auxiliary capacitor electrode CE1_{n,m}. Further, the counter electrode signal #COMLₙ falls from the potential V_{COM12}′ to the potential V_{COM11}′ at the time t₁₄′.

As shown in (c) of FIG. 7, in a period from the time t₁₄′ to the time t₁₅′, the potential V_{PEn,m} of the pixel electrode PE_{n,m} decreases from the potential V₁₄′ to the potential V₁₅′ (V₁₅′<V_{COM11}′).

Further, the counter electrode signal #COMLₙ rises from the potential V_{COM11}′ to the potential V_{COM13}′ at the time t₁₅′. Accordingly, the potential V_{PEn,m} of the pixel electrode PE_{n,m} changes from the potential V₁₅′ to a potential V₁₆′. It should be noted here that a specific value of the potential V₁₆′ is defined as:

V₁₆′=(V_{COM13}′−−V_{COM11}′)×C_{LC}/Σ_{C}+V₁₅′.

Since V_{COM11}′<V_{COM13}′ as mentioned above, the potential V₁₆′ is greater than the potential V₁₅′.

Then, the counter electrode signal #COMLₙ falls from the potential V_{COM13}′ to the potential V_{COM12}′ at the time t₁₆′. Accordingly, the potential V_{PEn,m} of the pixel electrode PE_{n,m} changes from the potential V₁₆′ to the potential V₁₁′. It should be noted here that a specific value of the potential V₁₁′ is defined as:

V₁₁′=(V_{COM12}′−V_{COM13}′)×C_{LC}/Σ_{C}+V₁₆′

Since V_{COM12}′<V_{COM13}′ as mentioned above, the potential V₁₁′ is smaller than the potential V₁₆′.

Further, the potential V₁₁′, the potential V₁₆′, the potential V_{COM12}′, and the potential V_{COM13}′ satisfy V_{COM12}′−V₁₁′−(V_{COM13}′−V₁₆′)=(V_{COM12}′−V_{COM13}′)×(Σ_{C}−C_{LC})/Σ_{C}, and since V_{COM12}′<V_{COM13}′ as mentioned above, V_{COM12}′−V₁₁′<V_{COM13}′−V₁₆′ holds. That is, the potential difference between the potential V_{PEn,m} of the pixel electrode PE_{n,m} and the potential V_{ECOMn,m} of the counter electrode E_{COMn,m} in a period from the time t₁₆′ to the time t₁₇′ is smaller than the potential difference between the potential V_{PEn,m} of the pixel electrode PE_{n,m} and the potential V_{ECOMn,m} of the counter electrode E_{COMn,m} in a period from the time t₁₅′ to the time t₁₆′. Therefore, the brightness of the pixel region P_{n,m} in the period from the time t₁₆′ to the time t₁₇′ is smaller than the brightness of the pixel region P_{n,m} in the period from the time t₁₅′ to the time t₁₆′.

Then, the gate signal #GLₙ rises from a low level to a high level at the time t₁₇′ and, after a certain period of time has elapsed, falls to a low level. Further, the counter electrode signal #COMLₙ rises from the potential V_{COM12}′ to the potential V_{COM13}′ at the time t₁₇′. The operation at the time t₁₇′ and later is the same as the operation at the time t₁₁′ and later.

The above example of operation has described a case where the counter electrode signal #COMLₙ falls from the potential V_{COM13}′ to the potential V_{COM11}′ at the time t₁₂′ and the counter electrode signal #COMLₙ rises from the potential V_{COM11}′ to the potential V_{COM13}′ at the time t₁₅′. However, more generally, the counter electrode signal #COMLₙ falls from the potential V_{COM13}′ to the potential V_{COM11}′ before several horizontal periods (period multiple times as long as a horizontal period Th) have elapsed since the time t₁₂′ and the counter electrode signal #COMLₙ rises from the potential V_{COM11}′ to the potential V_{COM13}′ before several horizontal periods (period multiple times as long as a horizontal period Th) have elapsed since the time t₁₅′.

Further, the above example of operation has described a case where the counter electrode signal #COMLₙ falls from the potential V_{COM12}′ to the potential V_{COM11}′ at the time t₁₄′. However, more generally, the counter electrode signal #COMLₙ falls from the potential V_{COM12}′ to the potential V_{COM11}′ in a period from the time t₁₃′ to the time t₁₅′.

As in this example of operation, the display panel 1 according to the present invention can also cause a change in brightness of the pixel region P_{n,m} in a single vertical scanning period by supplying the counter electrode signal #COMLₙ in such a way that the brightness of the pixel region P_{n,m} in the second half of a single vertical scanning period is smaller than the brightness of the pixel region P_{n,m} in the first half of the single vertical scanning period.

Therefore, in this example of operation, too, the phenomenon of blurring of moving images can be suppressed. Further, in this example of operation, the counter electrode signal #COMLₙ takes on a three-valued voltage level. Therefore, as compared with the example 4 of operation described above, the phenomenon of blurring of moving images can be more effectively suppressed.

(Example 6 of Operation of the Display Panel 1)

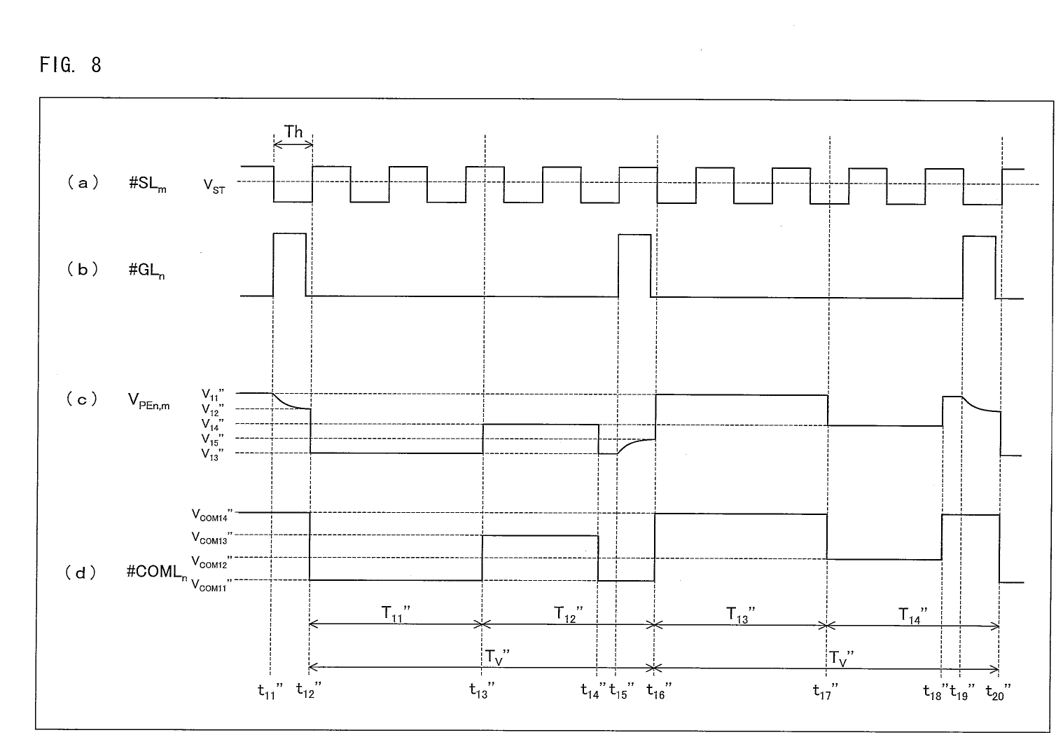

A sixth example of operation of the display panel 1 according to the present embodiment is described below with reference to (a) through (d) of FIG. 8.

(a) of FIG. 8 is a timing chart showing an example of a waveform of the source signal #SLₘ, which is supplied to the source bus line SLₘ. As shown in (a) of FIG. 8, the waveform of the source signal #SLₘ in this example of operation is described as being opposite in polarity to the waveform of the source signal #SLₘ shown in (a) of FIG. 3.

(b) of FIG. 8 is a timing chart showing a waveform of the gate signal #GLₙ, which is supplied to the gate bus line GLₙ. As shown in (b) of FIG. 8, the waveform of the gate signal #GLₙ in this example of operation is described as being substantially the same as the waveform of the gate signal #GLₙ shown in (b) of FIG. 3.

(c) of FIG. 8 is a timing chart showing a potential V_{PEn,m} of the liquid crystal electrode PE_{n,m}.

(d) of FIG. 8 is a timing chart showing a waveform of the counter electrode signal #COMLₙ, which is supplied to the counter electrode bus line COMLₙ. As shown in (d) of FIG. 8, the counter electrode signal #COMLₙ in this example of operation is a signal that takes on a potential V_{COM11}″, a potential V_{COM12}″, a potential V_{COM13}″, and a potential V_{COM14}″ in a single cycle composed of two consecutive vertical scanning periods T_{V}″. More specifically, as shown in (d) of FIG. 8, the counter electrode signal #COMLₙ takes on the potential V_{COM11}′ during a period T₁₁″ in a single vertical scanning period T_{V}″, takes on the potential V_{COM13}″ from a time t₁₃″ to a time t₁₄″ in a period T₁₂″, and takes on the potential V_{COM11}″ from the time t₁₄″ to a time t₁₆″ in the period T₁₂″. Further, the counter electrode signal #COMLₙ takes on the potential V_{COM14}″ during a period T₁₃″ in the ensuing vertical scanning period T_{V}″, takes on the potential V_{COM12}″ from a time t₁₇″ to a time t₁₈″ in a period T₁₄″, and takes on the potential V_{COM14}″ from the time t₁₈″ to a time t₂₀″ in the period T₁₄″. It is assumed that as shown in (d) of FIG. 8, specific values of the potentials V_{COM11}″, V_{COM12}″, V_{COM13}″, and V_{COM14}″ satisfy V_{COM11}″<V_{COM12}″<V_{COM13}″<V_{COM14}″.

The following describes the operation of each of the components in the pixel region P_{n,m} of the display panel 1 in this example of operation.

First, as shown in (b) of FIG. 8, the gate signal #GLₙ rises from a low level to a high level at the time t₁₁″ and, after a certain period of time has elapsed, falls to a low level. In a period of time during which the gate signal #GLₙ is at a high level, the transistor M_{n,m} is in a conducting state. When the transistor M_{n,m} is in a conducting state, the source signal #SLₘ is supplied to the pixel electrode PE_{n,m} and the first auxiliary capacitor electrode CE1_{n,m}. As shown in (c) of FIG. 8, in a period from the time t₁₁″ to the time t₁₂″, the potential V_{PEn,m} of the pixel electrode PE_{n,m} decreases from a potential V₁₁″ to a potential V₁₂″ (V₁₂″<V_{COM14}″).

Further, the counter electrode signal #COMLₙ falls from the potential V_{COM14}″ to the potential V_{COM11}″ at the time t₁₂″. Accordingly, the potential V_{PEn,m} of the pixel electrode PE_{n,m} changes from the potential V₁₂″ to a potential V₁₃″. It should be noted here that a specific value of the potential V₁₃″ is defined as:

V₁₃″=(V_{COM11}″−V_{COM14}″)×C_{LC}/Σ_{C}V₁₂″.

Since V_{COM11}″<V_{COM14}″ as mentioned above, the potential V₁₃″ is smaller than the potential V₁₂″.

Then, the counter electrode signal #COMLₙ rises from the potential V_{COM11}″ to the potential V_{COM13}″ at the time t₁₃″. Accordingly, the potential V_{PEn,m} of the pixel electrode PE_{n,m} changes from the potential V₁₃″ to a potential V₁₄″. It should be noted here that a specific value of the potential V₁₄″ is defined as:

V₁₄″=(V_{COM13}″−V_{COM11}″)×C_{LC}/Σ_{C}+V₁₃″.

Since V_{COM11}″<V_{COM13}″ as mentioned above, the potential V₁₄″ is greater than the potential V₁₃″.

Further, the potential V₁₃″, the potential V₁₄″, the potential V_{COM11}″, and the potential V_{COM13}″ satisfy V_{COM13}″-V₁₄″−(V_{COM11}″−V₁₃″)=(V_{COM13}″−V_{COM11}″)×(Σ_{C}−C_{LC})/Σ_{C}, and since V_{COM11}″<V_{COM13}″ as mentioned above, V_{COM13}″−V₁₄″>V_{COM11}″−V₁₃″ holds. That is, the potential difference between the potential V_{PEn,m} of the pixel electrode PE_{n,m} and the potential V_{ECOMn,m} of the counter electrode E_{COMn,m} in a period from the time t₁₃″ to the time t₁₄″ is greater than the potential difference between the potential V_{PEn,m} of the pixel electrode PE_{n,m} and the potential V_{ECOMn,m} of the counter electrode E_{COMn,m} in a period from the time t₁₂″ to the time t₁₃″. Therefore, the brightness of the pixel region P_{n,m} in the period from the time t₁₃″ to the time t₁₄″ is greater than the brightness of the pixel region P_{n,m} in the period from the time t₁₂″ to the time t₁₃″.

Then, the counter electrode signal #COMLₙ falls from the potential V_{COM13}″ to the potential V_{COM11}″ at the time t₁₄″. Accordingly, the potential V_{PEn,m} of the pixel electrode PE_{n,m} changes from the potential V₁₄″ to a potential V₁₃″.

Then, the gate signal #GLₙ rises from a low level to a high level at the time t₁₅″ and, after a certain period of time has elapsed, falls to a low level. In a period of time during which the gate signal #GLₙ is at a high level, the transistor M_{n,m} is in a conducting state, and the source signal #SLₘ is supplied to the pixel electrode PE_{n,m} and the first auxiliary capacitor electrode CE1_{n,m}.

As shown in (c) of FIG. 8, in a period from the time t₁₄″ to the time t₁₅″, the potential V_{PEn,m} of the pixel electrode PE_{n,m} increases from the potential V₁₄″ to the potential V₁₅″ (V₁₅″>V_{COM11}″).

Further, the counter electrode signal #COMLₙ rises from the potential V_{COM11}″ to the potential V_{COM14}″ at the time t₁₆″. Accordingly, the potential V_{PEn,m} of the pixel electrode PE_{n,m} changes from the potential V₁₅″ to the potential V₁₁″. It should be noted here that a specific value of the potential V₁₁″ is defined as:

V₁₁″=(V_{COM14}″−V_{COM11}″)×C_{LC}/Σ_{C}+V₁₅″.

Since V_{COM11}″<V_{COM14}″ as mentioned above, the potential V₁₁″ is greater than the potential V₁₅″.

Then, the counter electrode signal #COMLₙ falls from the potential V_{COM14}″ to the potential V_{COM12}″ at the time t₁₇″. Accordingly, the potential V_{PEn,m} of the pixel electrode PE_{n,m} changes from the potential V₁₁″ to the potential V₁₄″. It should be noted here that a specific value of the potential V₁₄″ is defined as:

V₁₄″=(V_{COM12}″−V_{COM14}″)×C_{LC}/Σ_{C}+V₁₁″.

Since V_{COM12}″<V_{COM14}″ as mentioned above, the potential V₁₄″ is smaller than the potential V₁₁″.

Further, the potential V₁₁″, the potential V₁₄″, the potential V_{COM12}″, and the potential V_{COM14}″ satisfy V₁₄″−V_{COM12}″−(V₁₁″−V_{COM14}″)=(V_{COM14}″−V_{COM12}″)×(Σ_{C}−C_{LC}) EC, and since V_{COM12}″<V_{COM14}″ as mentioned above, V₁₄″-V_{COM12}″>V₁₁″−V_{COM14}″ holds. That is, the potential difference between the potential V_{PEn,m} of the pixel electrode PE_{n,m} and the potential V_{ECOMn,m} of the counter electrode E_{COMn,m} in a period from the time t₁₁″ to the time t₁₈″ is greater than the potential difference between the potential V_{PEn,m} of the pixel electrode PE_{n,m} and the potential V_{ECOMn,m} of the counter electrode E_{COMn,m} in a period from the time t₁₆″ to the time t₁₇″. Therefore, the brightness of the pixel region P_{n,m} in the period from the time t₁₇″ to the time t₁₈″ is greater than the brightness of the pixel region P_{n,m} in the period from the time t₁₆″ to the time t₁₇″.

Then, the counter electrode signal #COMLₙ rises from the potential V_{COM12}″ to the potential V_{COM14}″ at the time t₁₈″. Accordingly, the potential V_{PEn,m} of the pixel electrode PE_{n,m} changes from the potential V₁₄″ to a potential V₁₁″.

Then, the gate signal #GLₙ rises from a low level to a high level at the time t₁₉″ and, after a certain period of time has elapsed, falls to a low level. The operation at the time t₁₉″ and later is the same as the operation at the time t₁₁″ and later.

The above example of operation has described a case where the counter electrode signal #COMLₙ falls from the potential V_{COM14}″ to the potential V_{COM11}″ at the time t₁₂″ and the counter electrode signal #COMLₙ rises from the potential V_{COM11}″ to the potential V_{COM14}″ at the time t₁₆″. However, more generally, the counter electrode signal #COMLₙ falls from the potential V_{COM14}″ to the potential V_{COM11}″ before several horizontal periods (period multiple times as long as a horizontal period Th) have elapsed since the time t₁₆″ and the counter electrode signal #COMLₙ rises from the potential V_{COM11}″ to the potential V_{COM14}″ before several horizontal periods (period multiple times as long as a horizontal period Th) have elapsed since the time t₁₆″.

As in this example of operation, the display panel 1 according to the present invention can also cause a change in brightness of the pixel region P_{n,m} in a single vertical scanning period.

Therefore, in this example of operation, too, the phenomenon of blurring of moving images can be suppressed. Further, in this example of operation, the counter electrode signal #COMLₙ takes on a four-valued voltage level. Therefore, as compared with the examples 4 and 5 of operation, the phenomenon of blurring of moving images can be more effectively suppressed.

The above examples 1 to 6 of operation have been described by taking, as an example, the gate signal #GLₙ that is supplied to the nth gate bus line GLₙ and the counter electrode signal #COMLₙ that is supplied to the nth counter electrode bus line COMLₙ. However, the same applies to a gate signal #GLₚ that is supplied to a gate bus line GLₚ (p≠n) other than the nth gate bus line and a counter electrode signal #COMLₚ that is supplied to a counter electrode bus line COMLₚ (p≠n) other than the nth counter electrode bus line.

Further, the counter electrode driver 14 in the display panel 1 according to the present invention supplies the nth counter electrode bus line COMLₙ with the counter electrode signal #COMLₙ in synchronization with the gate signal #GLₙ.

Furthermore, in a case where the source signal #SLₘ is such a polarity reversal signal as that mentioned above, i.e., in a case where the source signal #SLₘ is a signal that reverses its polarity every single horizontal scanning period, the counter electrode driver 14 supplies a counter electrode signal #COMLₙ₊₁ in such a way that the counter electrode signal #COMLₙ₊₁ has its polarity reversed with respect to the polarity of the counter electrode signal #COMLₙ.

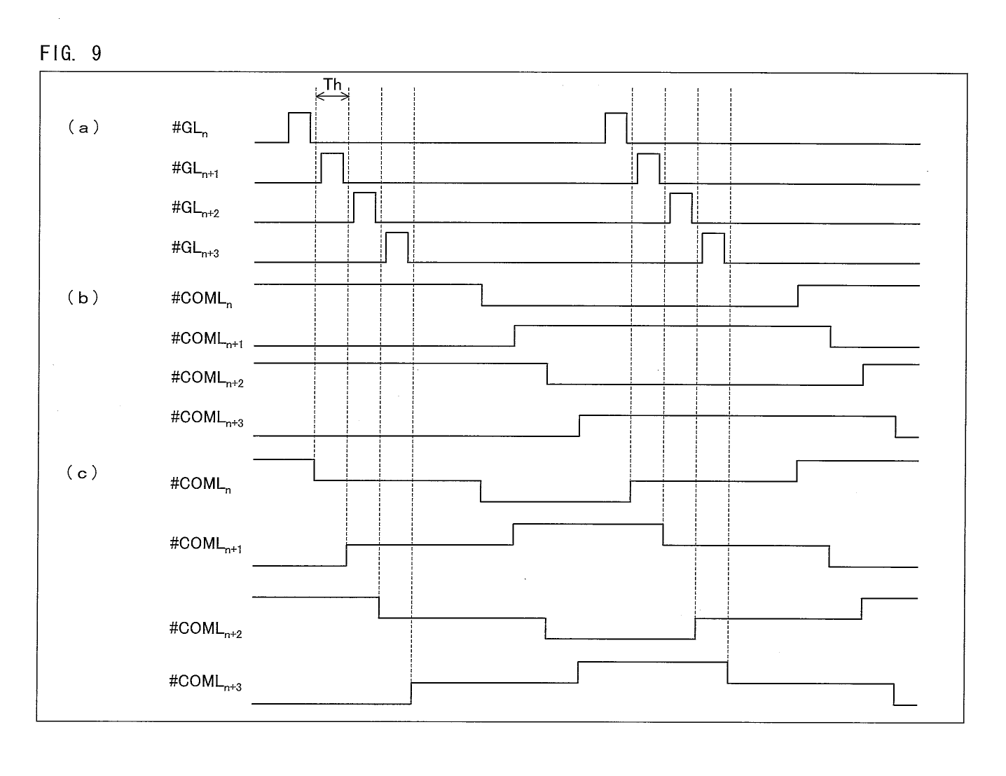

(a) of FIG. 9 is a timing chart showing examples of waveforms of gate signals #GLₙ to #GLₙ₊₃ that are supplied to the gate bus lines GLₙ to GLₙ₊₃, respectively. (b) of FIG. 9 is a timing chart showing examples of waveforms of counter electrode signals #COMLₙ to #COMLₙ₊₃ that are supplied to the counter electrode bus lines COMLₙ to COMLₙ₊₃, respectively, in the example 1 of operation described above. (c) of FIG. 9 is a timing chart showing examples of waveforms of counter electrode signals #COMLₙ to #COMLₙ₊₃ that are supplied to the counter electrode bus lines COMLₙ to COMLₙ₊₃, respectively, in the example 2 of operation described above.

In a case where as in the example 1 of operation, the potential level of the source signal #SLₘ during a selection period switches between the highest and lowest potential levels among a plurality of potential levels every single horizontal scanning period, i.e., in the case of line reversal driving, as shown in (b) and (c) of FIG. 9, the counter electrode driver 14 supplies the counter electrode signal #COMLₙ₊₁ in such a way that the counter electrode signal #COMLₙ₊₁ has its polarity reversed with respect to the polarity of the counter electrode signal #COMLₙ.

Further, as shown in (b) and (c) of FIG. 9, the counter electrode driver 14 supplies the counter electrode bus line COMLₙ with the counter electrode signals #COMLₙ to #COMLₙ₊₃ in synchronization with the gate signals #GLₙ to #GLₙ₊₃, respectively.

Further, the same applies to the other gate signal #GL_{q} (q≦n−1, q≧n+4) and the other counter electrode signal #COML_{q} (q≦n−1, q≧n+4).

In a case where the potential level of the source signal #SLₘ during a selection period switches between the highest and lowest potential levels among a plurality of potential levels every plural horizontal scanning periods, it is preferable the counter electrode driver 14 be configured to supply a counter electrode signal having its polarity reversed every plural counter electrode bus lines.

(Example 7 of Operation of the Display Panel 1)

The examples 1 to 6 of operation described above have been described by taking, as an example, a case where the counter electrode driver 14 supplies the plurality of counter electrode bus line COML₁ to COML_{N} with the counter electrode signals #COML₁ to #COML_{N}, respectively, in sequence every horizontal scanning period Th, i.e., a case where there is a phase difference corresponding to the length of a horizontal scanning period Th between the counter electrode signal #COMLₙ and the counter electrode signal #COMLₙ₊₁. However, the present invention is not to be limited to such an example.

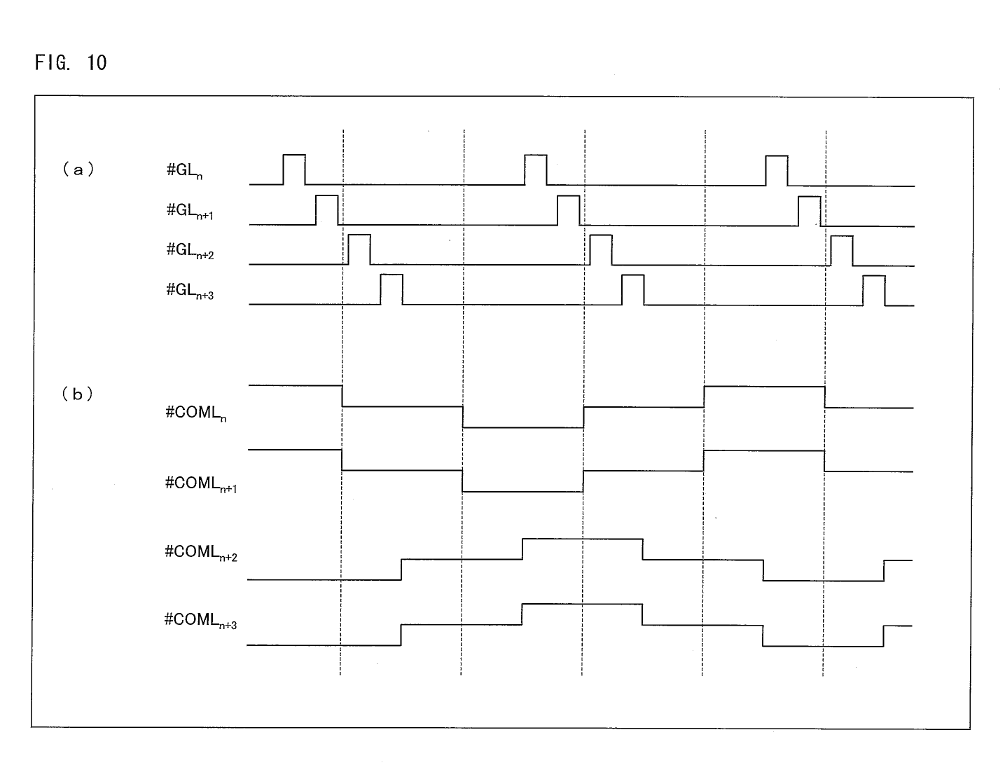

A seventh example of operation of the display panel 1 according to the present embodiment is described below with reference to (a) and (b) of FIG. 10. Further, this example of operation is described by taking, as an example, a case where the potential level of the source signal #SLₘ during a selection period switches between the highest and lowest potential levels among a plurality of potential levels every two horizontal scanning periods.

(a) of FIG. 10 is a timing chart showing examples of waveforms of gate signals #GLₙ to #GLₙ₊₃ that are supplied to the gate bus lines GLₙ to GLₙ₊₃, respectively. (b) of FIG. 10 is a timing chart showing examples of waveforms of counter electrode signals #COMLₙ to #COMLₙ₊₃ that are supplied to the counter electrode bus lines COMLₙ to COMLₙ₊₃, respectively, in this example of operation.

As shown in (b) FIG. 10, the counter electrode driver 14 supplies the counter electrode bus lines COMLₙ and COMLₙ₊₁ with the counter electrode signals #COMLₙ and #COMLₙ₊₁, which are in phase with each other. In other words, the counter electrode driver 14 supplies a pair of two adjacent counter electrode bus lines with a common counter electrode signal.

Thus, in this example of operation, the counter electrode driver 14 synchronously supplies the rectangular voltage signal (counter electrode signals #COMLₙ and #COMLₙ₊₁) to the counter electrode bus line COMLₙ connected to the counter electrode E_{COMn,m} opposed to the pixel electrode PE_{n,m} connected via the transistor M_{n,m} to the nth gate bus line GLₙ of the plurality of gate bus lines and to the counter electrode bus line COMLₙ₊₁ connected to the counter electrode E_{COMn+1,m} opposed to the pixel electrode PE_{n+1,m} connected via the transistor M_{n+1,m} to the (n+1)th gate bus line GLₙ₊₁ of the plurality of gate bus lines.

As a configuration to supply a pair of counter electrode bus lines with a common counter electrode signal, for example, it is only necessary to generate the counter electrode signals #COMLₙ and #COMLₙ₊₁ by using identical signal generating means in the counter electrode driver 14, and to supply the counter electrode signals #COMLₙ and #COMLₙ₊₁ to the counter electrode bus lines COMLₙ and COMLₙ₊₁, respectively.

Therefore, in this example of operation, the phenomenon of blurring of moving images can be suppressed by the counter electrode driver 14 of a simpler configuration.

Further, the display panel according to the present invention may be configured such that the counter electrode driver 14 synchronously supplies the rectangular voltage signal to the counter electrode bus line COMLₙ connected to the counter electrode E_{COMn,m} opposed to the pixel electrode PE_{n,m} connected via the transistor M_{n,m} to the nth gate bus line GLₙ of the plurality of gate bus lines and to the counter electrode bus line COMLₙ₊₂ connected to the counter electrode E_{COMn+2,m} opposed to the pixel electrode PE_{n+2,m} connected via the transistor M_{n+2,m} to the (n+2)th gate bus line GLₙ₊₂ of the plurality of gate bus lines.

The foregoing configuration makes it possible to synchronously supply the rectangular voltage signal to that one of the counter electrode bus lines which is connected to the counter electrode opposed to the pixel electrode connected via the transistor to the nth gate bus line of the plurality of gate bus lines and to that one of the counter electrode bus lines which is connected to the counter electrode opposed to the pixel electrode connected via the transistor to the (n+2)th gate bus line of the plurality of gate bus lines. Therefore, the counter electrode driver of a simpler configuration brings about a further effect of making it possible to suppress the phenomenon of blurring of moving images while suppressing the occurrence of flickers and streaks corresponding to polarity reversal.

Further, the counter electrode driver 14 may be configured to supply a set of three or more adjacent counter electrode bus lines with a common counter electrode signal.

As described above in the examples 1 to 7 of operation, in a single vertical scanning period, the display panel 1 according to the present embodiment supplies the counter electrode bus lines COML₁ to COML_{N} with the rectangular counter electrode signals #COML₁ to #COML_{N} each composed of a plurality of voltage levels, thereby making it possible to set up, in the single vertical scanning period, a period during which the brightness of the pixel region P_{n,m} is relatively high (such a period being hereinafter referred to as “bright period”) and a period during which the brightness of the pixel region P_{n,m} is relatively low (such a period being hereinafter referred to as “dark period”).

Further, the existence of such bright and dark periods in a single vertical scanning period can suppress blurring of images that are displayed on the display panel 1.

Further, the length of such a bright period and the length of such a dark period in a single vertical scanning period can be adjusted by changing the duty ratio of an counter electrode signal #COMLₙ that is supplied by the counter electrode driver 14.

It should be noted here that in a single vertical scanning period immediately after an application voltage of a positive polarity has been applied to the liquid crystal, the duty ratio of the counter electrode signal #COMLₙ means the proportion of a period during which the voltage level of the counter electrode signal #COMLₙ takes on the lowest voltage level among the plurality of voltage levels in the single vertical scanning period, and that in a single vertical period immediately after an application voltage of a negative polarity has been applied to the liquid crystal, the duty ratio of the counter electrode signal #COMLₙ means the proportion of a period during which the voltage level of the counter electrode signal #COMLₙ takes on the highest voltage level among the plurality of voltage levels in the single vertical scanning period. Further, the duty ratio corresponds to the proportion of a “bright period” in a single vertical scanning period.

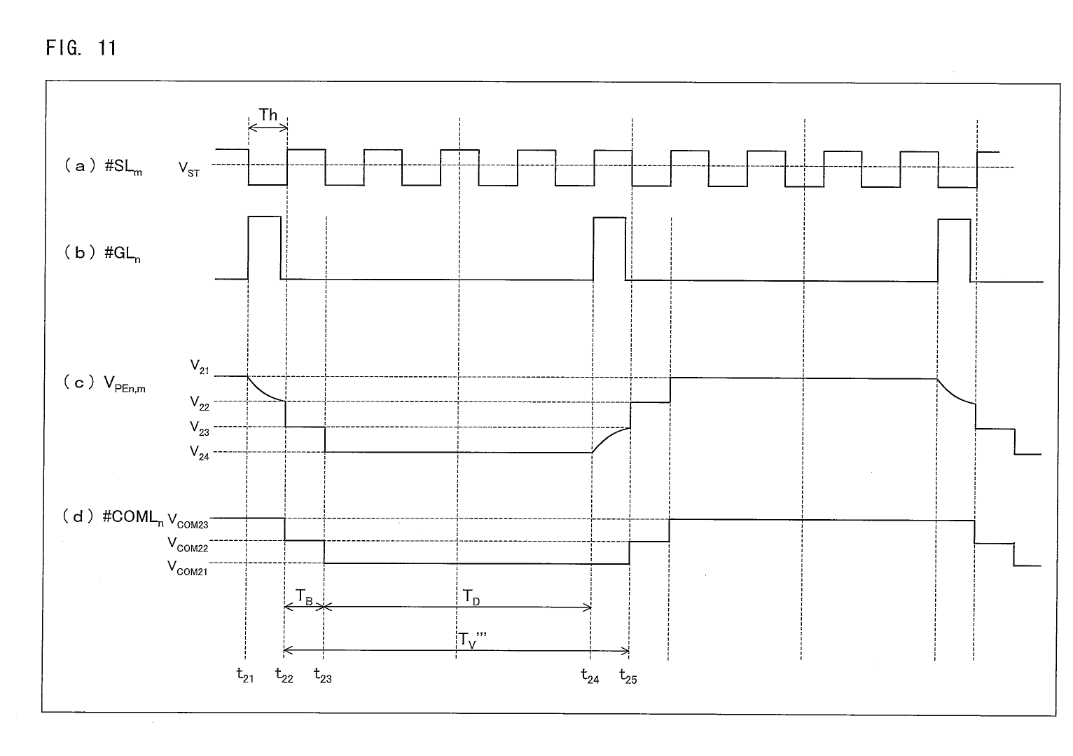

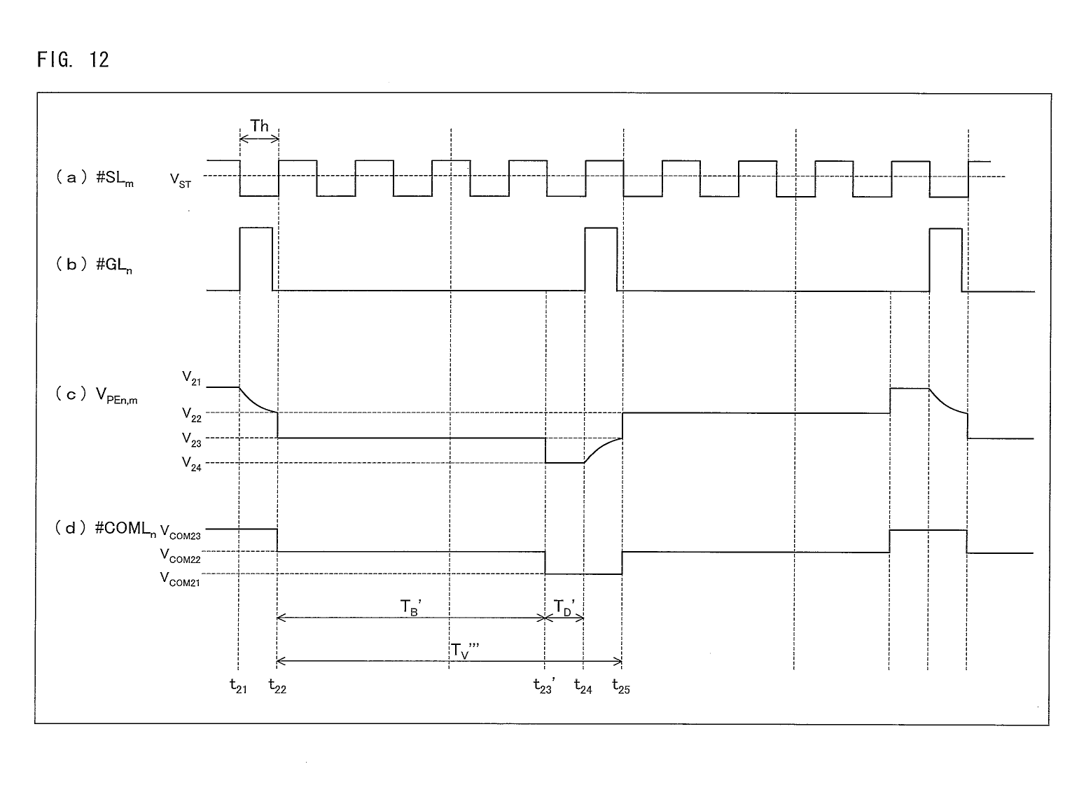

Two counter electrode signal #COMLₙ with different duty ratios, supplied by the counter electrode driver 14, are described below with reference to (a) through (d) of FIG. 11 and (a) through (d) of FIG. 12.

(a) of FIG. 11 is a timing chart showing an example of a waveform of the source signal #SLₘ, which is supplied to the source bus line SLₘ. As shown in (a) of FIG. 11, a case where the waveform of the source signal #SLₘ is the same as the waveform of the source signal #SLₘ shown in (a) of FIG. 8 is taken as an example.

(b) of FIG. 11 is a timing chart showing a waveform of the gate signal #GLₙ, which is supplied to the gate bus line GLₙ. As shown in (b) of FIG. 11, a case where the waveform of the gate signal #GLₙ is substantially the same as the waveform of the gate signal #GLₙ shown in (b) of FIG. 3 is taken as an example.

(c) of FIG. 11 is a timing chart showing a potential V_{PEn,m} of the liquid crystal electrode PE_{n,m}.

(d) of FIG. 11 is a timing chart showing a waveform of the counter electrode signal #COMLₙ, which is supplied to the counter electrode bus line COMLₙ, the waveform being set so that the duty ratio is approximately 10%. As shown in (d) of FIG. 11, the counter electrode signal #COMLₙ is a signal that takes on a potential V_{COM21}, a potential V_{COM22}, and a potential V_{COM23} in a single cycle composed of two consecutive vertical scanning periods T_{V}′″. More specifically, as shown in (d) of FIG. 11, the counter electrode signal #COMLₙ takes on the potential V_{COM22} during a period T_{B} in a single vertical scanning period T_{V}′″ and takes on the potential V_{COM21} from in a period T_{D}. Further, the counter electrode signal #COMLₙ takes on the potential V_{COM22} during a period T_{B} in the ensuing vertical scanning period T_{V}″ and takes on the potential V_{COM23} in a period T_{D}. It is assumed that as shown in (d) of FIG. 11, specific values of the potentials V_{COM21}, V_{COM22}, and V_{COM23} satisfy V_{COM21}<V_{COM22}<V_{COM23}.

As shown in (b) of FIG. 11, the gate signal #GLₙ rises from a low level to a high level at the time t₂₁ and, after a certain period of time has elapsed, falls to a low level. As shown in (c) of FIG. 11, in a period from the time t₂₁ to the time t₂₂, the potential V_{PEn,m} of the pixel electrode PE_{n,m} decreases from a potential V₂₁ to a potential V₂₂ (V₂₂<V_{COM23}).

Further, the counter electrode signal #COMLₙ falls from the potential V_{COM23} to the potential V_{COM22} at the time t₂₂. Accordingly, the potential V_{PEn,m} of the pixel electrode PE_{n,m} changes from the potential V₂₂ to a potential V₂₃. It should be noted here that a specific value of the potential V₂₃ is defined as:

V₂₃=(V_{COM22}−V_{COM23})×C_{LC}/Σ_{C}+V₂₂.

Since V_{COM22}<V_{COM23} as mentioned above, the potential V₂₃ is smaller than the potential V₂₂.

Then, the counter electrode signal #COMLₙ falls from the potential V_{COM22} to the potential V_{COM21} at the time t₂₃. Accordingly, the potential V_{PEn,m} of the pixel electrode PE_{n,m} changes from the potential V₂₃ to a potential V₂₄. It should be noted here that a specific value of the potential V₂₄ is defined as:

V₂₄=(V_{COM21}−V_{COM22})×C_{LC}/Σ_{C}+V₂₃.

Since V_{COM21}<V_{COM22} as mentioned above, the potential V₂₄ is smaller than the potential V₂₃.

Further, the potential V₂₃, the potential V₂₄, the potential V_{COM21}, and the potential V_{COM22} satisfy V_{COM21}-V₂₄−(V_{COM22}−V₂₃)=(V_{COM21}−V_{COM22})×(Σ_{C}−C_{LC})/Σ_{C}, and since V_{COM21}<V_{COM22} as mentioned above, V_{COM21}−V₂₄<V_{COM22}−V₂₃ holds. That is, the potential difference between the potential V_{PEn,m} of the pixel electrode PE_{n,m} and the potential V_{ECOMn,m} of the counter electrode E_{COMn,m} in a period from the time t₂₃ to the time t₂₄ is smaller than the potential difference between the potential V_{PEn,m} of the pixel electrode PE_{n,m} and the potential V_{ECOMn,m} of the counter electrode E_{COMn,m} in a period from the time t₂₂ to the time t₂₃. Therefore, the brightness of the pixel region P_{n,m} in the period from the time t₂₃ to the time t₂₄ is smaller than the brightness of the pixel region P_{n,m} in the period from the time t₂₂ to the time t₂₃.

As shown in (a) and (b) of FIG. 11, in a single vertical scanning period T_{V}′″ immediately after a source signal #SLₘ of a negative polarity has been applied, the period T_{B} (period from the time t₂₂ to the time t₂₃) during which the voltage level of the counter electrode signal #COMLₙ is relatively high occupies approximately 10% of the single vertical scanning period T_{V}′″, and the period T_{D} (period from the time t₂₃ to the time t₂₄) during which the voltage level of the counter electrode signal #COMLₙ is relatively low occupies approximately 90% of the single vertical scanning period T_{V}′″. That is, the duty ratio of the counter electrode signal #COMLₙ shown in (d) of FIG. 11 is approximately 10%. Further, in (d) of FIG. 11, the period T_{B} corresponds to a “bright period” and the period T_{D} corresponds to a “dark period”.

Thus, by supplying the counter electrode signal #COMLₙ with a duty ratio of approximately 10%, the counter electrode driver 14 can cause approximately 10% of a single vertical scanning period to be a “bright period” and approximately 90% to be a “dark period”.

Meanwhile, (d) of FIG. 12 is a timing chart showing a waveform of the counter electrode signal #COMLₙ with a duty ratio of approximately 90%. The source signal #SLₘ shown in (a) of FIG. 12 and the gate signal #GLₙ shown in (b) of FIG. 12 are the same signals as the source signal #SLₘ shown in (a) of FIG. 11 and the gate signal #GLₙ shown in (b) of FIG. 11, respectively. Further, (c) of FIG. 12 is a timing chart showing a potential V_{PEn,m} of the liquid crystal electrode PE_{n,m}.

As shown in (a) and (b) of FIG. 12, in a single vertical scanning period T_{V}′″ immediately after a source signal #SLₘ of a negative polarity has been applied, the period T_{B}′ (period from the time t₂₂ to the time t₂₃′) during which the voltage level of the counter electrode signal #COMLₙ is relatively high occupies approximately 90% of the single vertical scanning period T_{V}′″, and the period T_{D} (period from the time t₂₃′ to the time t₂₄) during which the voltage level of the counter electrode signal #COMLₙ is relatively low occupies approximately 10% of the single vertical scanning period T_{V}′″. That is, the duty ratio of the counter electrode signal #COMLₙ shown in (d) of FIG. 12 is approximately 90%. Further, in (d) of FIG. 12, the period T_{B}′ corresponds to a “bright period” and the period T_{D}′ corresponds to a “dark period”.

Thus, by supplying the counter electrode signal #COMLₙ with a duty ratio of approximately 90%, the counter electrode driver 14 can cause approximately 90% of a single vertical scanning period to be a “bright period” and approximately 10% to be a “dark period”.

Thus, the counter electrode driver 14 can change the proportion of a “bright period” and a “dark period” in a single vertical scanning period by changing the duty ratio of the counter electrode signal #COMLₙ.

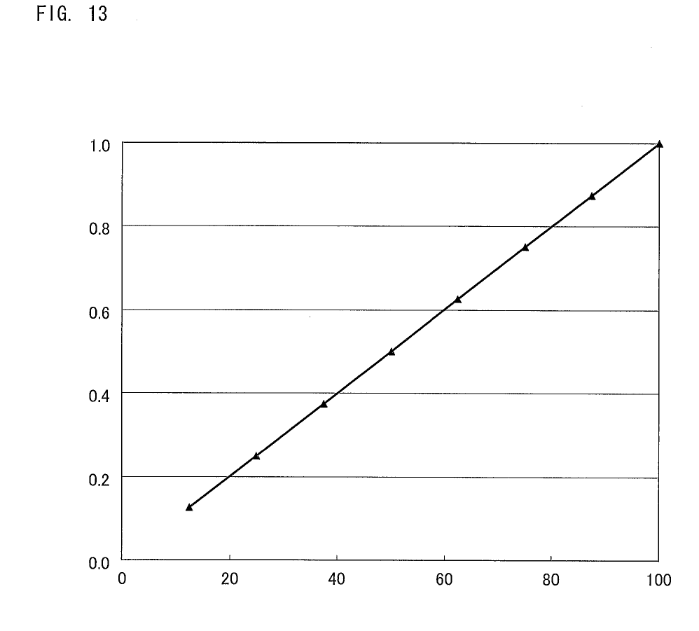

FIG. 13 is a graph showing a relationship between the duty ratio and brightness. In FIG. 13, the vertical axis represents the relative brightness with the lowest brightness at 0.0 and the highest brightness at 1.0, and the horizontal axis represents the duty ratio.

As shown in FIG. 13, the greater the duty ratio is, the higher the relative brightness is.

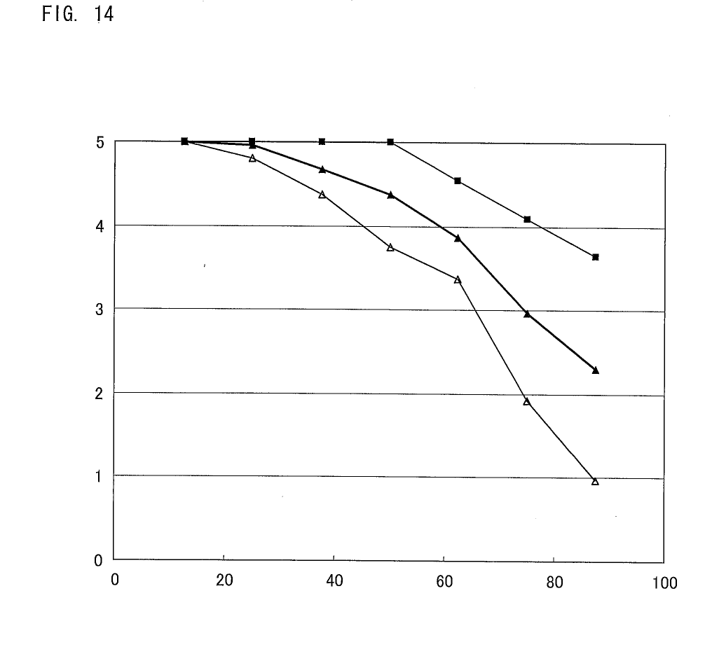

Further, FIG. 14 is a graph of experimental data showing a relationship between the duty ratio and the visibility of moving images that are displayed on the display panel 1.

The vertical axis of FIG. 14 represents, on a scale of 1 to 5, the visibility felt by a viewer looking at a moving image being displayed on the display panel 1. The higher the visibility is, the more clearly the moving image looks to the viewer, i.e., the less blurred the moving image looks to the viewer. The horizontal axis of FIG. 14 represents the aforementioned duty ratio.

In FIG. 14, the filled squares represent experimental data corresponding to the highest evaluations among evaluations of visibility given by a plurality of viewers, the open triangles representing experimental data corresponding to the lowest evaluations among the evaluations of visibility given by the plurality of viewers, the filled triangles representing the averages of the evaluations of visibility given by the plurality of viewers.

As shown in FIG. 14, at a duty ratio of approximately 10% or less, all of the viewers gave the highest evaluation of visibility. Meanwhile, at a duty ratio of approximately 90% or greater, most of the viewers cannot sense a change in visibility.

The experimental data shown in FIG. 14 shows that it is preferable that the aforementioned duty ratio be set within a range of approximately 10% to approximately 90%.

As described above, the rectangular voltage signal (counter electrode signal #COMLₙ) takes on any one of the first to third voltage levels (i.e., the potentials V_{COM21}, V_{COM22}, and V_{COM23}) in a period of time from a point in time at which the single scanning period (single vertical scanning period T_{V}′″) starts to a point in time where substantially 10% of the single scanning period elapses, and takes on another one of the first to third voltage levels (i.e., the potentials V_{COM21}, V_{COM22}, and V_{COM23}) in a period of time from a point in time where substantially 90% of the single scanning period elapses to a point in time at which the single scanning period ends.

As mentioned above, in the case of switching between a display at a high brightness and a display at a low brightness, the viewer feels no improvement in blurring of moving images when the percentage of the display at the high brightness is 90% or higher, feels more improvement in blurring of moving images at a lower percentage between 90% to 10%, and feels satisfactory improvement in blurring of moving images at a percentage of approximately 10%.

Therefore, the foregoing configuration makes it possible to effectively suppress the phenomenon of blurring of moving images.

Further, it is preferable that even in a case where the rectangular voltage signal (counter electrode signal #COMLₙ) takes on the first to fourth voltage levels in two such scanning periods, the rectangular voltage signal (counter electrode signal #COMLₙ) take on any one of the first to fourth voltage levels in a period of time from a point in time at which the single scanning period starts to a point in time where substantially 10% of the single scanning period elapses, and takes on another one of the first to fourth voltage levels in a period of time from a point in time where substantially 90% of the single scanning period elapses to a point in time at which the single scanning period ends.

As mentioned above, in the case of switching between a display at a high brightness and a display at a low brightness, the viewer feels no improvement in blurring of moving images when the percentage of the display at the high brightness is 90% or higher, feels more improvement in blurring of moving images at a lower percentage between 90% to 10%, and feels satisfactory improvement in blurring of moving images at a percentage of approximately 10%.

Therefore, the foregoing configuration brings about a further effect of making it possible to effectively suppress the phenomenon of blurring of moving images.

Further, the display panel 1 according to the present embodiment is preferably configured such that the source driver 12 changes the size of amplitude of the source signals #SL₁ to #SLₘ in accordance with the size of amplitude of the counter electrode signals #COML₁ to #COML_{N}.

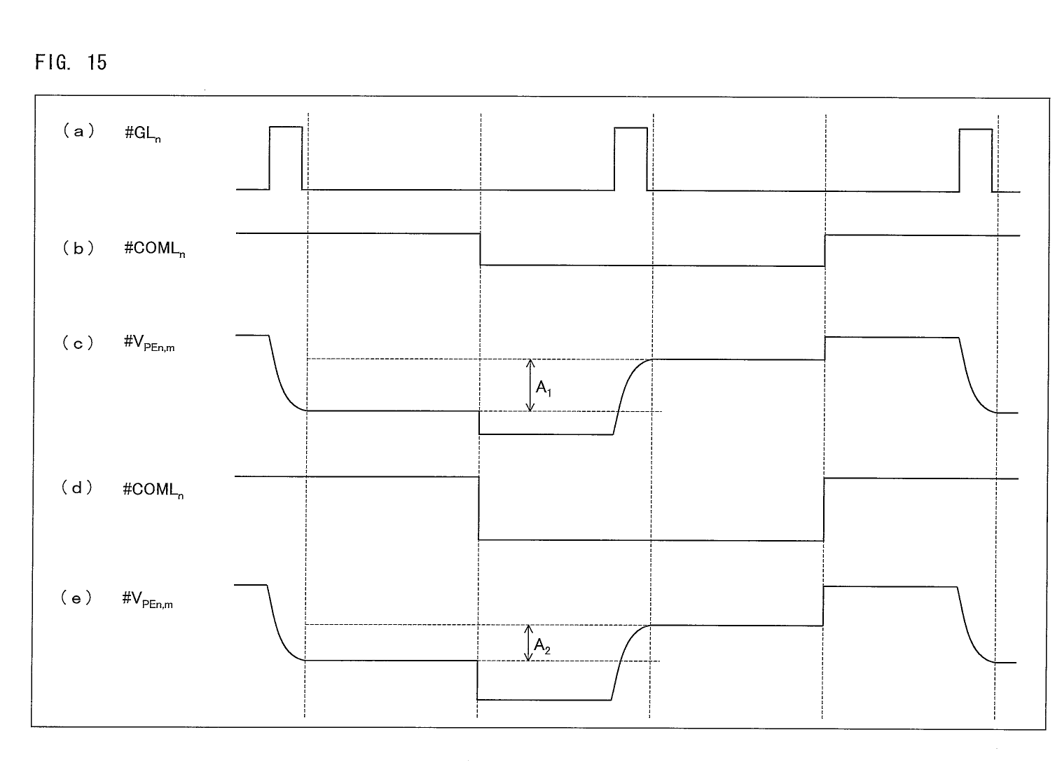

(a) of FIG. 15 is a timing chart showing a waveform of the gate signal #GLₙ. (b) of FIG. 15 is a timing chart showing a waveform of the counter electrode signal #COMLₙ of smaller amplitude. (c) of FIG. 15 is a timing chart showing an example of a waveform of the potential V_{PEn,m} as applied to the pixel electrode PE_{n,m} in a case where the counter electrode signal #COMLₙ shown in (b) of FIG. 15 is supplied. (d) of FIG. 15 is a timing chart showing a waveform of the counter electrode signal #COMLₙ of larger amplitude. (e) of FIG. 15 is a timing chart showing an example of a waveform of the potential V_{PEn,m} as applied to the pixel electrode PE_{n,m} in a case where the counter electrode signal #COMLₙ shown in (d) of FIG. 15 is supplied.

The amplitude A1 shown in (c) of FIG. 15 and the amplitude A2 shown in (e) of FIG. 15 represent the amplitude of the source signal #SLₘ.

As shown in (b) through (e) of FIG. 15, for example, the counter electrode driver 14 supplies the counter electrode signal #COMLₙ of smaller amplitude in a case where the amplitude of the source signal #SLₘ is larger, and supplies the counter electrode signal #COMLₙ of larger amplitude in a case where the amplitude of the source signal #SLₘ is smaller.

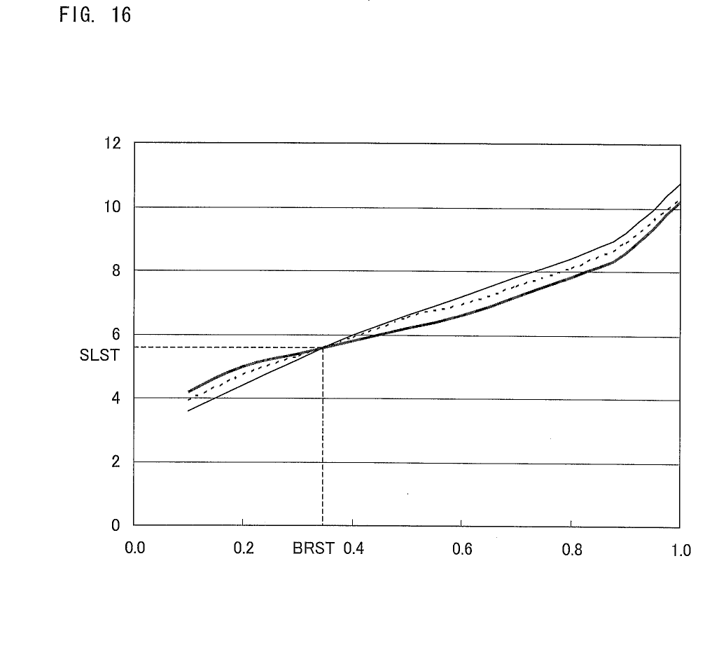

FIG. 16 is a graph showing a relationship between the amplitude of the source signal #SLₘ and the brightness of the pixel region P_{n,m} with the amplitude of the counter electrode signal #COMLₙ at 1.0 volt, 1.5 volts, or 2.0 volts. In FIG. 16, the vertical axis represents the amplitude of the source signal #SLₘ (unit: volt), and the horizontal axis represents the relative brightness with the lowest brightness at 0.0 and the highest brightness at 1.0. Further, in FIG. 16, the solid line indicates a case where the amplitude of the counter electrode signal #COMLₙ is at 2.0 volts, the dotted line indicating a case where the amplitude of the counter electrode signal #COMLₙ is at 1.5 volts, the bold line indicating a case where the amplitude of the counter electrode signal #COMLₙ is at 1.0 volt.

As shown in FIG. 16, there is such a positive correlation between the amplitude of the source signal #SLₘ and the relative brightness that when the amplitude of the source signal #SLₘ increases, the relative brightness increases. Further, when the amplitude of the counter electrode signal #COMLₙ becomes smaller, a change in relative brightness becomes more sensitive to a change in source signal #SLₘ. That is, when the amplitude of the counter electrode signal #COMLₙ becomes smaller, the slope of the graph shown in FIG. 16 becomes gentler.

In other words, the source driver 12 supplies the source signal #SLₘ so that in a case where the amplitude of the counter electrode signal #COMLₙ is smaller, the proportion of a change in amplitude of the source signal #SLₘ with respect to the relative brightness becomes smaller, and in a case where the amplitude of the counter electrode signal #COMLₙ is larger, the proportion of a change in amplitude of the source signal #SLₘ with respect to the relative brightness becomes larger.

Further, as shown in FIG. 16, the relationship between the amplitude of the source signal #SLₘ and the amplitude of the counter electrode signal #COMLₙ changes according to whether or not the amplitude of the source signal #SLₘ is less than a standard source amplitude SL_{ST}. The term “standard source amplitude SL_{ST}” here means such a value of the amplitude of source signal #SLₘ that the relative brightness remains unchanged even when the amplitude of the counter electrode signal #COMLₙ is changed.

As shown in FIG. 16, in a case where the amplitude of source signal #SLₘ is equal to the standard source amplitude SL_{ST}, the relative brightness remains unchanged even when the amplitude of the counter electrode signal #COMLₙ is changed. In the following, the relative brightness as obtained when the amplitude of source signal #SLₘ is equal to the standard source amplitude SL_{ST} is referred to as “standard relative brightness BR_{ST}”.

Further, as shown in FIG. 16, in order to hold the relative brightness constant in a range where the relative brightness is less than the standard relative brightness BR_{ST}, it is only necessary to supply the source signal #SLₘ of smaller amplitude when the amplitude of the counter electrode signal #COMLₙ is larger, and in order to hold the relative brightness constant in a range where the relative brightness is not less than the standard relative brightness BR_{ST}, it is only necessary to supply the source signal #SLₘ of larger amplitude when the amplitude of the counter electrode signal #COMLₙ is larger.

In other words, in order to hold the relative brightness constant in a case where the amplitude of the source signal #SLₘ is less than the standard source amplitude SL_{ST}, it is only necessary to supply the source signal #SLₘ of smaller amplitude when the amplitude of the counter electrode signal #COMLₙ is larger, and in order to hold the relative brightness constant in a case where the amplitude of the source signal #SLₘ is not less than the standard source amplitude SL_{ST}, it is only necessary to supply the source signal #SLₘ of larger amplitude when the amplitude of the counter electrode signal #COMLₙ is larger.

Further, a specific configuration, such as that described above, for supplying the counter electrode bus lines COML₁ to COML_{N} with the rectangular counter electrode signals #COML₁ to #COML_{N} each composed of a plurality of voltage levels can be realized, for example, by the counter electrode driver 14 including a plurality of power supplies for supplying the plurality of voltage levels and a selector for selecting any one of the voltage levels supplied from the plurality of power supplies.

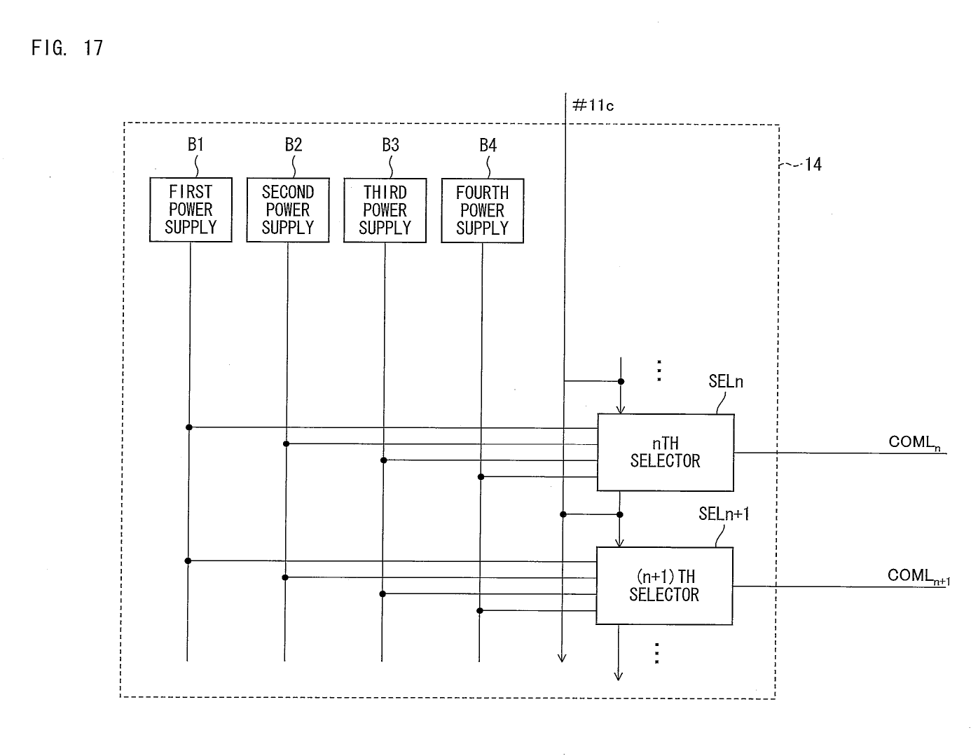

FIG. 17 is a block diagram showing a configuration of the counter electrode driver 14 for supplying the counter electrode signals #COML₁ to #COML_{N} each composed of a four-valued voltage level.

As shown in FIG. 17, the counter electrode driver 14 includes a first power supply B1, a second power supply B2. a third power supply B3, and a fourth power supply B4. Further, as shown in FIG. 17, the counter electrode driver 14 includes an nth selector SELₙ (1≦n≦N) connected to the counter electrode bus line COMLₙ (1≦n≦N).

Further, as shown in FIG. 17, the nth selector SELn is supplied with the control signal #11c that is outputted from the control section 11.

As shown in FIG. 17, a first potential that is outputted from the first power supply B1, a second potential that is outputted from the second power supply, a third potential that is outputted from the third power supply, and a fourth potential that is outputted from the fourth power supply are supplied to the nth selector SELn (1≦n≦N). The nth selector SELn selects any one of the first to fourth potentials in accordance with the control signal #11c and supplies the selected potential to the counter electrode bus line COMLₙ.

Although the present invention is not to be limited by a specific configuration of the first to fourth power supplies, DACs (digital-analog converters) to which digital values corresponding to the first to fourth potentials are inputted, respectively, may be used, for example, or another configuration may be used.

As described above, the display panel 1 according to the present invention is preferably configured such that the counter electrode driver 14 includes amplitude changing means for changing size of amplitude of the rectangular voltage signal (counter electrode signal #COMLₙ).

By the counter electrode driver 14 thus including amplitude changing means for changing size of amplitude of the rectangular voltage signal, the phenomenon of blurring of moving images can be more effectively suppressed.

Further, as described above, it is preferable that in a case where the source driver supplies the source signal #SLₘ of amplitude less than a predetermined standard amplitude, the source driver 12 supply the source signal #SLₘ of larger amplitude when the amplitude of the rectangular voltage signal (counter electrode signal #COMLₙ) is smaller and supply the source signal #SLₘ of smaller amplitude when the amplitude of the rectangular voltage signal (counter electrode bus line COMLₙ) is larger; and in a case where the source driver supplies the source signal #SLₘ of amplitude not less than the predetermined standard source amplitude, the source driver 12 supply the source signal #SLₘ of smaller amplitude when the amplitude of the rectangular voltage signal (counter electrode signal #COMLₙ) is smaller and supply the source signal #SLₘ of larger amplitude when the amplitude of the rectangular voltage signal (counter electrode signal #COMLₙ) is larger.

It should be noted that the standard amplitude needs only take on the aforementioned reference source amplitude SL_{ST}, for example.

The foregoing configuration makes it possible to effectively suppress the phenomenon of blurring of moving images, regardless of whether the rectangular voltage signal (counter electrode signal #COMLₙ) is of larger amplitude or smaller amplitude.

It should be noted the amplitude of the source signal is defined as being obtained by subtracting the potential of the source signal at the time of negative polarity writing from the potential of the source signal at the time of positive polarity writing (same applies below). Further, the time of positive polarity writing refers to the time of supply of the conducting signal during which the rectangular voltage signal is at the highest voltage level, and the time of negative polarity writing refers to the time of supply of the conducting signal during which the rectangular voltage signal is at a low, high voltage level (same applies below).

### Embodiment 2

In Embodiment 1, the display device 1 has been described as being configured to include N gate bus lines GLₙ to GL_{N} and N counter electrode bus lines COML₁ to COML_{N}. However, the present invention is not to be limited to this configuration.

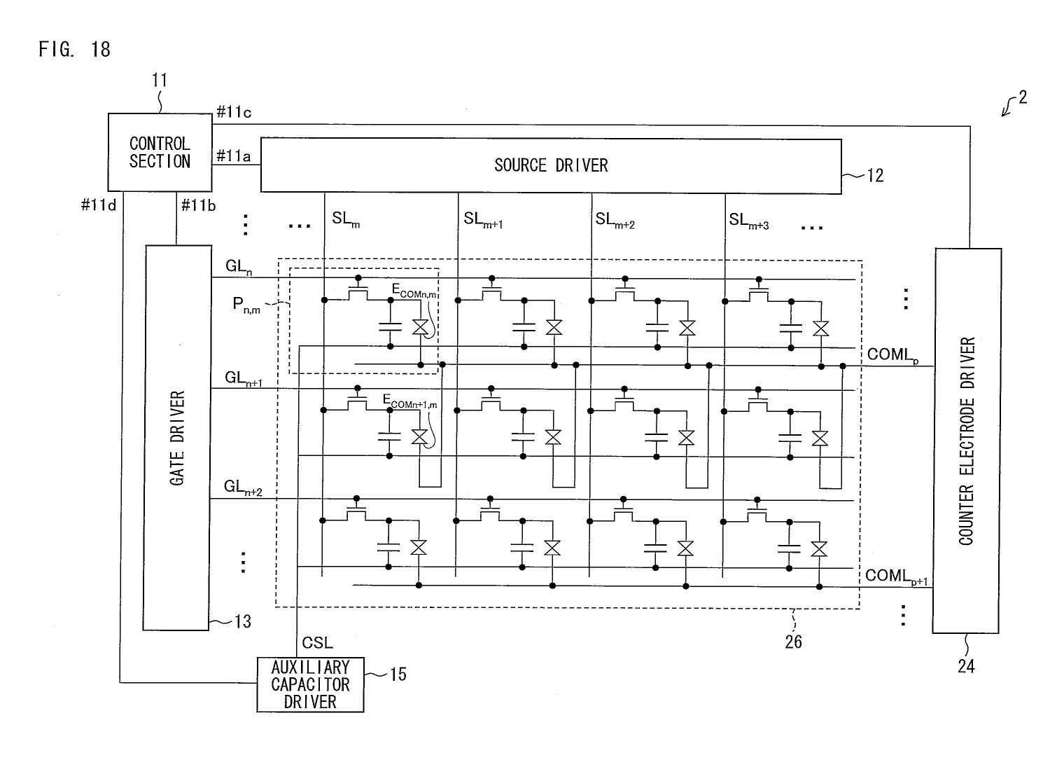

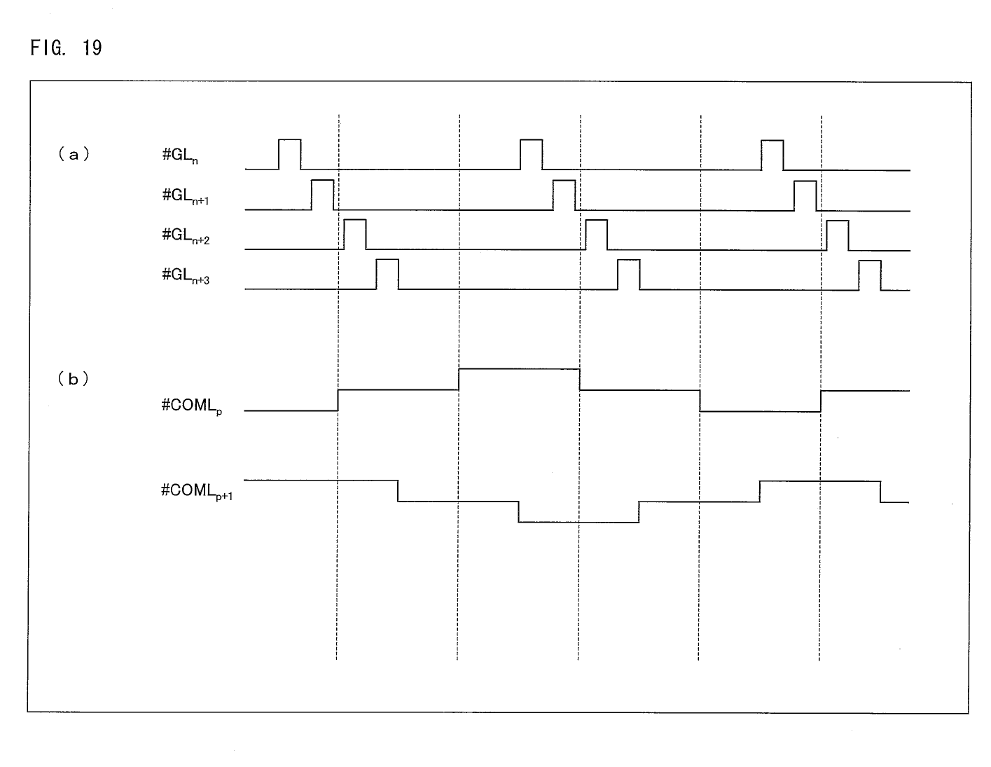

A display panel 2 according to a second embodiment of the present invention is described below with reference to FIGS. 18 and (a) and (b) of FIG. 19. It should be noted those parts which have already been described are given the same reference signs, and as such, will not be described below.

FIG. 18 is a block diagram showing a configuration of the display panel 2 according to the present embodiment. As shown in FIG. 18, the display panel 2 includes a counter electrode driver 24, instead of the counter electrode driver 14 in the display panel 1, and a display section 26, instead of the display section 16 in the display panel 1.

As shown in FIG. 18, in addition to the N gate bus lines GL₁ to GL_{N} (it is assumed in the present embodiment that N is an even number) and the M source bus lines SL₁ to SLₘ, the display section 26 has N/2 counter electrode bus lines COML₁ to COML_{N/2} formed therein.

Further, as shown in FIG. 18, a counter electrode E_{COMn,m} formed in the pixel region P_{n,m} defined by a gate bus line GLₙ (n is an odd number) and a counter electrode E_{COMn+1,m} formed in the pixel region P_{n+1,m} defined by a gate bus line GLₙ₊₁ are both connected to a counter electrode bus line COMLₚ (p=(n+1)/2).

The counter electrode driver 24 supplies the N/2 counter electrode bus lines COML₁ to COML_{N/2} with counter electrode signals #COML₁ to #COML_{N/2}, respectively.

Further, in the present embodiment, the source driver 12 is described as one which supplies the source bus line SLₘ with a source signal that reverses its polarity every two consecutive horizontal scanning periods.

The other components of the display panel 2 are the same as those of the display panel 1.

(a) of FIG. 19 is a timing chart showing examples of waveforms of gate signals #GLₙ to #GLₙ₊₃ that are supplied to the gate bus lines GLₙ to GLₙ₊₃, respectively, by the gate driver 13 in the display panel 2, and (b) of FIG. 19 is a timing chart showing examples of waveforms of counter electrode signals #COMLₚ (p=(n+1)/2) and #COMLₚ₊₁ that are supplied to the counter electrode bus lines COMLₚ and COMLₚ₊₁, respectively, by the counter electrode driver 24 in the display panel 2.

As shown in (a) and (b) of FIG. 19, the counter electrode driver 24 supplies the counter electrode bus line COMLₚ (p=(n+1)/2) with the counter electrode signal #COMLₚ (p=(n+1)/2) in synchronization with the gate signals #GLₙ and #GLₙ₊₁, and supplies the counter electrode bus line COMLₚ₊₁ (p=(n+1)/2) with the counter electrode signal #COMLₚ₊₁ (p=(n+1)/2) in synchronization with the gate signals #GLₙ₊₂ and #GLₙ₊₃.

Thus, the display panel 2 according to the present embodiment is configured such that: the number of the plurality of gate bus lines GL₁ to GL_{N} is an even number; the number of the plurality of counter electrode bus lines is a half of the number of gate bus lines (i.e., N/2); and the counter electrode E_{COM2k-1,m} opposed to the pixel electrode PE_{2k-1,m} connected via the transistor M_{2k-1,m} to the (2k−1)th (k is a natural number) gate bus line GL₂ₖ₋₁ of the plurality of gate bus lines and the counter electrode E_{COM2k,m} opposed to the pixel electrode PE_{2k,m} connected via the transistor M_{2k,m} to the 2kth gate bus line GL₂ₖ of the plurality of gate bus lines are connected to the kth counter electrode bus line COMLₖ of the plurality of counter electrode bus lines.

The display panel 2 according to the present embodiment can reduce the number of counter electrode bus lines to half as compared with the display panel 1 in Embodiment 1. Therefore, the configuration of the display section 26 in the display panel 2 can be made simpler than the configuration of the display section 16 in the display panel 1. Further, since the counter electrode driver 24 in the display panel 2 needs only supply the N/2 counter electrode bus lines COML₁ to COML_{N/2} with the counter electrode signals #COML₁ to #COML_{N/2}, respectively, the counter electrode driver 24 can be made simpler in configuration than the counter electrode driver 14, in the display panel 1, which supplies the N counter electrode bus lines COML₁ to COML_{N} with the counter electrode signals #COML₁ to #COML_{N}, respectively. That is, the display panel 2 according to the present embodiment can suppress the phenomenon of blurring of moving images with a simpler configuration than the display panel 1 in Embodiment 1.

### Embodiment 3

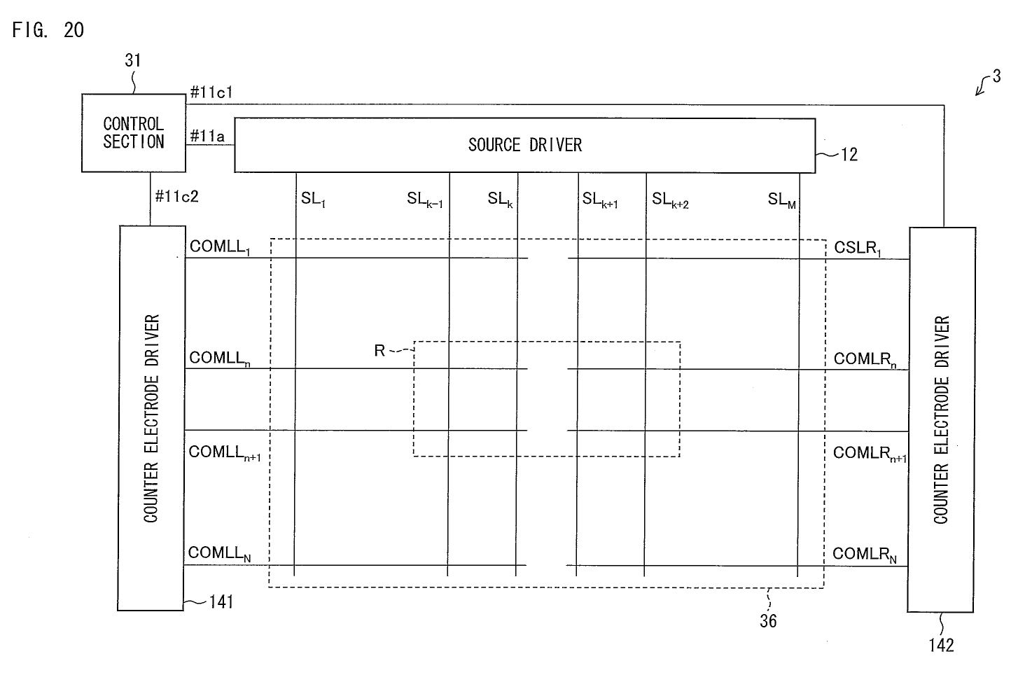

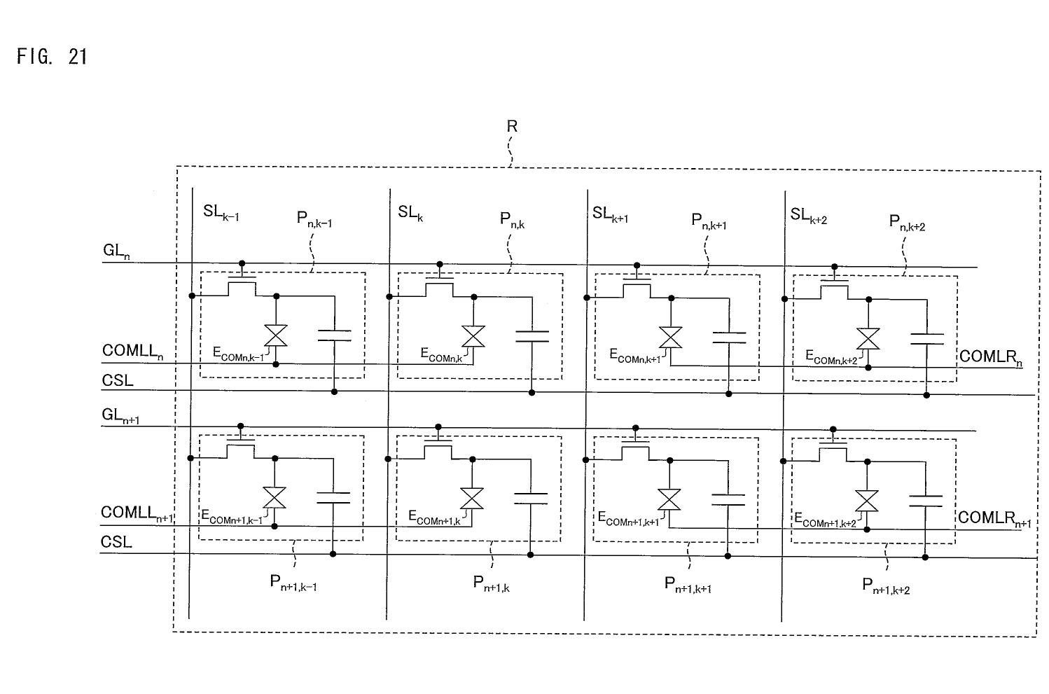

A display panel 3 according to a third embodiment of the present invention is described below with reference to FIGS. 20 and 21.

FIG. 20 is a block diagram showing a configuration of the display panel 3 according to the present embodiment. As shown in FIG. 20, the display panel 3 includes a control section 31, a source driver 12, a counter electrode driver 141, a counter electrode driver 142, and a display section 36. Further, the display panel 3 includes a gate driver (not illustrated) and an auxiliary capacitor driver (not illustrated). It should be noted here that the gate driver (not illustrated) and the auxiliary capacitor driver (not illustrated) are identical in configuration to the gate driver 13 and the auxiliary capacitor driver 15 in the display panel 1.

As shown in FIG. 20, the display section 36 has the counter electrode drivers 141 and 142 disposed on both sides thereof, respectively. Further, the counter electrode driver 141 is supplied with a control signal #11c2 from the control section 31, and the counter electrode driver 142 is supplied with a control signal #11c1 from the control section 31.

The display section 36 is provided with M source bus lines SL₁ to SL_{M} and N gate bus lines (not illustrated). It should be noted that the N gate bus lines (not illustrated) are identical in configuration to the N gate bus lines GL₁ to GL_{N} in the display pane 1. Further, the display section 36 is provided with an auxiliary capacitor bus line (not illustrated) identical to the auxiliary capacitor bus line CSL in the display panel 1.

Further, as shown in FIG. 20, the display section 36 has N counter electrode bus lines COMLL₁ to COMLL_{N} formed on a left half surface thereof substantially perpendicularly to the source bus lines SL₁ to SL_{M}, and has N counter electrode bus lines COMLR₁ to COMLR_{N} formed on a right half surface thereof substantially perpendicularly to the source bus lines SL₁ to SL_{M}. Further, the N counter electrode bus lines COMLL₁ to COMLL_{N} and the N counter electrode bus lines COMLR₁ to COMLR_{N} are insulated from each other. Further, as shown in FIG. 20, the counter electrode bus line COMLLₙ and the counter electrode bus line COMLRₙ are disposed collinearly. Therefore, in other words, in the present embodiment, the counter electrode bus line COMLₙ in the display panel 1 is constituted by the two counter electrode bus lines COMLLₙ and COMLRₙ formed collinearly via an insulating section.

Further, each of the N counter electrode bus lines COMLL₁ to COMLL_{N} has an end connected to the counter electrode driver 141, and each of the N counter electrode bus lines COMLR₁ to COMLR_{N} has an end connected to the counter electrode driver 142.

The counter electrode driver 141 supplies the counter electrode bus lines COMLL₁ to COMLL_{N} with counter electrode signals #COMLL₁ to #COMLL_{N}, respectively, and the counter electrode driver 142 supplies the counter electrode bus lines COMLR₁ to COMLR_{N} with counter electrode signals #COMLR₁ to #COMLR_{N}, respectively.

FIG. 21 is a circuit diagram showing a configuration of the display section 36 in a region R shown in FIG. 20. As shown in FIG. 21, counter electrodes E_{COMn,1} to E_{COMn,k} respectively formed in the pixel regions P_{n,1} to P_{n,k} defined by source bus lines SL₁ to SLₖ are connected to the counter electrode bus line COMLLₙ, and counter electrodes E_{COMn,k+1} to E_{COMn,M} respectively formed in the pixel regions P_{n,k+1} to P_{n,M} defined by source bus lines SLₖ₊₁ to SL_{M} are connected to the counter electrode bus line COMLRₙ. The same applies to the pixel regions P_{s,1} to P_{s,k} (s≠n, 1≦s≦N) and the pixel regions P_{s,k+1} to P_{s,M} (s≠n, 1≦s≦N).

It should be noted here that the k take on a value of approximately M/2, where M is the number of source bus lines. Further, it is preferable that the value of k fall within a range of approximately 0.45×M to 0.55×M.

The counter electrode drivers 141 and 142 may be configured to carry out the same operation as the counter electrode driver 14 described in Embodiment 1, or may be configured to supply different counter electrode signals from each other. For example, the counter electrode driver 141 may supply counter electrode signals #COMLL₁ to #COMLL_{N} such as those of the example 2 of operation of Embodiment 1, and the counter electrode driver 142 may supply counter electrode signals #COMLR₁ to #COMLR_{N} such as those of the example 5 of operation of Embodiment 1. Further, the counter electrode drivers 141 and 142 may be configured to output counter electrode signals #COMLL₁ to #COMLL_{N} and counter electrode signals #COMLR₁ to #COMLR_{N}, respectively, that are different in duty ratio from each other.

Further, it is preferable that in a case where the source driver 12 supplies the source bus lines SL₁ to SLₖ with source signals #SL₁ to #SLₖ of larger amplitude such as those shown in (c) of FIG. 15 and supplies the source bus lines SLₖ₊₁ to SL_{M} with source signals #SLₖ₊₁ to #SL_{M} of smaller amplitude such as those shown in (e) of FIG. 15, the counter electrode driver 141 supply the counter electrode bus lines COMLL₁ to COMLL_{N} with counter electrode signals #COMLL₁ to #COMLL_{N} of smaller amplitude such as those shown in (b) of FIG. 15 and the counter electrode driver 142 supply the counter electrode bus lines COMLR₁ to COMLR_{N} with counter electrode signals #COMLR₁ to #COMLR_{N} of larger amplitude such as those shown in (d) of FIG. 15.

As described above, the display panel 3 according to the present embodiment is configured such that: the counter electrode driver comprises two counter electrode drivers (counter electrode drivers 141 and 142); the given counter electrode bus line (counter electrode bus line COMLₙ) is constituted by two counter electrode bus lines (counter electrode bus lines COMLLₙ and COMLRₙ) formed collinearly via an insulating section; in the single scanning period, either one (counter electrode driver 141) of the two counter electrode drivers supplies either one (counter electrode bus line COMLLₙ) of the two counter electrode bus lines with the rectangular voltage signal (counter electrode signal #COMLLₙ) in synchronization with the conducting signal (high-level interval of the gate signal GLₙ), the rectangular voltage signal (counter electrode signal #COMLLₙ) being composed of the first voltage level and the second voltage level that is different from the first voltage level; and in the single scanning period, the other one (counter electrode driver 142) of the two counter electrode drivers supplies the other one (counter electrode bus line COMLRₙ) of the two counter electrode bus lines with the rectangular voltage signal (counter electrode signal #COMLRₙ) in synchronization with the conducting signal, the rectangular voltage signal (counter electrode signal #COMLRₙ) being composed of the first voltage level and the second voltage level that is different from the first voltage level.

The display panel 3 according to the present embodiment can supply a pixel electrode connected to the one counter electrode bus line (counter electrode bus line COMLLₙ) and a pixel electrode connected to the other counter electrode bus line (counter electrode bus line COMLRₙ) with the rectangular voltage signals (counter electrode signals #COMLLₙ and #COMLRₙ) independently from each other.

Therefore, the foregoing configuration allows a pixel region including the pixel electrode connected to the one counter electrode bus line and a pixel region including the pixel electrode connected to the other counter electrode bus line to display images that are different in improvement effect on the phenomenon of blurring of moving images. Therefore, the improvement effect of the present invention on the blurring of moving images can be made to more effectively claim users' attention. That is, the improvement effect of the present invention on the blurring of moving images can be made more effectively appealing to users.

Further, as mentioned above, the source driver 12 may be configured to supply source signals of different amplitudes to the source bus line SLₘ connected via the transistor M_{n,m} to the pixel electrode PE_{n,m} opposed to the counter electrode E_{COMn,m} (m≦k) connected to the one counter electrode bus line (counter electrode bus line COMLLₙ) and to the source bus line SLᵣ connected via the transistor M_{n,r} to the pixel electrode PE_{n,r} opposed to the counter electrode COM_{n,r} (r≧k+1) connected to the other counter electrode bus line (counter electrode bus line COMLRₙ).

Thus, the pixel electrode PE_{n,m} (m≦k) connected to the one counter electrode bus line (counter electrode bus line COMLLₙ) and the pixel electrode PE_{n,m} (m≧k+1) connected to the other counter electrode bus line (counter electrode bus line COMLRₙ) are supplied with the rectangular voltage signals (counter electrode signals #COMLLₙ and #COMLRₙ) independently from each other, whereby while uniforming the visibility of images except for the blurring of moving images, the pixel region including the pixel electrode connected to the one counter electrode bus line and the pixel region including the pixel electrode connected to the other counter electrode bus line can display images that are different in improvement effect on the phenomenon of blurring of moving images. Therefore, the improvement effect of the present invention on the blurring of moving images can be made to more effectively claim users' attention. That is, the improvement effect of the present invention on the blurring of moving images can be made more effectively appealing to users.

Further, the one counter electrode bus line (counter electrode bus line COMLLₙ) has a length that is substantially 45% to substantially 55% of that of the given counter electrode bus line (counter electrode bus line COMLₙ) in the display panel 1, and the other counter electrode bus line (counter electrode bus line COMLRₙ) has a length that is substantially equal to a length obtained by subtracting the length of the one counter electrode bus line (counter electrode bus line COMLLₙ) from the length of the given counter electrode bus line (counter electrode bus line COMLₙ in the display panel 1).

Therefore, according to the display panel 3 configured as described above, the brightness of the pixel region including the pixel electrode PE_{n,m} (n≦k) disposed on one half surface of the display section 36 and the brightness of the pixel region including the pixel electrode PE_{n,m} (n≦k+1) disposed on the other half surface can be each independently controlled in the single scanning period.

Further, since the one counter electrode bus line (counter electrode bus line COMLLₙ) and the other counter electrode bus line (counter electrode bus line COMLRₙ) can be made substantially identical in load characteristic to each other, the counter electrode driver 141 connected to the one counter electrode bus line (counter electrode bus line COMLLₙ) and the counter electrode driver 142 connected to the other counter electrode bus line (counter electrode bus line COMLRₙ) can be made substantially identical in configuration to each other.

Therefore, according to the foregoing configuration, the improvement effect of the present invention on the blurring of moving images can be made effectively appealing to users by a configuration that is easy to design and fabricate.

Further, the display panel 3 according to the present invention is configured such that the one counter electrode driver (counter electrode driver 141) includes first amplitude changing means (configured in the same manner as that shown in FIG. 17) for changing size of amplitude of the rectangular voltage signal, and the other counter electrode driver (counter electrode driver 142) includes second amplitude changing means (configured in the same manner as that shown in FIG. 17) for changing size of amplitude of the rectangular voltage signal.

Therefore, the one counter electrode driver and the other counter electrode driver can supply the rectangular voltage signal of different amplitudes.

Therefore, according to the foregoing configuration, the one counter electrode driver and the other counter electrode driver supply the rectangular voltage signal of different amplitudes, whereby the pixel region including the pixel electrode connected to the one counter electrode bus line and the pixel region including the pixel electrode connected to the other counter electrode bus line can display images that are different in improvement effect on the phenomenon of blurring of moving images. Therefore, the improvement effect of the present invention on the blurring of moving images can be made to more effectively claim users' attention. That is, the improvement effect of the present invention on the blurring of moving images can be made more effectively appealing to users.

Further, the display panel according to the present invention is configured such that: in a case where the source driver 12 supplies the source signal #SLₘ of amplitude less than a predetermined standard amplitude, the source driver 12 (i) supplies, in a case where the one counter electrode driver (counter electrode driver 141) supplies the one counter electrode bus line (counter electrode bus line COMLLₙ) with the rectangular voltage signal (counter electrode signal #COMLLₙ) of smaller amplitude, the source signals #SL₁ to #SLₖ of larger amplitude to the source bus lines SL₁ to SLₖ each connected via the transistor M_{n,m} to the pixel electrode PE_{n,m} opposed to the counter electrode E_{COMn,m} (m≦k) connected to the one counter electrode bus line, and (ii) supplies, in a case where the one counter electrode driver (counter electrode driver 141) supplies the one counter electrode bus line (counter electrode bus line COMLLₙ) with the rectangular voltage signal (counter electrode signal #COMLLₙ) of larger amplitude, the source signals #SL₁ to #SLₖ of smaller amplitude to the source bus lines SL₁ to SLₖ each connected via the transistor M_{n,m} to the pixel electrode PE_{n,m} opposed to the counter electrode E_{COMn,m} (m≦k) connected to the one counter electrode bus line; and in a case where the source driver 12 supplies the source signal #SLₘ of amplitude not less than the predetermined standard amplitude, the source driver 12 (i) supplies, in a case where the other counter electrode driver (counter electrode driver 142) supplies the other counter electrode bus line (counter electrode bus line COMLRₙ) with the rectangular voltage signal (counter electrode signal #COMLRₙ) of smaller amplitude, the source signals #Sₖ₊₁ to #SL_{M} of smaller amplitude to the source bus lines Sₖ₊₁ to SL_{M} each connected via the transistor M_{n,r} to the pixel electrode PE_{n,r} opposed to the counter electrode E_{COMn,r} (r≧k+1) connected to the other counter electrode bus line, and (ii) supplies, in a case where the other counter electrode driver (counter electrode driver 142) supplies the other counter electrode bus line (counter electrode bus line COMLRₙ) with the rectangular voltage signal (counter electrode signal #COMLRₙ) of larger amplitude, the source signals #Sₖ₊₁ to #SL_{M} of larger amplitude to the source bus lines Sₖ₊₁ to SL_{M} each connected via the transistor M_{n,r} to the pixel electrode PE_{n,r} opposed to the counter electrode E_{COMn,r} (r≧k+1) connected to the other counter electrode bus line.

It should be noted that the standard amplitude needs only take on the aforementioned standard source amplitude SL_{ST}, for example.

According to the foregoing configuration, while uniforming the visibility of images except for the blurring of moving images, the pixel region including the pixel electrode connected to the one counter electrode bus line and the pixel region including the pixel electrode connected to the other counter electrode bus line can display images that are different in improvement effect on the phenomenon of blurring of moving images. Therefore, the improvement effect of the present invention on the blurring of moving images can be more effectively appealing to users.

### Embodiment 4

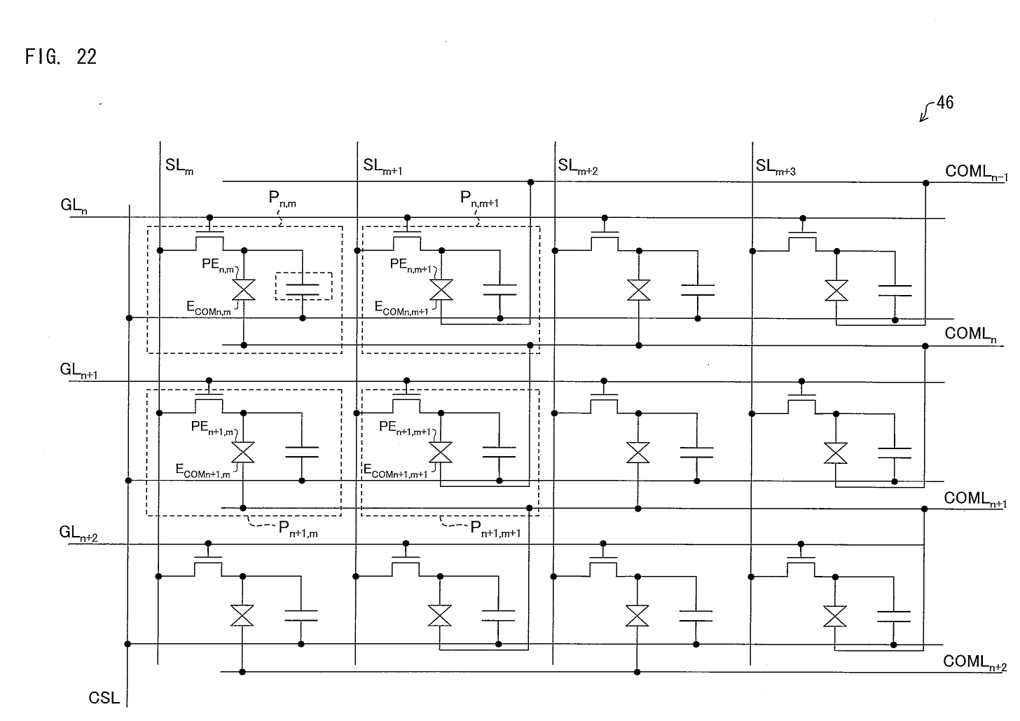

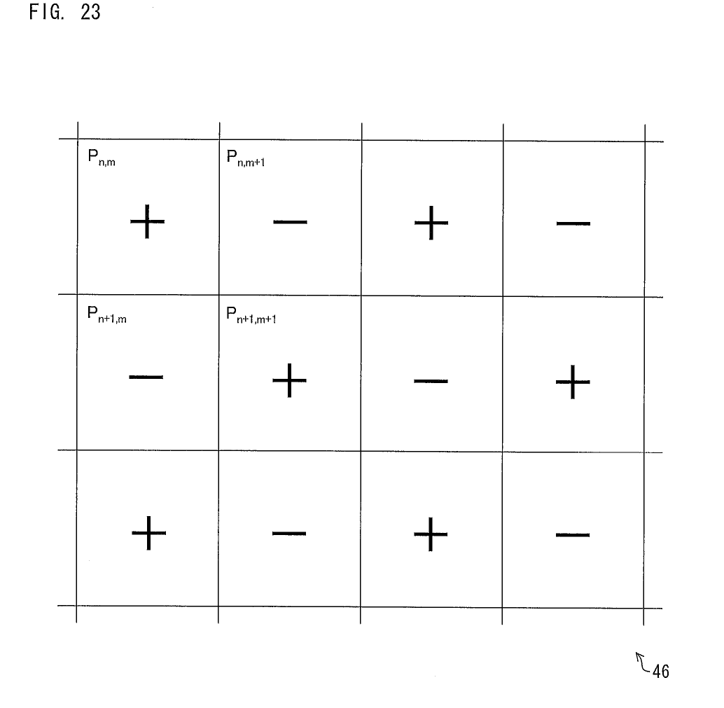

In Embodiments 1 to 3, the applications of the present invention to a line reversal driving system have mainly been described. However, the present invention is not to be limited to a line reversal driving system. In the following, the application of the present invention to a dot reversal driving system in which adjacent pixel electrodes are supplied with source signals that are opposite in polarity to each other is described with reference to FIGS. 22 and 23.

FIG. 22 is a circuit diagram showing a configuration of a display section 46 in a display panel according to the present embodiment. Another configuration of the display panel according to the present embodiment is identical to the configuration of the display panel 1 in Embodiment 1.

FIG. 23 is a diagram showing the polarities of source signals that are applied to the respective pixel electrodes of the display section 46. In the present embodiment, as shown in FIG. 23, pixel electrodes that are adjacent to each other are supplied with source signals that are opposite in polarity to each other. For such dot reversal driving, the source driver in the present embodiment needs only be configured, for example, to supply, at a given timing, such source signals #SL₁ to #SL_{M} that the polarity of the source signal #SLₘ and the polarity of the source signal #SLₘ₊₁ are polarities that are opposite to each other.

As shown in FIG. 22, in the display section 46, the counter electrode E_{COMn,m} formed in the pixel region P_{n,m} is connected to the counter electrode bus line COMLₙ, and the counter electrode E_{COMn,m+1} formed in the pixel region P_{n,m+1} is connected to the counter electrode bus line COMLₙ₋₁.

Further, the counter electrode E_{COMn+1,m} formed in the pixel region P_{n+1,m} is connected to the counter electrode bus line COMLₙ₊₁, and the counter electrode E_{COMn+1,m+1} formed in the pixel region P_{n+1,m+1} is connected to the counter electrode bus line COMLₙ.

Further, the counter electrode driver in the present embodiment supplies such counter electrode signals #COML₁ to #COML_{N} that the polarity of the counter electrode signal #COMLₙ and the polarity of the counter electrode signal #COMLₙ₊₁ are opposite polarities. This can be realized, for example, by configuring the counter electrode driver in the present embodiment in the same manner as the counter electrode driver 14 in Embodiment 1.

Thus, the display panel according to the present embodiment is configured such that: the counter electrode E_{COMn,m} opposed to the pixel electrode PE_{n,m} connected to the transistor M_{n,m} connected to the nth gate bus line GLₙ of the plurality of gate bus lines and to the mth source bus line SLₘ of the plurality of source bus lines is connected to the nth counter electrode bus line COMLₙ of the plurality of counter electrode bus lines; and the counter electrode E_{COMn,m}÷1 opposed to the pixel electrode PE_{n,m}÷1 connected to the transistor M_{n,m}÷1 connected to the nth gate bus line GLₙ of the plurality of gate bus lines and to the (m+1)th source bus line SLₘ÷1 of the plurality of source bus lines is connected to the (n−1)th counter electrode bus line COMLₙ₋₁ of the plurality of counter electrode bus lines.

According to the display panel thus configured, by carrying out dot reversal driving in which source signals that are applied to pixel electrodes that are adjacent to each other are opposite in polarity to each other, the phenomenon of blurring of moving images can be suppressed while flickers, cross-talks, etc. are being suppressed.

(Summary)

As described above, a display panel according to the present invention is a display panel including: a plurality of gate bus lines; a plurality of source bus lines; a plurality of counter electrode bus lines; a transistor including a gate connected to a given gate bus line of the plurality of gate bus lines and a source connected to a given source bus line of the plurality of source bus lines; a pixel electrode connected to a drain of the transistor; a counter electrode opposed to the pixel electrode via a liquid crystal and connected to a given counter electrode bus line of the plurality of counter electrode bus lines; a source driver, connected to one end of each of the plurality of source bus lines, which supplies the given source bus line with a source signal; and a gate driver, connected to one end of each of the plurality of gate bus lines, which sequentially supplies the given gate bus line with a conducting signal that renders the transistor conducting, the display panel including a counter electrode driver which, in a single scanning period from a point in time where the gate driver supplies the given gate bus line with the conducting signal to a point in time where the gate driver supplies the conducting signal next, supplies the given counter electrode bus line with a rectangular voltage signal composed of at least a first voltage level and a second voltage level that is different from the first voltage level.

Although, in changing from displaying one frame to displaying the next frame, a hold-type display device such as a liquid crystal display device displays an moving object as if the moving object were staying in one position, the observer transfers his/her gaze on the screen in chase of the moving object even in a period of time during which the moving object is being displayed as if it were staying in one position; therefore, there occurs a phenomenon of blurring of moving images where the contours of the moving object appear to be blurred.

As described above, the display panel according to the present invention is a display panel including: a plurality of gate bus lines; a plurality of source bus lines; a plurality of counter electrode bus lines; a transistor including a gate connected to a given gate bus line of the plurality of gate bus lines and a source connected to a given source bus line of the plurality of source bus lines; a pixel electrode connected to a drain of the transistor; a counter electrode opposed to the pixel electrode via a liquid crystal and connected to a given counter electrode bus line of the plurality of counter electrode bus lines; a source driver, connected to one end of each of the plurality of source bus lines, which supplies the given source bus line with a source signal; and a gate driver, connected to one end of each of the plurality of gate bus lines, which sequentially supplies the given gate bus line with a conducting signal that renders the transistor conducting, the display panel including a counter electrode driver which, in a single scanning period from a point in time where the gate driver supplies the given gate bus line with the conducting signal to a point in time where the gate driver supplies the conducting signal next, supplies the given counter electrode bus line with a rectangular voltage signal composed of a first voltage level and a second voltage level that is different from the first voltage level. Therefore, in a single scanning period from a point in time where the gate driver supplies the given gate bus line with the conducting signal to a point in time where the gate driver supplies the conducting signal next, a first voltage level and a second voltage level that is different from the first voltage level can be applied to the pixel electrode connected via the transistor to the given gate bus line.

Generally, the brightness of an image that is displayed by a pixel region changes according to a voltage that is applied to the pixel electrode. Therefore, the foregoing configuration can cause the brightness of an image in the pixel region in which the pixel electrode has been formed to switch between two values in the single scanning period.

This brings about an effect of making it possible to suppress the phenomenon of blurring of moving images.

Further, in the display panel according to the present invention, the blurring of moving images can be suppressed without using a frame memory in which to temporarily store image signals. Therefore, as compared with a conventional configuration that uses a frame memory in which to temporarily store image signals, the display panel according to the present invention brings about an effect of making it possible to reduce manufacturing cost. Further, as compared with a conventional configuration that uses a frame memory in which to temporarily store image signals, the display panel according to the present invention brings about an effect of making it possible to reduce power consumption.

Further, the display panel according to the present invention is preferably configured such that in the single scanning period, the counter electrode driver supplies the given counter electrode bus line with the rectangular voltage signal in synchronization with the conducting signal, the rectangular voltage signal being composed of at least the first and second voltage levels.

The foregoing configuration makes it possible to supply the given counter electrode bus line with the rectangular voltage signal in synchronization with the conducting signal, the rectangular voltage signal being composed of the first and second voltage levels.

Therefore, unlike in a case where a voltage signal is supplied out of synchronization with the conducting signal, the switching between bright and dark can be carried out in every pixel region on the screen after a certain period of time has elapsed since an update of image data. Further, a proportion between a period of display at a high brightness and a period of display at a low brightness can be made substantially equal in any place on the screen, so that blurring of moving images can be effectively suppressed.

Further, the display panel according to the present invention is preferably configured such that the rectangular voltage signal takes on either one of the first and second voltage levels in an at least 10% period of time of the single scanning period.

According to the foregoing configuration, the rectangular voltage signal takes on either one of the first and second voltage levels in an at least 10% period of time of the single scanning period. This brings about a further effect of making it possible to effectively suppress the phenomenon of blurring of moving images.

Further, the display panel according to the present invention is preferably configured such that the rectangular voltage signal takes on either one of the first and second voltage levels in a period of time from a point in time at which the single scanning period starts to a point in time where substantially 10% of the single scanning period elapses, and takes on the other one of the first and second voltage levels in a period of time from a point in time where substantially 90% of the single scanning period elapses to a point in time at which the single scanning period ends.

Generally, in the case of switching between a display at a high brightness and a display at a low brightness, the viewer feels no improvement in blurring of moving images when the percentage of the display at the high brightness is 90% or higher, feels more improvement in blurring of moving images at a lower percentage between 90% to 10%, and feels satisfactory improvement in blurring of moving images at a percentage of approximately 10%.

Therefore, the foregoing configuration brings about a further effect of making it possible to effectively suppress the phenomenon of blurring of moving images.

Further, the display panel according to the present invention is preferably configured such that in the single scanning period, a polarity of a voltage that is applied to the liquid crystal as represented by a difference between a potential of the pixel electrode and a potential of the counter electrode when the rectangular voltage signal is at the first voltage level and a polarity of a voltage that is applied to the liquid crystal as represented by a difference between a potential of the pixel electrode and the potential of the counter electrode when the rectangular voltage signal is at the second voltage level are polarities that are different from each other.

According to the foregoing configuration, regardless of whether the rectangular voltage signal is at the first or second voltage level, the absolute value of the voltage that is applied to the liquid crystal can be made sufficiently small.

Therefore, the foregoing configuration brings about a further effect of making it possible, in a normally black type in which the brightness is lower in a case where the absolute value of a voltage that is applied to the liquid crystal is smaller, to carry out a black display at a sufficiently low brightness, regardless of whether the rectangular voltage signal is at the first or second voltage level.

Further, the display panel according to the present invention is preferably configured such that an absolute value of a potential difference between the first voltage level and the second voltage level is twice or less as great as a threshold voltage of the liquid crystal.

Generally, the orientation of a liquid crystal is not affected even when a voltage that is equal to or lower than the threshold voltage is applied to the liquid crystal. In other words, the threshold voltage means a voltage at which the orientation of a liquid crystal starts to be affected (same applies below).

According to the foregoing configuration, the absolute value of the potential difference between the first voltage level and the second voltage level is twice or less as great as the threshold voltage of the liquid crystal. This makes it possible to prevent the orientation of the liquid crystal from being affected, regardless of whether the rectangular voltage signal is at the first or second voltage level.

Therefore, the foregoing configuration brings about a further effect of making it possible, in a normally black type in which the brightness is lower in a case where the absolute value of a voltage that is applied to the liquid crystal is smaller, to carry out a black display regardless of whether the rectangular voltage signal is at the first or second voltage level.

Further, the display panel according to the present invention is preferably configured such that in the single scanning period, the counter electrode driver supplies the given counter electrode bus line with a rectangular voltage signal composed of the first voltage level, the second voltage level, and a third voltage level that is different from the first and second voltage levels.

According to the foregoing configuration, in the single scanning period, the counter electrode driver can supply the given counter electrode bus line with a rectangular voltage signal in synchronization with the conducting signal, the rectangular voltage signal being composed of the first voltage level, the second voltage level, and a third voltage level that is different from the first and second voltage levels. Therefore, in the single scanning period, a three-valued voltage level can be applied to the pixel electrode connected via the transistor to the given gate bus line. In other words, in the single scanning period, the level of voltage that is applied to the pixel electrode makes two transitions. The first transition between the voltage levels in the single scanning period causes a voltage that is applied to the liquid crystal after the first transitions between the voltage levels to be suitable for a display after the first transition between the voltage levels, and the second transition between the voltage levels allows switching between a high brightness and a low brightness.

That is, the foregoing configuration brings about a further effect of making a display at a higher brightness possible while effectively suppressing the phenomenon of blurring of moving images.

Further, the display panel according to the present invention is preferably configured such that the rectangular voltage signal takes on any one of the first to third voltage levels in an at least 10% period of time of the single scanning period.

According to the foregoing configuration, the rectangular voltage signal takes on any one of the first to third voltage levels in an at least 10% period of time of the single scanning period. This brings about a further effect of making it possible to effectively suppress the phenomenon of blurring of moving images.

Further, the display panel according to the present invention is preferably configured such that the rectangular voltage signal takes on any one of the first to third voltage levels in a period of time from a point in time at which the single scanning period starts to a point in time where substantially 10% of the single scanning period elapses, and takes on another one of the first to third voltage levels in a period of time from a point in time where substantially 90% of the single scanning period elapses to a point in time at which the single scanning period ends.

Generally, in the case of switching between a display at a high brightness and a display at a low brightness, the viewer feels no improvement in blurring of moving images when the percentage of the display at the high brightness is 90% or higher, feels more improvement in blurring of moving images at a lower percentage between 90% to 10%, and feels satisfactory improvement in blurring of moving images at a percentage of approximately 10%.

Therefore, the foregoing configuration brings about a further effect of making it possible to effectively suppress the phenomenon of blurring of moving images.

Further, the display panel according to the present invention is preferably configured such that in the single scanning period, a polarity of a voltage that is applied to the liquid crystal as represented by a difference between a potential of the pixel electrode and a potential of the counter electrode after a first transition between the voltage levels and a polarity of a voltage that is applied to the liquid crystal as represented by a difference between a potential of the pixel electrode and the potential of the counter electrode after a next transition between the voltage levels are polarities that are different from each other.

According to the foregoing configuration, regardless of whether after the first transition between the voltage levels or after the next transition between the voltage levels in the single scanning period, the absolute value of the voltage that is applied to the liquid crystal can be made sufficiently small.

Therefore, the foregoing configuration brings about a further effect of making it possible, in a normally black type in which the brightness is lower in a case where the absolute value of a voltage that is applied to the liquid crystal is smaller, to carry out a black display at a sufficiently low brightness, regardless of whether after the first transition between the voltage levels or after the next transition between the voltage levels in the single scanning period.

Further, the display panel according to the present invention is preferably configured such that an absolute value of a potential difference between the middle voltage level among the first to third voltage levels and the lowest voltage level among the first to third voltage levels is twice or less as great as a threshold voltage of the liquid crystal.

According to the foregoing configuration, the absolute value of the potential difference between the middle voltage level among the first to third voltage levels and the lowest voltage level among the first to third voltage levels is twice or less as great as the threshold voltage of the liquid crystal. Therefore, regardless of which of the first to third voltage levels the rectangular voltage signal takes on, the foregoing configuration brings about a further effect of making it possible, in a normally black type in which the brightness is lower in a case where the absolute value of a potential of the pixel electrode is smaller, to carry out a black display regardless of which of the first to third voltage levels the rectangular voltage signal takes on.

Further, the display panel according to the present invention is preferably configured such that in the single scanning period, the counter electrode driver supplies the given counter electrode bus line with a rectangular voltage signal composed of the first voltage level, the second voltage level, and a third voltage level that is different from the first and second voltage levels, and in a single scanning period subsequent to the single scanning period, the counter electrode driver supplies the given counter electrode bus line with a rectangular voltage signal composed of any two of the first to third voltage levels and a fourth voltage level that is different from the first to third voltage levels.

According to the foregoing configuration, in the single scanning period, the counter electrode driver can supply the given counter electrode bus line with a rectangular voltage signal in synchronization with the conducting signal, the rectangular voltage signal being composed of the first voltage level, the second voltage level, and a third voltage level that is different from the first and second voltage levels. Therefore, in the single scanning period, the level of voltage that is applied to the pixel electrode switches among three values. In other words, in the single scanning period, the level of voltage that is applied to the pixel electrode makes two transitions. The first transition between the voltage levels in the single scanning period causes a voltage that is applied to the liquid crystal after the first transitions between the voltage levels to be suitable for a display after the first transition between the voltage levels, and the second transition between the voltage levels allows switching between a high brightness and a low brightness.

Therefore, the foregoing configuration brings about a further effect of making a display at a higher brightness possible while effectively suppressing the phenomenon of blurring of moving images.

Furthermore, the foregoing configuration makes it possible, in a single scanning period subsequent to the single scanning period, to supply a rectangular voltage signal composed of any two of the first to third voltage levels and a fourth voltage level that is different from the first to third voltage levels. Therefore, as compared with a case where a rectangular voltage signal composed of the first to third voltage levels is supplied in a single scanning period subsequent to the single scanning period, the adjustment of brightness levels between a high brightness and a low brightness can be more flexibly carried out.

Therefore, the foregoing configuration brings about a further effect of making a display at a high brightness possible while further effectively suppressing the phenomenon of blurring of moving images.

Further, the display panel according to the present invention is preferably configured such that an absolute value of a potential difference between the voltage level before a first transition between the voltage levels in the single scanning period and the voltage level after the first transition is smaller than an absolute value of a potential difference between the voltage level before a next transition between the voltage levels in the single scanning period and the voltage level after the next transition.

According to the foregoing configuration, the absolute value of the potential difference between the voltage level before the first transition between the voltage levels in the single scanning period and the voltage level after the first transition is smaller than the absolute value of the potential difference between the voltage level before the next transition between the voltage levels in the single scanning period and the voltage level after the next transition. Therefore, the difference between the brightness before the next transition and the brightness after the next transition can be made greater than the difference between the brightness before the first transition and the brightness after the first transition. Therefore, the foregoing configuration brings about a further effect of making it possible to more effectively suppress the phenomenon of blurring of moving images.

Further, the display panel according to the present invention is preferably configured such that the rectangular voltage signal takes on any one of the first to fourth voltage levels in an at least 10% period of time of the single scanning period.

According to the foregoing configuration, the rectangular voltage signal takes on any one of the first to fourth voltage levels in an at least 10% period of time of the single scanning period. This brings about a further effect of making it possible to effectively suppress the phenomenon of blurring of moving images.

Further, the display panel according to the present invention is preferably configured such that the rectangular voltage signal takes on any one of the first to fourth voltage levels in a period of time from a point in time at which the single scanning period starts to a point in time where substantially 10% of the single scanning period elapses, and takes on another one of the first to fourth voltage levels in a period of time from a point in time where substantially 90% of the single scanning period elapses to a point in time at which the single scanning period ends.

Generally, in the case of switching between a display at a high brightness and a display at a low brightness, the viewer feels no improvement in blurring of moving images when the percentage of the display at the high brightness is 90% or higher, feels more improvement in blurring of moving images at a lower percentage between 90% to 10%, and feels satisfactory improvement in blurring of moving images at a percentage of approximately 10%.

Therefore, the foregoing configuration brings about a further effect of making it possible to effectively suppress the phenomenon of blurring of moving images.

Further, the display panel according to the present invention is preferably configured such that in the single scanning period, a polarity of a voltage that is applied to the liquid crystal as represented by a difference between a potential of the pixel electrode and a potential of the counter electrode after a first transition between the voltage levels and a polarity of a voltage that is applied to the liquid crystal as represented by a difference between a potential of the pixel electrode and the potential of the counter electrode after a next transition between the voltage levels are polarities that are different from each other.

According to the foregoing configuration, regardless of whether after the first transition between the voltage levels or after the next transition between the voltage levels in the single scanning period, the absolute value of the voltage that is applied to the liquid crystal can be made sufficiently small.

Therefore, the foregoing configuration brings about a further effect of making it possible, in a normally black type in which the brightness is lower in a case where the absolute value of a voltage that is applied to the liquid crystal is smaller, to carry out a black display at a sufficiently low brightness, regardless of whether after the first transition between the voltage levels or after the next transition between the voltage levels in the single scanning period.

Further, the display panel according to the present invention is preferably configured such that an absolute value of a potential difference between the second highest voltage level among the first to fourth voltage levels and the lowest voltage level among the first to fourth voltage levels is twice or less as great as a threshold voltage of the liquid crystal.

According to the foregoing configuration, the absolute value of the potential difference between the second highest voltage level among the first to fourth voltage levels and the lowest voltage level among the first to fourth voltage levels is twice or less as great as the threshold voltage of the liquid crystal. This makes it possible to prevent the orientation of the liquid crystal from being affected, regardless whether the rectangular voltage signal is at the highest voltage level or at the lowest voltage among the first to fourth voltage levels.

Therefore, the foregoing configuration brings about a further effect of making it possible, in a normally black type in which the brightness is lower in a case where the absolute value of the potential of a voltage that is applied to the liquid crystal is smaller, to carry out a black display regardless of which of the first to fourth voltage levels the rectangular voltage signal takes on.

Further, the display panel according to the present invention is preferably configured such that in a case where when the gate driver supplies the given gate bus line with the conducting signal, the given counter electrode bus line is supplied with the highest voltage level among the voltage levels, the counter electrode driver supplies the given counter electrode bus line with the rectangular voltage signal in the single scanning period, the rectangular voltage signal having its voltage levels arranged in a descending order.

Generally, in a normally black type in which a black display is carried out in a case where no voltage is applied to the pixel electrode, a phenomenon of insufficient rising from a low brightness to a high brightness occurs due to finite lengths of time of response of the liquid crystal. In other words, there is such a characteristic that the amount of time required to change from a low brightness to a high brightness is larger than the amount of time required to change from a high brightness to a low brightness. Such a phenomenon can occur at a timing when the potential difference between the potential of the pixel electrode and the potential of the counter electrode increases.

According to the foregoing configuration, in a case where when the gate driver supplies the given gate bus line with the conducting signal, the given counter electrode bus line is supplied with the highest voltage level among the voltage levels, the pixel electrode can be supplied with a voltage signal at a higher voltage level and then with a voltage signal at a lower voltage level in the single scanning period.

This allows the potential difference between the potential of the pixel electrode and the potential of the counter electrode to gradually increase. This makes it possible to suppress the phenomenon of insufficient rising from a low brightness to a high brightness that can occur in a normally black type.

Further, the display panel according to the present invention is preferably configured such that in a case where when the gate driver supplies the given gate bus line with the conducting signal, the given counter electrode bus line is supplied with the lowest voltage level among the voltage levels, the counter electrode driver supplies the given counter electrode bus line with the rectangular voltage signal in the single scanning period, the rectangular voltage signal having its voltage levels arranged in an ascending order.

Generally, in a normally black type in which a black display is carried out in a case where no voltage is applied to the pixel electrode, a phenomenon of insufficient rising from a low brightness to a high brightness occurs due to finite lengths of time of response of the liquid crystal. In other words, there is such a characteristic that the amount of time required to change from a low brightness to a high brightness is larger than the amount of time required to change from a high brightness to a low brightness. Such a phenomenon can occur at a timing when the potential difference between the potential of the pixel electrode and the potential of the counter electrode increases.

According to the foregoing configuration, in a case where when the gate driver supplies the given gate bus line with the conducting signal, the given counter electrode bus line is supplied with the lowest voltage level among the voltage levels, the pixel electrode can be supplied with a voltage signal at a lower voltage level and then with a voltage signal at a higher voltage level in the single scanning period.

This allows the potential difference between the potential of the pixel electrode and the potential of the counter electrode to gradually increase. This makes it possible to suppress the phenomenon of insufficient rising from a low brightness to a high brightness that can occur in a normally black type.

Further, the display panel according to the present invention is preferably configured such that the counter electrode driver synchronously supplies the rectangular voltage signal to that one of the counter electrode bus lines which is connected to the counter electrode opposed to the pixel electrode connected via the transistor to the nth gate bus line of the plurality of gate bus lines and to that one of the counter electrode bus lines which is connected to the counter electrode opposed to the pixel electrode connected via the transistor to the (n+1)th gate bus line of the plurality of gate bus lines.

The foregoing configuration makes it possible to synchronously supply the rectangular voltage signal to that one of the counter electrode bus lines which is connected to the counter electrode opposed to the pixel electrode connected via the transistor to the nth gate bus line of the plurality of gate bus lines and to that one of the counter electrode bus lines which is connected to the counter electrode opposed to the pixel electrode connected via the transistor to the (n+1)th gate bus line of the plurality of gate bus lines. Therefore the counter electrode driver of a simpler configuration brings about a further effect of making it possible to suppress the phenomenon of blurring of moving images.

Further, the display panel according to the present invention is preferably configured such that the counter electrode driver synchronously supplies the rectangular voltage signal to that one of the counter electrode bus lines which is connected to the counter electrode opposed to the pixel electrode connected via the transistor to the nth gate bus line of the plurality of gate bus lines and to that one of the counter electrode bus lines which is connected to the counter electrode opposed to the pixel electrode connected via the transistor to the (n+2)th gate bus line of the plurality of gate bus lines.

The foregoing configuration makes it possible to synchronously supply the rectangular voltage signal to that one of the counter electrode bus lines which is connected to the counter electrode opposed to the pixel electrode connected via the transistor to the nth gate bus line of the plurality of gate bus lines and to that one of the counter electrode bus lines which is connected to the counter electrode opposed to the pixel electrode connected via the transistor to the (n+2)th gate bus line of the plurality of gate bus lines. Therefore, the counter electrode driver of a simpler configuration brings about a further effect of making it possible to suppress the phenomenon of blurring of moving images while suppressing the occurrence of flickers and streaks corresponding to polarity reversal.

Further, the display panel according to the present invention is preferably configured such that: the number of the plurality of gate bus lines is an even number; the number of the plurality of counter electrode bus lines is a half of the number of gate bus lines; and the counter electrode opposed to the pixel electrode connected via the transistor to the (2k−1)th (k is a natural number) gate bus line of the plurality of gate bus lines and the counter electrode opposed to the pixel electrode connected via the transistor to the 2kth gate bus line of the plurality of gate bus lines are connected to the kth counter electrode bus line of the plurality of counter electrode bus lines.

According to the foregoing configuration, the number of counter electrode bus lines to be formed on the display panel can be reduced to half of the number of the plurality of gate bus lines. Therefore, the display panel of a simpler configuration brings about a further effect of making it possible to suppress the phenomenon of blurring of moving images.

Further, the display panel according to the present invention is preferably configured such that the counter electrode driver includes amplitude changing means for changing size of amplitude of the rectangular voltage signal.

According to the foregoing configuration, the counter electrode driver includes amplitude changing means for changing size of amplitude of the rectangular voltage signal. This brings about a further effect of making it possible to more effectively suppress the phenomenon of blurring of moving images.

Further, the display panel according to the present invention is preferably configured such that in a case where the source driver supplies the source signal of amplitude less than a predetermined standard amplitude, the source driver supplies the source signal of larger amplitude when the amplitude of the rectangular voltage signal is smaller and supplies the source signal of smaller amplitude when the amplitude of the rectangular voltage signal is larger; and in a case where the source driver supplies the source signal of amplitude not less than the predetermined standard amplitude, the source driver supplies the source signal of smaller amplitude when the amplitude of the rectangular voltage signal is smaller and supplies the source signal of larger amplitude when the amplitude of the rectangular voltage signal is larger.

According to the foregoing configuration, in a case where the source driver supplies the source signal of amplitude less than a predetermined standard amplitude, the source driver can supply the source signal of larger amplitude when the amplitude of the rectangular voltage signal is smaller and supplies the source signal of smaller amplitude when the amplitude of the rectangular voltage signal is larger; and in a case where the source driver supplies the source signal of amplitude not less than the predetermined standard amplitude, the source driver can supply the source signal of smaller amplitude when the amplitude of the rectangular voltage signal is smaller and supplies the source signal of larger amplitude when the amplitude of the rectangular voltage signal is larger. This brings about a further effect of making it possible to effectively suppress the phenomenon of blurring of moving images, regardless of whether the rectangular voltage signal is of larger amplitude or smaller amplitude.

It should be noted the amplitude of the source signal is defined as being obtained by subtracting the potential of the source signal at the time of negative polarity writing from the potential of the source signal at the time of positive polarity writing (same applies below). Further, the time of positive polarity writing refers to the time of supply of the conducting signal during which the rectangular voltage signal is at the highest voltage level, and the time of negative polarity writing refers to the time of supply of the conducting signal during which the rectangular voltage signal is at the low, high voltage level (same applies below).

Further, the display panel according to the present invention may be configured such that: the counter electrode driver comprises two counter electrode drivers; the given counter electrode bus line is constituted by two counter electrode bus lines formed collinearly via an insulating section; in the single scanning period, either one of the two counter electrode drivers supplies either one of the two counter electrode bus lines with the rectangular voltage signal in synchronization with the conducting signal, the rectangular voltage signal being composed of the first voltage level and the second voltage level that is different from the first voltage level; and in the single scanning period, the other one of the two counter electrode drivers supplies the other one of the two counter electrode bus lines with the rectangular voltage signal in synchronization with the conducting signal, the rectangular voltage signal being composed of the first voltage level and the second voltage level that is different from the first voltage level.

According to the foregoing configuration, the one counter electrode driver supplies the rectangular voltage signal to either one of the two counter electrode bus lines formed collinearly via the insulating section, and the other counter electrode driver supplies the rectangular voltage signal to the other counter electrode bus line.

Therefore, according to the foregoing configuration, the pixel electrode connected to the one counter electrode bus line and the pixel electrode connected to the other counter electrode bus line can be supplied with the rectangular voltage signal independently from each other.

As a result, therefore, the foregoing configuration allows a pixel region including the pixel electrode connected to the one counter electrode bus line and a pixel region including the pixel electrode connected to the other counter electrode bus line to display images that are different in improvement effect on the phenomenon of blurring of moving images. Therefore, the improvement effect of the present invention on the blurring of moving images can be made to more effectively claim users' attention. That is, such a further effect can be brought about that the improvement effect of the present invention on the blurring of moving images can be made more effectively appealing to users.

Further, the display panel according to the present invention is preferably configured such that the source driver supplies source signals of different amplitudes to that one of the source bus lines which is connected via the transistor to the pixel electrode opposed to the counter electrode connected to the one counter electrode bus line and to that one of the source bus lines which is connected via the transistor to the pixel electrode opposed to the counter electrode connected to the other counter electrode bus line.

According to the foregoing configuration, the source driver can supply source signals of different amplitudes to that one of the source bus lines which is connected via the transistor to the pixel electrode opposed to the counter electrode connected to the one counter electrode bus line and to that one of the source bus lines which is connected via the transistor to the pixel electrode opposed to the counter electrode connected to the other counter electrode bus line. Therefore, the pixel electrode connected to the one counter electrode bus line and the pixel electrode connected to the other counter electrode bus line can be supplied with the rectangular voltage signal independently from each other, whereby while uniforming the visibility of images except for the phenomenon of blurring of moving images, the pixel region including the pixel electrode connected to the one counter electrode bus line and the pixel region including the pixel electrode connected to the other counter electrode bus line can display images that are different in improvement effect on the phenomenon of blurring of moving images.

Therefore, the improvement effect of the present invention on the blurring of moving images can be made to more effectively claim users' attention. That is, such a further effect can be brought about that the improvement effect of the present invention on the blurring of moving images can be made more effectively appealing to users.

Further, the display panel according to the present invention is preferably configured such that the one counter electrode bus line has a length that is substantially 45% to substantially 55% of that of the given counter electrode bus line, and the other counter electrode bus line has a length that is substantially equal to a length obtained by subtracting the length of the one counter electrode bus line from the length of the given counter electrode bus line.

According to the foregoing configuration, the given counter electrode bus line is electrically separated into the one counter electrode bus line and the other counter electrode bus line within a range of ±5% from the center line dividing the display section, which displays an image in the display panel, into two equal parts in parallel with the source bus lines.

Therefore, according to the foregoing configuration, the brightness of the pixel region including the pixel electrode disposed on one half surface of the display section and the brightness of the pixel region including the pixel electrode disposed on the other half surface can be each independently controlled in the single scanning period. Further, since the one counter electrode bus line and the other counter electrode bus line can be made substantially identical in load characteristic to each other, the counter electrode driver connected to the one counter electrode bus line and the counter electrode driver connected to the other counter electrode bus line can be made substantially identical in configuration to each other.

Therefore, the foregoing configuration brings about such a further effect that the improvement effect of the present invention on the blurring of moving images can be made effectively appealing to users by a configuration that is easy to design and fabricate.

Further, the display panel according to the present invention is preferably configured such that the one counter electrode driver includes first amplitude changing means for changing size of amplitude of the rectangular voltage signal, and the other counter electrode driver includes second amplitude changing means for changing size of amplitude of the rectangular voltage signal.

According to the foregoing configuration, the one counter electrode driver includes first amplitude changing means for changing size of amplitude of the rectangular voltage signal, and the other counter electrode driver includes second amplitude changing means for changing size of amplitude of the rectangular voltage signal. Therefore, the one counter electrode driver and the other counter electrode driver can supply the rectangular voltage signal of different amplitudes.

Therefore, according to the foregoing configuration, the one counter electrode driver and the other counter electrode driver supply the rectangular voltage signal of different amplitudes, whereby the pixel region including the pixel electrode connected to the one counter electrode bus line and the pixel region including the pixel electrode connected to the other counter electrode bus line can display images that are different in improvement effect on the phenomenon of blurring of moving images. Therefore, the improvement effect of the present invention on the blurring of moving images can be made to more effectively claim users' attention. That is, such a further effect can be brought about that the improvement effect of the present invention on the blurring of moving images can be made more effectively appealing to users.

Further, the display panel according to the present invention is preferably configured such that: in a case where the source driver supplies the source signal of amplitude less than a predetermined standard amplitude, the source driver (i) supplies, in a case where the one counter electrode driver supplies the one counter electrode bus line with the rectangular voltage signal of smaller amplitude, the source signal of larger amplitude to that one of the source bus lines which is connected via the transistor to the pixel electrode opposed to the counter electrode connected to the one counter electrode bus line, (ii) supplies, in a case where the one counter electrode driver supplies the one counter electrode bus line with the rectangular voltage signal of larger amplitude, the source signal of smaller amplitude to that one of the source bus lines which is connected via the transistor to the pixel electrode opposed to the counter electrode connected to the one counter electrode bus line, (iii) supplies, in a case where the other counter electrode driver supplies the other counter electrode bus line with the rectangular voltage signal of smaller amplitude, the source signal of larger amplitude to that one of the source bus lines which is connected via the transistor to the pixel electrode opposed to the counter electrode connected to the other counter electrode bus line, and (iv) supplies, in a case where the other counter electrode driver supplies the other counter electrode bus line with the rectangular voltage signal of larger amplitude, the source signal of smaller amplitude to that one of the source bus lines which is connected via the transistor to the pixel electrode opposed to the counter electrode connected to the other counter electrode bus line; and in a case where the source driver supplies the source signal of amplitude not less than the predetermined standard amplitude, the source driver (i) supplies, in a case where the one counter electrode driver supplies the one counter electrode bus line with the rectangular voltage signal of smaller amplitude, the source signal of smaller amplitude to that one of the source bus lines which is connected via the transistor to the pixel electrode opposed to the counter electrode connected to the one counter electrode bus line, (ii) supplies, in a case where the one counter electrode driver supplies the one counter electrode bus line with the rectangular voltage signal of larger amplitude, the source signal of larger amplitude to that one of the source bus lines which is connected via the transistor to the pixel electrode opposed to the counter electrode connected to the one counter electrode bus line, (iii) supplies, in a case where the other counter electrode driver supplies the other counter electrode bus line with the rectangular voltage signal of smaller amplitude, the source signal of smaller amplitude to that one of the source bus lines which is connected via the transistor to the pixel electrode opposed to the counter electrode connected to the other counter electrode bus line, and (iv) supplies, in a case where the other counter electrode driver supplies the other counter electrode bus line with the rectangular voltage signal of larger amplitude, the source signal of larger amplitude to that one of the source bus lines which is connected via the transistor to the pixel electrode opposed to the counter electrode connected to the other counter electrode bus line.

According to the foregoing configuration, while uniforming the visibility of images except for the phenomenon of blurring of moving images, the pixel region including the counter electrode connected to the one counter electrode bus line and the pixel region including the counter electrode connected to the other counter electrode bus line can display images that are different in improvement effect on the phenomenon of blurring of moving images. Therefore, such a further effect can be brought about that the improvement effect of the present invention on the blurring of moving images can be more effectively appealing to users.

Further, the display panel according to the present invention is preferably configured such that: the counter electrode opposed to the pixel electrode connected to the transistor connected to the nth gate bus line of the plurality of gate bus lines and to the mth source bus line of the plurality of source bus lines is connected to the nth counter electrode bus line of the plurality of counter electrode bus lines; and the counter electrode opposed to the pixel electrode connected to the transistor connected to the nth gate bus line of the plurality of gate bus lines and to the (m+1)th source bus line of the plurality of source bus lines is connected to the (n−1)th counter electrode bus line of the plurality of counter electrode bus lines.

The display panel thus configured brings about such a further effect that by carrying out dot reversal driving in which source signals that are applied to pixel electrodes that are adjacent to each other are opposite in polarity to each other, the phenomenon of blurring of moving images can be suppressed while flickers, cross-talks, etc. are being suppressed.

Further, a liquid crystal display device including a display panel thus configured is also encompassed in the scope of the present invention.

Further, a driving method according to the present invention is a method for driving a display panel including: a plurality of gate bus lines; a plurality of source bus lines; a plurality of counter electrode bus lines; a transistor including a gate connected to a given gate bus line of the plurality of gate bus lines and a source connected to a given source bus line of the plurality of source bus lines; a pixel electrode connected to a drain of the transistor; a counter electrode opposed to the pixel electrode via a liquid crystal and connected to a given counter electrode bus line of the plurality of counter electrode bus lines; a source driver, connected to one end of each of the plurality of source bus lines, which supplies the given source bus line with a source signal; and a gate driver, connected to one end of each of the plurality of gate bus lines, which sequentially supplies the given gate bus line with a conducting signal that renders the transistor conducting, the method including a voltage signal supplying step of, in a single scanning period from a point in time where the gate driver supplies the given gate bus line with the conducting signal to a point in time where the gate driver supplies the conducting signal next, supplying the given counter electrode bus line with a rectangular voltage signal composed of at least a first voltage level and a second voltage level that is different from the first voltage level.

The foregoing method brings about the same effects as the foregoing display panel according to the present invention.

The present invention is not limited to the description of the embodiments above, but may be altered by a skilled person within the scope of the claims. An embodiment based on a proper combination of technical means disclosed in different embodiments is encompassed in the technical scope of the present invention.

Further, a liquid crystal display device including a display panel described in any one of the embodiments is also encompassed in the present invention.

### INDUSTRIAL APPLICABILITY

The present invention can be suitably applied to a display panel that displays an image by using liquid crystals.

### REFERENCE SIGNS LIST

1 Display panel
11 Control section
12 Source driver
13 Gate driver
14 Counter electrode driver
15 Auxiliary capacitor driver
16 Display section
SLₘ Source bus line
GLₙ Gate bus line
COMLₙ Counter electrode bus line
CSL Auxiliary capacitor bus line
P_{n,m} Pixel region
PE_{n,m} Pixel electrode
M_{n,m} Transistor
E_{COMn,m} Counter electrode

1. A display panel including:
a plurality of gate bus lines;
a plurality of source bus lines;
a plurality of counter electrode bus lines;
a transistor including a gate connected to a given gate bus line of the plurality of gate bus lines and a source connected to a given source bus line of the plurality of source bus lines;
a pixel electrode connected to a drain of the transistor;
a counter electrode opposed to the pixel electrode via a liquid crystal and connected to a given counter electrode bus line of the plurality of counter electrode bus lines;
a source driver, connected to one end of each of the plurality of source bus lines, which supplies the given source bus line with a source signal; and
a gate driver, connected to one end of each of the plurality of gate bus lines, which sequentially supplies the given gate bus line with a conducting signal that renders the transistor conducting,
the display panel comprising a counter electrode driver which, in a single scanning period from a point in time where the gate driver supplies the given gate bus line with the conducting signal to a point in time where the gate driver supplies the conducting signal next, supplies the given counter electrode bus line with a rectangular voltage signal composed of at least a first voltage level and a second voltage level that is different from the first voltage level.

2. The display panel as set forth in claim 1, wherein in the single scanning period, the counter electrode driver supplies the given counter electrode bus line with the rectangular voltage signal in synchronization with the conducting signal, the rectangular voltage signal being composed of at least the first and second voltage levels.

3. The display panel as set forth in claim 1, wherein the rectangular voltage signal takes on either one of the first and second voltage levels in an at least 10% period of time of the single scanning period.

4. The display panel as set forth in claim 1, wherein the rectangular voltage signal takes on either one of the first and second voltage levels in a period of time from a point in time at which the single scanning period starts to a point in time where substantially 10% of the single scanning period elapses, and takes on the other one of the first and second voltage levels in a period of time from a point in time where substantially 90% of the single scanning period elapses to a point in time at which the single scanning period ends.

5. The display panel as set forth in claim 1, wherein in the single scanning period, a polarity of a voltage that is applied to the liquid crystal as represented by a difference between a potential of the pixel electrode and a potential of the counter electrode when the rectangular voltage signal is at the first voltage level and a polarity of a voltage that is applied to the liquid crystal as represented by a difference between a potential of the pixel electrode and the potential of the counter electrode when the rectangular voltage signal is at the second voltage level are polarities that are different from each other.

6. The display panel as set forth in claim 1, wherein an absolute value of a potential difference between the first voltage level and the second voltage level is twice or less as great as a threshold voltage of the liquid crystal.

7. The display panel as set forth in claim 1, wherein in the single scanning period, the counter electrode driver supplies the given counter electrode bus line with a rectangular voltage signal composed of the first voltage level, the second voltage level, and a third voltage level that is different from the first and second voltage levels.

8. The display panel as set forth in claim 7, wherein the rectangular voltage signal takes on any one of the first to third voltage levels in an at least 10% period of time of the single scanning period.

9. The display panel as set forth in claim 7, wherein the rectangular voltage signal takes on any one of the first to third voltage levels in a period of time from a point in time at which the single scanning period starts to a point in time where substantially 10% of the single scanning period elapses, and takes on another one of the first to third voltage levels in a period of time from a point in time where substantially 90% of the single scanning period elapses to a point in time at which the single scanning period ends.

10. The display panel as set forth in claim 7, wherein in the single scanning period, a polarity of a voltage that is applied to the liquid crystal as represented by a difference between a potential of the pixel electrode and a potential of the counter electrode after a first transition between the voltage levels and a polarity of a voltage that is applied to the liquid crystal as represented by a difference between a potential of the pixel electrode and the potential of the counter electrode after a next transition between the voltage levels are polarities that are different from each other.

11. The display panel as set forth in claim 7, wherein an absolute value of a potential difference between the middle voltage level among the first to third voltage levels and the lowest voltage level among the first to third voltage levels is twice or less as great as a threshold voltage of the liquid crystal.

12. The display panel as set forth in claim 1, wherein in the single scanning period, the counter electrode driver supplies the given counter electrode bus line with a rectangular voltage signal composed of the first voltage level, the second voltage level, and a third voltage level that is different from the first and second voltage levels, and in a single scanning period subsequent to the single scanning period, the counter electrode driver supplies the given counter electrode bus line with a rectangular voltage signal composed of any two of the first to third voltage levels and a fourth voltage level that is different from the first to third voltage levels.

13. The display panel as set forth in claim 12, wherein an absolute value of a potential difference between the voltage level before a first transition between the voltage levels in the single scanning period and the voltage level after the first transition is smaller than an absolute value of a potential difference between the voltage level before a next transition between the voltage levels in the single scanning period and the voltage level after the next transition.

14. The display panel as set forth in claim 12, wherein the rectangular voltage signal takes on any one of the first to fourth voltage levels in an at least 10% period of time of the single scanning period.

15. The display panel as set forth in claim 12, wherein the rectangular voltage signal takes on any one of the first to fourth voltage levels in a period of time from a point in time at which the single scanning period starts to a point in time where substantially 10% of the single scanning period elapses, and takes on another one of the first to fourth voltage levels in a period of time from a point in time where substantially 90% of the single scanning period elapses to a point in time at which the single scanning period ends.

16. The display panel as set forth in claim 12, wherein in the single scanning period, a polarity of a voltage that is applied to the liquid crystal as represented by a difference between a potential of the pixel electrode and a potential of the counter electrode after a first transition between the voltage levels and a polarity of a voltage that is applied to the liquid crystal as represented by a difference between a potential of the pixel electrode and the potential of the counter electrode after a next transition between the voltage levels are polarities that are different from each other.

17. The display panel as set forth in claim 12, wherein an absolute value of a potential difference between the second highest voltage level among the first to fourth voltage levels and the lowest voltage level among the first to fourth voltage levels is twice or less as great as a threshold voltage of the liquid crystal.

18. The display panel as set forth in claim 1, wherein in a case where when the gate driver supplies the given gate bus line with the conducting signal, the given counter electrode bus line is supplied with the highest voltage level among the voltage levels, the counter electrode driver supplies the given counter electrode bus line with the rectangular voltage signal in the single scanning period, the rectangular voltage signal having its voltage levels arranged in a descending order.

19. The display panel as set forth in claim 1, wherein in a case where when the gate driver supplies the given gate bus line with the conducting signal, the given counter electrode bus line is supplied with the lowest voltage level among the voltage levels, the counter electrode driver supplies the given counter electrode bus line with the rectangular voltage signal in the single scanning period, the rectangular voltage signal having its voltage levels arranged in an ascending order.

20. The display panel as set forth in claim 1, wherein the counter electrode driver synchronously supplies the rectangular voltage signal to that one of the counter electrode bus lines which is connected to the counter electrode opposed to the pixel electrode connected via the transistor to the nth gate bus line of the plurality of gate bus lines and to that one of the counter electrode bus lines which is connected to the counter electrode opposed to the pixel electrode connected via the transistor to the (n+1)th gate bus line of the plurality of gate bus lines.

21. The display panel as set forth in claim 1, wherein the counter electrode driver synchronously supplies the rectangular voltage signal to that one of the counter electrode bus lines which is connected to the counter electrode opposed to the pixel electrode connected via the transistor to the nth gate bus line of the plurality of gate bus lines and to that one of the counter electrode bus lines which is connected to the counter electrode opposed to the pixel electrode connected via the transistor to the (n+2)th gate bus line of the plurality of gate bus lines.

22. The display panel as set forth in claim 1, wherein:
the number of the plurality of gate bus lines is an even number;
the number of the plurality of counter electrode bus lines is a half of the number of gate bus lines; and
the counter electrode opposed to the pixel electrode connected via the transistor to the (2k−1)th (k is a natural number) gate bus line of the plurality of gate bus lines and the counter electrode opposed to the pixel electrode connected via the transistor to the 2kth gate bus line of the plurality of gate bus lines are connected to the kth counter electrode bus line of the plurality of counter electrode bus lines.

23. The display panel as set forth in claim 1, wherein the counter electrode driver includes amplitude changing means for changing size of amplitude of the rectangular voltage signal.

24. The display panel as set forth in claim 23, wherein in a case where the source driver supplies the source signal of amplitude less than a predetermined standard amplitude, the source driver supplies the source signal of larger amplitude when the amplitude of the rectangular voltage signal is smaller and supplies the source signal of smaller amplitude when the amplitude of the rectangular voltage signal is larger; and
in a case where the source driver supplies the source signal of amplitude not less than the predetermined standard amplitude, the source driver supplies the source signal of smaller amplitude when the amplitude of the rectangular voltage signal is smaller and supplies the source signal of larger amplitude when the amplitude of the rectangular voltage signal is larger.

25. The display panel as set forth in claim 1, wherein:
the counter electrode driver comprises two counter electrode drivers;
the given counter electrode bus line is constituted by two counter electrode bus lines formed collinearly via an insulating section;
in the single scanning period, either one of the two counter electrode drivers supplies either one of the two counter electrode bus lines with the rectangular voltage signal in synchronization with the conducting signal, the rectangular voltage signal being composed of the first voltage level and the second voltage level that is different from the first voltage level; and
in the single scanning period, the other one of the two counter electrode drivers supplies the other one of the two counter electrode bus lines with the rectangular voltage signal in synchronization with the conducting signal, the rectangular voltage signal being composed of the first voltage level and the second voltage level that is different from the first voltage level.

26. The display panel as set forth in claim 25, wherein the source driver supplies source signals of different amplitudes to that one of the source bus lines which is connected via the transistor to the pixel electrode opposed to the counter electrode connected to the one counter electrode bus line and to that one of the source bus lines which is connected via the transistor to the pixel electrode opposed to the counter electrode connected to the other counter electrode bus line.

27. The display panel as set forth in claim 25, wherein the one counter electrode bus line has a length that is substantially 45% to substantially 55% of that of the given counter electrode bus line, and the other counter electrode bus line has a length that is substantially equal to a length obtained by subtracting the length of the one counter electrode bus line from the length of the given counter electrode bus line.

28. The display panel as set forth in claim 25, wherein the one counter electrode driver includes first amplitude changing means for changing size of amplitude of the rectangular voltage signal, and the other counter electrode driver includes second amplitude changing means for changing size of amplitude of the rectangular voltage signal.

29. The display panel as set forth in claim 28, wherein:
in a case where the source driver supplies the source signal of amplitude less than a predetermined standard amplitude, the source driver (i) supplies, in a case where the one counter electrode driver supplies the one counter electrode bus line with the rectangular voltage signal of smaller amplitude, the source signal of larger amplitude to that one of the source bus lines which is connected via the transistor to the pixel electrode opposed to the counter electrode connected to the one counter electrode bus line, (ii) supplies, in a case where the one counter electrode driver supplies the one counter electrode bus line with the rectangular voltage signal of larger amplitude, the source signal of smaller amplitude to that one of the source bus lines which is connected via the transistor to the pixel electrode opposed to the counter electrode connected to the one counter electrode bus line, (iii) supplies, in a case where the other counter electrode driver supplies the other counter electrode bus line with the rectangular voltage signal of smaller amplitude, the source signal of larger amplitude to that one of the source bus lines which is connected via the transistor to the pixel electrode opposed to the counter electrode connected to the other counter electrode bus line, and (iv) supplies, in a case where the other counter electrode driver supplies the other counter electrode bus line with the rectangular voltage signal of larger amplitude, the source signal of smaller amplitude to that one of the source bus lines which is connected via the transistor to the pixel electrode opposed to the counter electrode connected to the other counter electrode bus line; and
in a case where the source driver supplies the source signal of amplitude not less than the predetermined standard amplitude, the source driver (i) supplies, in a case where the one counter electrode driver supplies the one counter electrode bus line with the rectangular voltage signal of smaller amplitude, the source signal of smaller amplitude to that one of the source bus lines which is connected via the transistor to the pixel electrode opposed to the counter electrode connected to the one counter electrode bus line, (ii) supplies, in a case where the one counter electrode driver supplies the one counter electrode bus line with the rectangular voltage signal of larger amplitude, the source signal of larger amplitude to that one of the source bus lines which is connected via the transistor to the pixel electrode opposed to the counter electrode connected to the one counter electrode bus line, (iii) supplies, in a case where the other counter electrode driver supplies the other counter electrode bus line with the rectangular voltage signal of smaller amplitude, the source signal of smaller amplitude to that one of the source bus lines which is connected via the transistor to the pixel electrode opposed to the counter electrode connected to the other counter electrode bus line, and (iv) supplies, in a case where the other counter electrode driver supplies the other counter electrode bus line with the rectangular voltage signal of larger amplitude, the source signal of larger amplitude to that one of the source bus lines which is connected via the transistor to the pixel electrode opposed to the counter electrode connected to the other counter electrode bus line.

30. The display panel as set forth in claim 1, wherein:
the counter electrode opposed to the pixel electrode connected to the transistor connected to the nth gate bus line of the plurality of gate bus lines and to the mth source bus line of the plurality of source bus lines is connected to the nth counter electrode bus line of the plurality of counter electrode bus lines; and
the counter electrode opposed to the pixel electrode connected to the transistor connected to the nth gate bus line of the plurality of gate bus lines and to the (m+1)th source bus line of the plurality of source bus lines is connected to the (n−1)th counter electrode bus line of the plurality of counter electrode bus lines.

31. A liquid crystal display device comprising a display panel as set forth in claim 1.

32. A method for driving a display panel including:
a plurality of gate bus lines;
a plurality of source bus lines;
a plurality of counter electrode bus lines;
a transistor including a gate connected to a given gate bus line of the plurality of gate bus lines and a source connected to a given source bus line of the plurality of source bus lines;
a pixel electrode connected to a drain of the transistor;
a counter electrode opposed to the pixel electrode via a liquid crystal and connected to a given counter electrode bus line of the plurality of counter electrode bus lines;
a source driver, connected to one end of each of the plurality of source bus lines, which supplies the given source bus line with a source signal; and
a gate driver, connected to one end of each of the plurality of gate bus lines, which sequentially supplies the given gate bus line with a conducting signal that renders the transistor conducting,
the method comprising a voltage signal supplying step of, in a single scanning period from a point in time where the gate driver supplies the given gate bus line with the conducting signal to a point in time where the gate driver supplies the conducting signal next, supplying the given counter electrode bus line with a rectangular voltage signal composed of at least a first voltage level and a second voltage level that is different from the first voltage level.
